(19) United States
(12) Patent Application Publication
(10) Pub. No.: US 2026/0227820 A1
(43) Pub. Date: Aug. 6, 2026

(54) SYSTEM-ON-CHIP THAT PERFORMS NETWORK SWITCHING AND DIRECTLY DRIVES ACTUATORS

(71) Applicant: TELECHIPS INC., Seongnam-si (KR)

(72) Inventors: Dong Yeob YANG, Seongnam-si (KR); Kyu Ho KIM, Seongnam-si (KR); Dae Woon KIM, Seongnam-si (KR); Ho Jun KIM, Seongnam-si (KR); Min Hyeok SHIN, Seongnam-si (KR); Ji Hun HU, Seongnam-si (KR); Jin Kyu HWANG, Seongnam-si (KR)

(21) Appl. No.: 19/403,511

(22) Filed: Nov. 28, 2025

(30) Foreign Application Priority Data
Feb. 3, 2025 (KR) 10-2025-0013349
Feb. 3, 2025 (KR) 10-2025-0013359
Feb. 3, 2025 (KR) 10-2025-0013376
Feb. 5, 2025 (KR) 10-2025-0014205

(51) Int. Cl. G06F 1/04; B60W 50/00; B60W 50/02; G07C 5/02

(52) U.S. Cl. CPC G06F 1/04; B60W 50/0225; G07C 5/02; B60W 2050/0083

(57) ABSTRACT

A System-on-Chip (SoC) for performing a network switching operation and an operation of directly driving an actuator includes a CPU subsystem having a plurality of electrically isolated, hypervisorless-based high-performance cores and configured to execute a plurality of applications, an MCU (Micro Control Unit) subsystem configured to calculate command data or a processing result value for driving from an input signal received by the SoC, a network device configured to route the input signal received by the SoC and transmit the routed signal to a specific communication port within the SoC, and an actuator driving signal generator configured to generate an actuator driving signal for driving an actuator connected to the SoC, using the command data or the processing result value for driving.

### CROSS REFERENCE TO RELATED APPLICATION

This application claims priority under 35 U.S.C. § 119(a) to Republic of Korea Patent Application No. 10-2025-0013349, filed on Feb. 3, 2025, Republic of Korea Patent Application No. 10-2025-0013376, filed on Feb. 3, 2025, Republic of Korea Patent Application No. 10-2025-0013359, filed on Feb. 3, 2025, and Republic of Korea Patent Application No. 10-2025-0014205, filed on Feb. 5, 2025 the contents of which are all hereby incorporated by reference herein in their entirety.

### BACKGROUND

### Technical Field

The present disclosure relates to vehicle control systems and control methods thereof. More particularly, the present disclosure relates to a vehicle control system and a control method for controlling in-vehicle devices or actuators.

### Description of Related Technology

A vehicle includes various devices such as an engine/motor, a steering system, a brake system, airbags, headlights, an air conditioning controller, side mirrors, seats, mood lamps, power windows, door locks, soft closing, trunk door locks, a power trunk, taillights, wipers, a rear curtain, washers, a sunroof, as well as wireless charging, telescopic steering, infotainment systems, and the like. Additionally, an Electronic Control Unit (ECU) may be used to control each of these devices.

The Electronic Control Unit (ECU) collects all sensor information installed in the vehicle and manages the operation of actuators. A single vehicle may use dozens to hundreds of ECUs.

A vehicle may use an automotive wiring harness to supply the power necessary to operate all electronic components within the vehicle and to transmit electrical signals to each electronic control module.

Recently, with the development of electric vehicles and autonomous vehicles, the number of ECUs has increased, and the number of wiring harnesses has also significantly increased.

As such, the increased number of ECUs and wiring harnesses due to the development of electric and autonomous vehicles makes vehicle wiring more complex. Furthermore, the increased vehicle weight leads to a decrease in fuel efficiency.

To address the problems caused by this increase in ECUs and wiring harnesses, Modular ECUs have emerged, which integrate functions such as engine/motor control, transmission control, and vehicle safety system management into a single module performed by one ECU. Additionally, an architecture is being introduced where ECUs are grouped by function into domains or zones and controls various in-vehicle functions through communication between domains or zones.

However, a failure of an integrated ECU or an error in a specific communication node can significantly affect the operation of the entire in-vehicle system. This can degrade the stability and safety of the vehicle. In particular, if a problem occurs in an ECU responsible for critical functions, it can lead to serious consequences.

Furthermore, existing vehicle systems have limited capabilities for immediately detecting and recovering from errors. This limitation can negatively impact vehicle safety, especially when a failure occurs. This makes real-time error recovery in complex vehicle systems difficult. Moreover, simple redundancy or fail-safe mechanisms in a zone are designed to maintain only minimal functionality even if a part of the vehicle system fails. Also, if an error occurs in a specific ECU, the corresponding vehicle system stops, and cooperation with other vehicle systems becomes impossible. Additionally, while the existing vehicle systems were effective in controlling conventional vehicle functions, the existing vehicle systems lack the scalability needed to integrate autonomous driving, Vehicle-to-Everything (V2X) communication, and various new technologies. This lack of scalability may pose challenges when upgrading existing vehicle systems or adding new functions as technological advancements are made.

Many ECUs may be operating on different software versions, and it is not easy for the existing vehicle systems to manage and update different software versions in an integrated manner. When a software defect is found, it is difficult for the existing vehicle systems to quickly correct the software defect across the entire vehicle system.

Since data are not centrally processed, there are limitations in effectively analyzing and utilizing the large amounts of data generated within a vehicle. This limitation can be particularly problematic in vehicle systems that need to process large amounts of data in real-time, such as autonomous driving.

However, in a centralized vehicle system, if an error occurs in the centralized computing unit, it can lead to a failure of the entire vehicle system, potentially causing serious accidents.

### SUMMARY

An aspect of the present disclosure is directed to providing various vehicle systems with an enhanced recovery function for a vehicle system and its data, even in an event of an error in hardware or transmitted data within a vehicle system that directly controls in-vehicle devices and actuators.

However, the technical problems to be solved by the present disclosure are not limited thereto and may be expanded to various environments without departing from the spirit and scope of the disclosure.

One embodiment of the present disclosure provides a System-on-Chip (SoC) for performing a network switching operation and an operation of directly driving an actuator, the SoC comprising: a CPU subsystem comprising a plurality of electrically isolated, hypervisorless-based high-performance cores and configured to execute a plurality of applications, a MCU (Micro Control Unit) subsystem configured to calculate command data or a processing result value for driving from an input signal received by the SoC, a network device configured to route the input signal received by the SoC and transmit the routed signal to a specific communication port within the SoC, and an actuator driving signal generator configured to generate an actuator driving signal for driving an actuator connected to the SoC, using the command data or the processing result value for driving.

The network device is connected to an in-vehicle control apparatus external to the SoC, wherein the network device comprises at least one of an Ethernet, CAN, and LIN communication port.

The CPU subsystem is configured to calculate the command data or the processing result value for driving using an in-vehicle device command signal or sensor data.

The command data indicates a target operation or a target state of a target device targeted by the command data, the processing result value for driving includes a control parameter for the actuator driving signal to achieve the target operation or the target state of the target device included in the command data, the actuator driving signal comprises a pulse signal, the control parameter includes at least one of a prescale value, a counter value, a compare value, a clock division value, a signal period, a signal pattern, and a signal amplitude, and the target device includes a vehicle driving, steering, brake, and body device.

The CPU subsystem, the MCU subsystem, and the network device each derive clock signals of at least three mutually different frequencies, and each of the clock signals of the at least three mutually different frequencies is independent of each other.

The actuator driving signal generator comprises a clock interface configured to receive at least two clock signals from among the clock signals of the at least three mutually different frequencies, and to select one of the at least two clock signals as a system clock.

The actuator driving signal generator comprises a register interface and a register, and the register interface is configured to receive at least one clock division value or at least one processing result value for driving from the CPU subsystem, the MCU subsystem, or the network device, and to store the received at least one clock division value and the at least one processing result value for driving at respective corresponding addresses in the register.

The actuator driving signal generator comprises a clock generator configured to generate a clock signal using the system clock transmitted from the clock interface and the clock division value transmitted from the register.

The actuator driving signal generator comprises at least two pulse signal generation modules, and each of the at least two pulse signal generation modules is configured to generate an actuator driving signal using the clock signal transmitted from the clock generator and the processing result value for driving transmitted from the register.

In an event that the system clock is changed or an error occurs in a path between the clock generator and the at least two pulse signal generation modules, the actuator driving signal generator is configured to transmit a pre-stored clock division value and a pre-stored processing result value for driving from the register to the clock generator and the at least two pulse signal generation modules, respectively, corresponding to each case.

The register includes a safety control value, and in a case where an actuator connected to the actuator driving signal generator exceeds a threshold for a state required by the command data, the register is configured to transmit the safety control value to the at least two pulse signal generation modules, the safety control value includes a processing result value for driving that stops the actuator or maintains the actuator in a safe state.

Upon receiving a direct control signal from an upper-level system, the register interface is configured to directly transmit a subsequently received processing result value for driving to the at least two pulse signal generation modules, the upper-level system includes the CPU subsystem, the MCU subsystem, or the network device.

At least some of the at least two pulse signal generation modules are simultaneously activated and operate in a complementary manner, and the register is configured to transmit at least one clock division value and at least one processing result value for driving to the clock generator and the at least two pulse signal generation modules, respectively.

In a case where an actuator related to a target device to which the input signal is directed is connected to the SoC, the network device is configured to extract the command data and the processing result value for driving from the input signal and transmit the extracted data and value to the actuator driving signal generator.

A zone control unit for controlling an in-vehicle device connected to a vehicle network, the zone control unit comprising: an MCU (Micro Control Unit) subsystem configured to calculate command data or a processing result value for driving from a signal input to a System-on-Chip (SoC), a network device configured to route the input signal to the SoC and transmit the routed input signal to a specific port within the SoC, and an actuator driving signal generator configured to generate an actuator driving signal for driving an actuator connected to the SoC, using the command data or the processing result value for driving.

The disclosed technology may have the following effects. However, the present disclosure does not mean that a specific embodiment must include all of the following effects or only the following effects. Therefore, the scope of rights of the present disclosure should not be understood as being limited by these effects.

A vehicle control system and method according to example embodiments of the present disclosure enable precise synchronization between zone control units. This allows for maintaining a constant transmission delay time for control signals for each in-vehicle device and actuator.

A vehicle control system and method according to example embodiments of the present disclosure can continuously control a target actuator without interruption even if an error occurs in the driving calculation unit of the central control unit or a zone control unit.

A vehicle control system and method according to example embodiments of the present disclosure provide multiple control paths for major in-vehicle actuators. This ensures uninterrupted control of major actuators even if a problem occurs in a specific path.

A vehicle control system and method according to example embodiments of the present disclosure can reduce the processing delay of messages for urgent and major actuators among a plurality of incoming messages.

In a vehicle control system and method according to example embodiments of the present disclosure, a central control unit or a zone control unit performs driving signal generation for an actuator and path redundancy within its own integrated circuit. This allows for continuous and uninterrupted control of a target actuator.

A vehicle control system and method according to example embodiments of the present disclosure can provide a vehicle control system that can accurately and quickly determine the transmission path of a command signal to a target device.

A vehicle control system and method according to example embodiments of the present disclosure can reduce design time and IP introduction costs by using the same actuator driving unit within the zone control unit and the ECU.

A vehicle control system and method according to example embodiments of the present disclosure can reduce the number of expensive computing units and improve functional safety by directly controlling the actuator driving signal generation module within the central control unit or zone control unit using a register control method.

A vehicle control system and method according to example embodiments of the present disclosure can accurately transmit data to a target device even if data manipulation by external intrusion into the vehicle network or vehicle control apparatus, an error on the signal transmission path, or an error in a computing unit on the data transmission path occurs. Also, if the transmitted command data violates a predetermined rule, the system can control the target actuator to a preset safety level.

A vehicle control system and method according to example embodiments of the present disclosure can quickly and accurately transmit and process actuator command data by automatically generating a frame using a pre-written reference table based on information from the device where the actuator operation command is generated.

A vehicle control system and method according to example embodiments of the present disclosure can easily expand the existing system when adding new devices or functions. Also, it is possible to minimize system changes when introducing new functions or upgrading the vehicle.

A vehicle control system and method according to example embodiments of the present disclosure allow a zone control unit within the vehicle network to transmit data with integrity by filtering out erroneous data through mutual comparison of data generated by its own computation and received data.

A vehicle control system and method according to example embodiments of the present disclosure can quickly detect an error when it occurs within the system and take appropriate countermeasures through a multi-core system and a register-based control structure.

A vehicle control system and method according to example embodiments of the present disclosure monitor and control the entire vehicle system with a centralized control method for consistent control of the entire vehicle system. Therefore, it can effectively manage data generated in each zone of the vehicle and efficiently allocate necessary resources.

### BRIEF DESCRIPTION OF THE DRAWINGS

FIG. 1a is a block diagram of a vehicle network (1) capable of controlling a plurality of zones in a vehicle.

FIG. 1b is an internal block diagram of a zone control unit (150) constituting a vehicle control system (1-1) for controlling a plurality of zones in a vehicle according to a comparative embodiment of the present disclosure.

FIG. 2a is a schematic diagram of a vehicle control system (2-1) for a vehicle's zone architecture network.

FIG. 2b is a schematic diagram of a vehicle control system (2-2) for a vehicle's zone architecture network.

FIG. 3 is a schematic diagram of a vehicle control system (2-3) for a vehicle zone architecture network according to an embodiment of the present disclosure.

FIG. 4 is a schematic diagram of a vehicle control system (2-4) according to another embodiment of the present disclosure.

FIG. 5 is a diagram showing a signal flow of a vehicle control system (3) according to another embodiment of the present disclosure.

FIG. 6 is a schematic block diagram of a vehicle control system (4) capable of controlling a plurality of zones in a vehicle according to another embodiment of the present disclosure.

FIG. 7 is a block diagram showing a partial internal configuration of a vehicle control system (5) according to another embodiment of the present disclosure.

FIG. 8 is a block diagram of a device (6) for controlling in-vehicle devices according to a comparative embodiment of the present disclosure.

FIGS. 9a and 9b are block diagrams of a device (7-1, 7-2) for controlling in-vehicle devices according to an embodiment of the present disclosure.

FIGS. 10a and 10b are schematic block diagrams of a vehicle control system (800) according to another embodiment of the present disclosure.

FIG. 11 is an internal block diagram of a vehicle control system (9) constituting a vehicle network according to another embodiment of the present disclosure.

FIG. 12 is a block diagram showing a detailed internal configuration of a central control unit (10) according to an embodiment of the present disclosure.

FIG. 13 is a block diagram showing a detailed internal configuration of a central control unit (11) according to another embodiment of the present disclosure.

FIG. 14 is a block diagram showing a detailed internal configuration of a first zone control unit (12) according to another embodiment of the present disclosure.

FIG. 15 is a diagram for explaining a method of directly controlling an actuator by a first zone control unit (13) according to another embodiment of the present disclosure.

FIG. 16 is a diagram showing signal paths within a zone control unit (1400) in a vehicle control system (14) for a zone architecture according to another embodiment of the present disclosure.

FIGS. 17a to 17d are diagrams showing a part of the operation of the network subsystem (1330) of FIG. 14 and FIG. 15, corresponding to the first path (A) shown in FIG. 16.

FIG. 18 is a diagram showing the components and operation of a network device (16) according to an embodiment of the present disclosure.

FIG. 19 is an internal block diagram of a first zone control unit (17) using register mirroring according to another embodiment of the present disclosure.

FIG. 20 is a block diagram showing a detailed internal configuration of a first zone control unit (18) according to another embodiment of the present disclosure.

FIG. 21 is a block diagram showing a detailed internal configuration of a first zone control unit (19) according to another embodiment of the present disclosure.

FIG. 22 is a block diagram of a vehicle control apparatus (20) for generating an actuator driving signal according to an embodiment of the present disclosure.

FIG. 23 is a block diagram of an input/output subsystem (21) composed of a plurality of General Purpose Serial Bus (GPSB) controllers according to an embodiment of the present disclosure.

FIG. 24 is a block diagram of an input/output subsystem (22) according to another embodiment of the present disclosure.

FIGS. 25 and 26 are block diagrams of vehicle control systems (23, 24) including ECUs (2310, 2440, 2450) with improved functional safety for actuator control according to another embodiment of the present disclosure.

FIG. 27 is a block diagram of a vehicle control apparatus (25) that directly controls an in-vehicle actuator according to another embodiment of the present disclosure.

FIG. 28 is an internal block diagram of a zone control unit (26) used in an in-vehicle zone architecture network according to another embodiment of the present disclosure.

FIGS. 29 and 30 are internal block diagrams of zone control units (27, 28) used in an in-vehicle zone architecture network, as modified embodiments of FIG. 28.

FIG. 31 is an internal block diagram of a driving control unit (29) according to an embodiment of the present disclosure.

FIG. 32 is an internal block diagram of a network device (30) within a zone control unit including a path controller (3005) according to another embodiment of the present disclosure.

FIGS. 33a and 33b are internal block diagrams of a network device (31) within a zone control unit according to another embodiment of the present disclosure.

FIG. 34 is a schematic diagram of a centralized vehicle control system (32) in which the in-vehicle computing unit is integrated into the central control unit according to another embodiment of the present disclosure.

FIG. 35 is an internal configuration diagram of a driving control unit (33) of a zone control unit according to another embodiment of the present disclosure.

FIG. 36 is an internal block diagram of a driving signal generator (34) according to a comparative embodiment of the present disclosure.

FIG. 37 is an internal block diagram of a driving signal generator (35) according to an embodiment of the present disclosure.

FIG. 38 is a diagram showing a signal flow in a zone control system (36) having data security and a backup path according to another embodiment of the present disclosure.

FIG. 39 is a block diagram of a zone control unit (37) constituting the zone control system (36) of FIG. 38 according to another embodiment of the present disclosure.

FIG. 40 is a configuration diagram of a vehicle control system (38) which is another embodiment of the present disclosure.

FIGS. 41a and 41b are diagrams showing a frame (3900) generated by a vehicle control system for directly controlling an actuator according to an embodiment of the present disclosure.

FIGS. 42 and 43 are flowcharts of a vehicle control system controlling an actuator using the frame (3900) according to an embodiment of the present disclosure.

### DETAILED DESCRIPTION OF EXAMPLE EMBODIMENTS OF THE INVENTION

The present disclosure is capable of various modifications and may have various embodiments. Accordingly, specific embodiments thereof are illustrated in the drawings and will be described in detail in the detailed description. However, this is not intended to limit the present disclosure to particular embodiments, and it should be understood that the present disclosure includes all modifications, equivalents, and substitutes included in the spirit and scope of the present invention. In describing the present disclosure, if it is determined that a detailed description of a related known technology may obscure the gist of the present disclosure, the detailed description thereof will be omitted.

Terms such as “first,” “second,” etc., may be used to describe various components, but the components should not be limited by these terms. These terms may be used only for the purpose of distinguishing one component from another.

The terminology used in the present disclosure is for the purpose of describing particular embodiments only and is not intended to be limiting of the invention. The terminology used in the present disclosure has been selected from general terms that are currently widely used, considering their functions in the present disclosure. However, these terms may vary depending on the intention of a person skilled in the art, legal precedents, or the emergence of new technologies. Also, in certain cases, there are terms arbitrarily selected by the applicant. In such cases, their meanings will be described in detail in the corresponding description of the disclosure. Therefore, the terms used in the present disclosure should be defined based on the meaning they have and the overall content of the disclosure, not just their simple names.

A singular expression may include a plural expression unless the context clearly indicates otherwise. In the present disclosure, terms such as “comprising” or “having” are intended to specify the presence of stated features, numbers, steps, operations, components, parts, or combinations thereof, and not to preclude the presence or addition of one or more other features, numbers, steps, operations, components, parts, or combinations thereof.

Hereinafter, a “Domain” may refer to an area that integrally manages a group of systems for a specific function within a vehicle. A “Chassis Domain” may include all control systems related to steering, braking, safety, wheels, and the vehicle's driving performance, stability, and ride comfort. A “Powertrain Domain” may include all control systems related to propulsion, such as the engine, transmission, and battery management system. A “Body Domain” may include systems that control the vehicle's exterior and convenience functions, such as lighting, door locks, and window control. An “Infotainment Domain” may include systems that provide information and entertainment to occupants, such as audio, video, navigation, internet connectivity, and displays. Furthermore, an “ADAS/Autonomous Driving Domain” may include systems that manage advanced driver-assistance systems and autonomous driving technologies.

Hereinafter, a “Zone” refers to a specific physical zone or region within a vehicle, and a “Zone Control System” may include a system that individually controls and manages a specific physical zone or region within the vehicle.

Hereinafter, a “Zone Architecture Network” may include a communication infrastructure designed to efficiently communicate data between various zones within a vehicle and to control the systems within each zone.

Hereinafter, a “Zone Control Unit” or “Zone control apparatus” may include a device or apparatus that independently manages and controls devices or apparatus within a specific physical area or zone in a vehicle. A Zone Control Unit may include an MCU subsystem and a network subsystem. The Zone Control Unit may further include at least one of an input/output subsystem, a memory subsystem, and a driving control unit.

Hereinafter, “Devices in Vehicle” may include headlights, air conditioning controller, side mirrors, seats, mood lamps, power windows, door locks, soft closing, trunk door locks, power trunk, taillights, wipers, rear curtain, washers, wireless charging, telescopic steering, sunroof, steering, and the like.

Hereinafter, a “user manipulation unit” may include door lock, window, and mirror operation switches installed in the vehicle cabin, a touch panel in the cluster, an accelerator pedal, a brake pedal, a steering wheel, and a user remote device.

Hereinafter, a “Vehicle control system” refers to a collection of electronic and mechanical systems that manage and control various functions and operations within a vehicle. A vehicle control system may include a central control unit and a plurality of zone control units connected by a communication network. The vehicle control system may further include at least one Electronic Control Unit (ECU). The vehicle control system may also further include at least one sensor and at least one actuator.

Hereinafter, a “Vehicle control apparatus” may have at least one of the functions of communication, routing, switching, computation, and driving signal generation. The vehicle control apparatus may include a central control unit and a plurality of zone control units. The vehicle control apparatus may further include at least one Electronic Control Unit (ECU). The vehicle control apparatus may also further include a driving control unit.

Hereinafter, an “MCU sub system” (Micro Control Unit sub system) is a component of a vehicle control apparatus that executes a specific program for a specific input to produce a result. The MCU subsystem may include a plurality of computing units. The MCU subsystem may further include a dedicated bus system and the like.

Hereinafter, a “Memory sub system” is a component of a vehicle control apparatus that manages data storage and access. The memory subsystem may include a DMA (Direct Memory Access) controller and various types of memory. The memory subsystem may further include at least one of a Deep Packet Inspection (DPI) module and a dedicated bus system.

Hereinafter, a “CPU sub system” is a component of a vehicle control apparatus responsible for implementing the vehicle's user applications. The CPU subsystem may include a plurality of high-performance processors (e.g., ARM's Cortex-A65AE). The CPU subsystem may further include a dedicated bus system.

Hereinafter, a “Network sub system” is a component of a vehicle control apparatus that controls the data flow within the vehicle control apparatus and between vehicle control apparatuses. The network subsystem may include a routing/switching module. The network subsystem may further include an Ethernet/CAN/LIN communication module. The network subsystem may further include a protocol conversion module. The network subsystem may further include a parsing unit that extracts specific data from a packet or frame.

Hereinafter, a “Driving signal processing unit” is a component of a vehicle control apparatus that generates a signal for driving using command data or a processing result value for driving transmitted from the network subsystem. The driving signal processing unit may include an Input/Output sub system and a Driving control unit.

Hereinafter, an “Input/Output sub system” may convert input data into a serial communication protocol and transmit it to the driving control unit. The input/output subsystem may include a plurality of communication controllers (e.g., serial communication controllers).

Hereinafter, a “Driving control unit” is a component of a vehicle control apparatus that generates a driving signal (e.g., a PWM signal). The driving control unit may include a register and a register interface. The driving control unit may further include a Pulse signal generation module. The driving control unit may further include a clock interface.

Hereinafter, a “Network device” is a component of a vehicle control apparatus that integrally performs the functions of a Network sub system and a Driving Signal Processing Unit.

Hereinafter, a “NoC (Network On Chip) bus system” is a bus system designed to efficiently handle communication between multiple components (e.g., cores or processor cores, memory modules or memory subsystems, peripheral devices, etc.) within a System-on-Chip (SoC).

Hereinafter, a “node” may include a vehicle control apparatus (central control unit, zone control unit, ECU) connected to a network subsystem, and a driving signal processing unit inside the vehicle control apparatus.

Hereinafter, a “packet” is a unit of transmission delivered by L3 switches, routers, etc., when transmitted through a vehicle network at the Network Layer.

Hereinafter, a “frame” is a unit of transmission at the Data Link Layer, and a transmission frame may include information such as a checksum for error checking on the data sent from an upper layer, addresses of the source and destination hosts, and other control codes used by the protocol.

Hereinafter, a “Command signal” refers to a signal received from a user manipulation unit, a sensor, or a domain system to operate an in-vehicle device. And “command data” indicates the target operation and target state of the in-vehicle device instructed by the command signal. Furthermore, a “calculation result value for driving” may include control parameter values (e.g., amplitude, period, width, etc. of a PWM signal) that determine the form of a driving signal (e.g., PWM) corresponding to the polarity and output amount calculated to achieve the target operation and target state of the in-vehicle device included in the command data.

Hereinafter, embodiments of the present disclosure will be described in detail with reference to the accompanying drawings. In describing with reference to the accompanying drawings, identical or corresponding components are given the same reference numbers, and redundant descriptions thereof will be omitted.

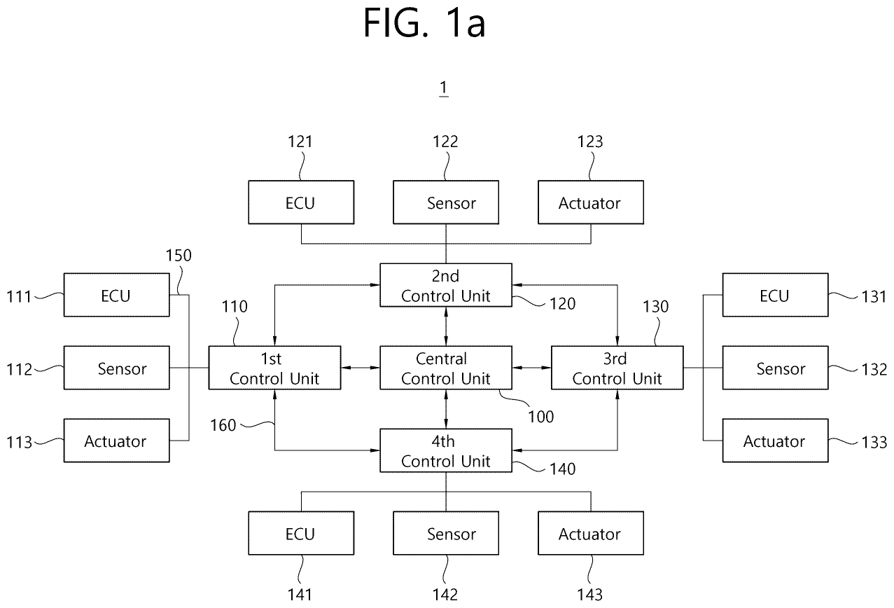

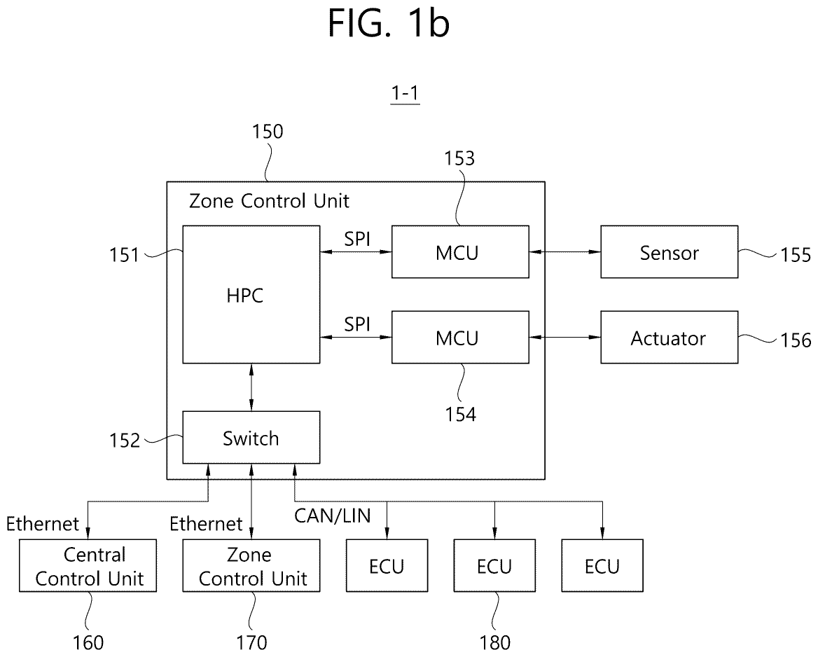

FIG. 1a is a block diagram of a vehicle network (1) capable of controlling a plurality of zones in a vehicle.

The vehicle network (1) shown in FIG. 1a may include one central control unit (100) and first to fourth zone control units (110, 120, 130, 140). The first zone control unit (110) can communicate with and directly control the central control unit (100), adjacent zone control units (120, 140), and at least one Electronic Control Unit (ECU) (111), at least one sensor (112), and at least one actuator (113) located in the first zone assigned to it. The second to fourth zone control units (120, 130, 140) also perform the same functions as the first zone control unit (110).

As shown in FIG. 1a, the present disclosure illustrates one central control unit (100) and four zone control units (110, 120, 130, 140). However, this is just one embodiment, and the number of zone control units is not limited to four and can be implemented with a number other than four. The central control unit (100) may include an interface (not shown) for diagnostics from the outside, firmware updates, and Over-The-Air (OTA) communication with the outside. Also, the central control unit (100) can be connected to chassis, powertrain, and body domain controllers to receive respective domain control commands. And the central control unit (100) can transmit the received control command to the zone control unit containing the target device or broadcast it to adjacent zone control units.

The central control unit (100), zone control units (110, 120, 130, 140), ECUs (111, 121, 131, 141), and sensors (112, 122, 132, 142) can receive control command signals for in-vehicle devices from an in-vehicle switch, an in-vehicle Human-Machine Interface (HMI), or a remote device. The ECUs (111, 121, 131, 141) connected to the zone control units (110, 120, 130, 140) can control in-vehicle devices in response to the control command signals. Each zone control unit (110, 120, 130, 140) analyzes messages obtained through communication with the central control unit (100) and adjacent zone control units, and each zone control unit can control in-vehicle devices by transmitting signals with different forms and information to its connected ECUs or actuators.

As shown in FIG. 1a, the first to fourth zone control units (110, 120, 130, 140) can be connected in a ring topology network structure. The first to fourth zone control units (110, 120, 130, 140) and the central control unit (100) can be connected in a star topology network structure. Therefore, the communication path between the first to fourth zone control units (110, 120, 130, 140) and the central control unit (100) has a hardware backup path. This enables uninterrupted communication.

Each zone control unit (110, 120, 130, 140) may include a network switch. And each zone control unit can transmit a packet received from the central control unit (100) and adjacent zone control units to a first contact node that includes the target in-vehicle device intended by the packet. Here, the first contact node is connected to the unit (e.g., central control unit, zone control unit, ECU, sensor) that first received the command signal. Also, the first contact node can be the central control unit (100) or a zone control unit (110, 120, 130, 140) or an ECU (111, 121, 131, 141) that includes the target device included in the command signal downstream.

The devices connected to the network switch of each zone control unit (110, 120, 130, 140) are identified by a network address. Therefore, the network switch can direct traffic flow that maximizes the security and efficiency of the network.

Communication between the central control unit (100) and the zone control units (110, 120, 130, 140) and between the zone control units (110, 120, 130, 140) can use Ethernet communication at different speeds. In particular, communication between the central control unit (100) and the zone control units (110, 120, 130, 140) can be implemented as a backbone communication network based on Time-Sensitive Networking (TSN). Communication between the zone control units (110, 120, 130, 140) and ECUs (111, 121, 131, 141), sensors (112, 122, 132, 142), and actuators (113, 123, 133, 143) can be implemented with low-speed Ethernet, CAN, LIN, and hard-wiring.

Hereinafter, in a vehicle zone architecture network capable of controlling a plurality of zones in a vehicle, the sensors connected to the zone control units include autonomous vehicle sensors such as cameras, radars, or lidars that process large amounts of data. These sensors can include collision detection sensors, lane departure detection sensors, ultrasonic sensors, parking assistance sensors, speed sensors, acceleration sensors, GPS sensors, temperature sensors, humidity sensors, gas sensors, fine dust sensors, and lighting sensors that process small amounts of data.

The vehicle network (1) shown in FIG. 1a meets the strict end-to-end low latency requirements often required by real-time and mission-critical applications. Therefore, the vehicle network (1) provides real-time guarantees such as bounded latency, low packet delay variation, and low packet loss using standard protocols like Time-Sensitive Networking (TSN). The vehicle network (1) ensures deterministic traffic delivery using various mechanisms such as time synchronization, scheduling, and traffic shaping between nodes.

On the other hand, each zone control unit (110, 120, 130, 140) can transmit a packet including its own identifier and a copy of the packet in a first direction and a second direction, respectively, at regular time intervals. The first direction can be clockwise in a ring structure centered on the central control unit (100), and the second direction can be counter-clockwise. Its own identifier may include its own device number, protocol type, a timestamp indicating the period when the data was generated, and a checksum to verify data integrity.

If a received packet is not for itself or its downstream device, the zone control unit (110 to 140) first checks for data corruption. If corruption exists, the packet is discarded. If there is no corruption, it can determine whether the currently received message is a duplicate of an already received message. If it is a duplicate, the currently received message is discarded. If it is not a duplicate, the current message can be retransmitted in the first and second directions. Through this, even if a communication error occurs between specific zone control units, a backup communication network can be established where data is reliably transmitted to the target device.

FIG. 1b is an internal block diagram of a zone control unit (150) constituting a vehicle control system (1-1) for controlling a plurality of zones in a vehicle according to a comparative embodiment of the present invention.

The zone control unit (150) shown in FIG. 1b may include a high-performance CPU (HPC) (151) for managing the ECUs in a certain area of the vehicle. The zone control unit (150) may also include a switch (152) that transmits externally input data to a central control unit (160) or another zone control unit (170), and MCUs (153, 154) for controlling sensors (155) and actuators (156).

The zone control unit (150) of FIG. 1b is composed of a chip in which the HPC (151) and the switch (152) are integrated. However, the MCUs (153, 154) may not be integrated.

In the zone control unit (150) of FIG. 1b, if a failure occurs in the MCU (154) that controls the actuator (156), the MCU (154) can transmit a signal indicating that a failure has occurred to the outside. However, a problem arises in that it can no longer generate a signal to control the actuator (156). Therefore, the failure signal can be detected from the outside and the corresponding system can be recovered. However, the corresponding actuator (156) will not operate at all until the recovery time. Therefore, a control device is needed that integrates the MCU (154) and can continuously control the actuator without interruption even when a failure occurs in the MCU (154).

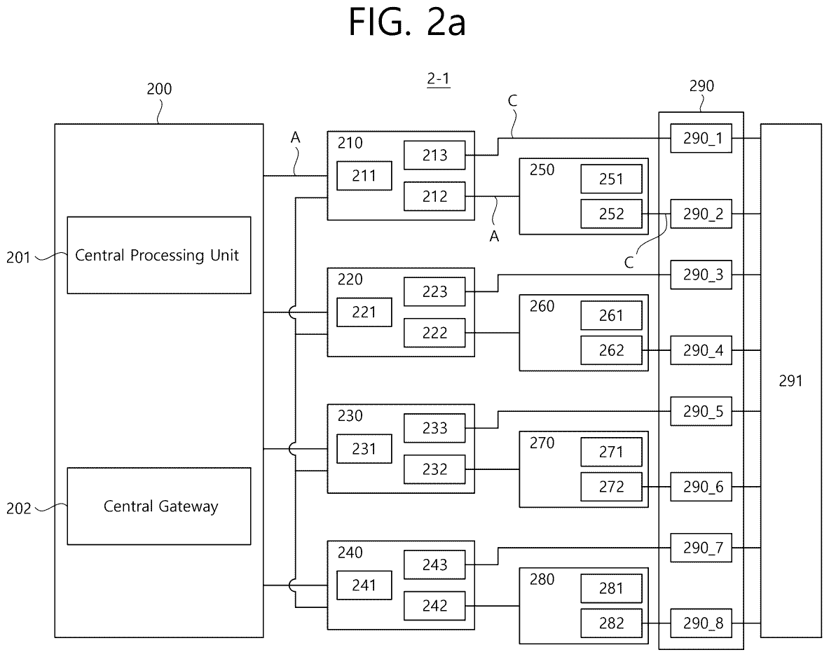

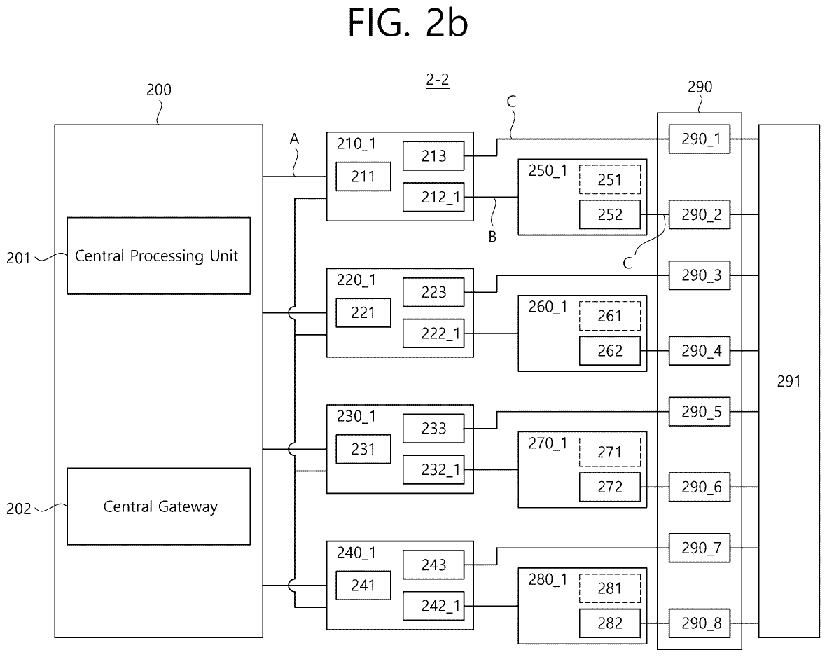

FIG. 2a is a schematic diagram of a vehicle control system (2-1) for a vehicle's zone architecture network.

As shown in FIG. 2a, a vehicle control system (2-1) for a zone architecture network may include one central control unit (200), a plurality of zone control units (210, 220, 230, 240), and a plurality of Electronic Control Units (250, 260, 270, 280). The vehicle control system (2-1) may further include a plurality of actuators (290). The plurality of actuators (290) drive in-vehicle devices (291). A sensor (not shown) and a user input device (not shown) that receive control command signals for the in-vehicle devices (291) can be connected to at least one of the central control unit (200), the plurality of zone control units (210, 220, 230, 240), and the plurality of Electronic Control Units (250, 260, 270, 280).

As shown in FIG. 2a, to configure a zone architecture, the vehicle control system (2-1) may require a central gateway (202) and L2/L3 switches (211, 221, 231, 241) in each zone control unit (210, 220, 230, 240) and the central control unit (200). Therefore, in the vehicle control system (2-1), a plurality of computing units (201, 202, 211, 212, 221, 222, 231, 232, 241, 242, 251, 261, 271, 281) can be placed in each of the central control unit (200), zone control units (210, 220, 230, 240), and ECUs (250, 260, 270, 280). The central computing unit (201) of the central control unit (200) can control the data flow with the zone control units (210, 220, 230, 240) and external systems (not shown). Therefore, the central computing unit (201) of the central control unit (200) and the computing unit within the central gateway (202) are high-performance processors. And the first computing units (212, 222, 232, 242) within the zone control units (210, 220, 230, 240) and the second computing units (251, 261, 271, 281) within the ECUs can be implemented with low-performance processors.

The signal that the zone control unit (210, 220, 230, 240) directly transmits to an actuator it directly controls among the plurality of actuators (290_1 to 290_8) and the signal that the zone control unit (210, 220, 230, 240) transmits to an ECU (250, 260, 270, 280) may differ in their form and the information they contain. That is, the signal transmitted from the zone control unit (210, 220, 230, 240) to the ECU (250, 260, 270, 280) can be in the form of a packet or frame based on CAN, LIN, or Ethernet. The packet or frame may include actuator command data (A) which includes the target in-vehicle device, target operation, and target state. On the other hand, the signal directly transmitted from the zone control unit (210, 220, 230, 240) to the actuator (290) it directly controls can be an actuator driving signal (C) such as a pulse signal (e.g., Pulse Width Modulation (PWM) signal).

The vehicle control system (2-1) for the zone architecture of FIG. 2a has a disadvantage in that the time from the generation of an actuator operation command to the actual operation can be long due to the multiple computation processing paths (e.g., a path through the computing units 201-202-211-212-251) that a single actuator command data (A) must go through.

FIG. 2b is a schematic diagram of a vehicle control system (2-2) for a vehicle's zone architecture network.

The ECUs (250_1, 260_1, 270_1, 280_1) of the vehicle control system (2-2) shown in FIG. 2b differ from the ECUs (250, 260, 270, 280) of FIG. 2a in that they do not have the computing units (251, 261, 271, 281) within the ECUs (250, 260, 270, 280) of FIG. 2a.

The central control unit (200) transmits actuator command data (A) to the zone control units (210_1, 220_1, 230_1, 240_1). And the zone control units (210_1, 220_1, 230_1, 240_1) can calculate a calculation result value for driving an actuator (B) using the actuator command data and transmit it to the ECUs (250_1, 260_1, 270_1, 280_1). The ECUs (250_1, 260_1, 270_1, 280_1) can generate an actuator driving signal (C) using the received calculation result value for driving an actuator (B) and transmit it to the actuator (290). That is, the computing units (212_1, 222_1, 232_1, 242_1) that directly control the actuator (290) are located only in the zone control units (210_1, 220_1, 230_1, 240_1).

The calculation result value for driving an actuator (B) transmitted by the zone control unit (210_1, 220_1, 230_1, 240_1) to the ECU (250_1, 260_1, 270_1, 280_1) can be transmitted in the form of a packet or frame based on CAN, LIN, or Ethernet. And the calculation result value for driving an actuator (B) may include control parameter values that determine the form of the actuator driving signal (C). On the other hand, the signal directly transmitted from the zone control unit (210_1, 220_1, 230_1, 240_1) to the actuator (290) may include an actuator driving signal (C) such as a Pulse Width Modulation (PWM) signal.

A disadvantage of the vehicle control system (2-2) of FIG. 2b is that the functionally complex computing units (212_1, 222_1, 232_1, 242_1) are distributed in the zone control units (210_1, 220_1, 230_1, 240_1), and synchronization between the zone control units (210_1, 220_1, 230_1, 240_1) can become difficult. Accordingly, an error in the actuator driving signal (C) or a variation in the time it reaches the actuator may occur.

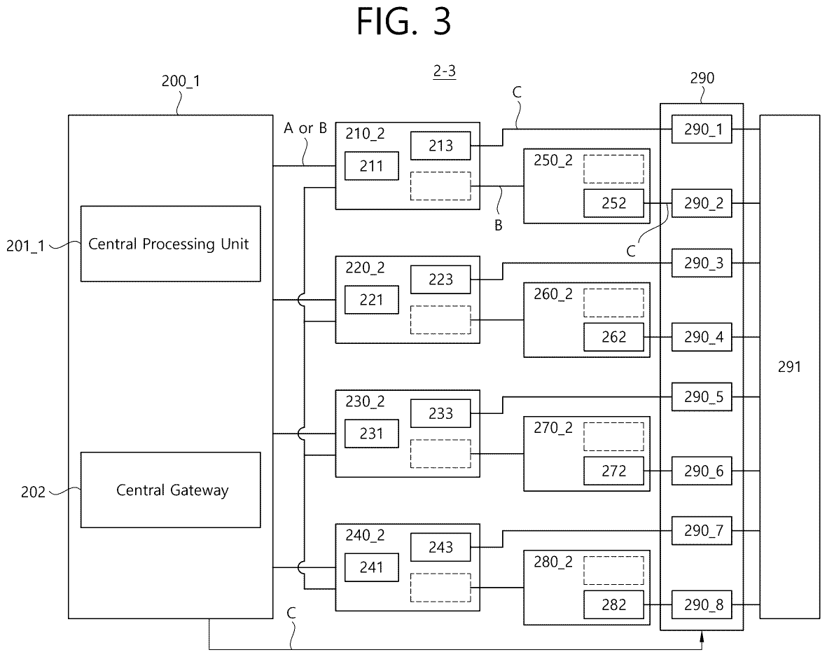

FIG. 3 is a schematic diagram of a vehicle control system (2-3) for a vehicle zone architecture network according to an embodiment of the present disclosure.

The vehicle control system (2-3) of FIG. 3 shows that the functions of the computing units (212, 222, 232, 242, 251, 261, 271, 281) of the zone control units (210, 220, 230, 240) and ECUs (250, 260, 270, 280) of the vehicle control system (2-1) of FIG. 2a can also be integrated into the central computing unit (201_1) of the central control unit (200_1). That is, a central computing unit (201_1) with high-capacity memory and a high-performance processor can be placed in the central control unit (200_1) to control all actuators (290) inside the vehicle.

The central control unit (200_1) can directly transmit an actuator driving signal (C) generated using externally received command data (A) to the actuator (290).

The central control unit (200_1) can calculate a calculation result value for driving an actuator (B) using externally received actuator command data (A) and transmit it to the zone control units (210_2, 220_2, 230_2, 240_2).

The zone control units (210_2, 220_2, 230_2, 240_2) generate an actuator driving signal (C) using the received calculation result value for driving an actuator (B). And they can transmit the generated signal to an actuator directly connected to the zone control units (210_2, 220_2, 230_2, 240_2) among the plurality of actuators (290). Also, the zone control units (210_2, 220_2, 230_2, 240_2) can transmit the received calculation result value for driving an actuator (B) to the ECUs (250_1, 260_1, 270_1, 280_1).

The ECUs (250_2, 260_2, 270_2, 280_2) generate an actuator driving signal (C) using the received calculation result value for driving an actuator (B). And they can transmit the generated signal to an actuator directly connected to the ECUs (250_2, 260_2, 270_2, 280_2) among the plurality of actuators (290).

An advantage of the vehicle control system (2-3) of FIG. 3 is that precise synchronization between the zone control units (210_2, 220_2, 230_2, 240_2) is possible, resulting in a constant transmission delay time for each actuator. However, a disadvantage of the vehicle control system (2-3) of FIG. 3 is that if an error occurs in the central computing unit (201_1) of the central control unit (200_1), the entire function of the vehicle control system (2-3) can be interrupted.

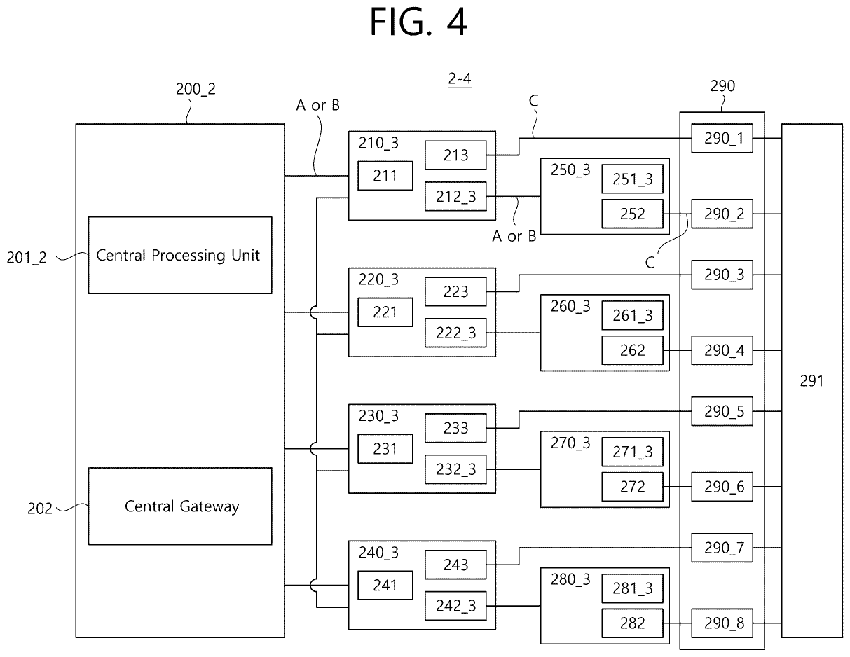

FIG. 4 is a schematic diagram of a vehicle control system (2-4) according to another embodiment of the present disclosure.

In the vehicle control system (2-4) shown in FIG. 4, a central computing unit (201_2) that controls all devices inside the vehicle can be placed in the central control unit (200_2). Here, all devices inside the vehicle may include actuators, autonomous driving control devices, driving assistance devices, braking control devices, and driving path control devices.

The central computing unit (201_2), during normal operation, uses the actuator command data (A) which includes the target operation or target state (operation direction, operation duration, etc.) for a target in-vehicle device received from the outside. Through this, it can broadcast the calculated calculation result value for driving an actuator (B) to the zone control units (210_3, 220_3, 230_3, 240_3). Here, the calculation result value for driving an actuator (B) may include control parameters for the actuator driving signal (C) to achieve the target operation or target state of the target in-vehicle device included in the actuator command data (A), and the actuator driving signal (C) may include a pulse signal. The control parameters may include at least one of a prescale value, a counter value, a compare value, a clock division value, a signal period, a signal pattern, and a signal amplitude.

The L2/L3 switches (211, 221, 231, 241) of the zone control units (210_3, 220_3, 230_3, 240_3) select the calculation result value for driving an actuator (B) that drives an in-vehicle device directly connected to them from the calculation result values for driving an actuator (B) transmitted from the central control unit (200_2), and they transmit it to the first driving signal generators (213, 223, 233, 243). The first driving signal generators (213, 223, 233, 243) can generate an actuator driving signal (C) using the selected calculation result value for driving an actuator (B) and transmit the signal to the actuator (290). Furthermore, the zone control units (210_3, 220_3, 230_3, 240_3) select the calculation result value for driving an actuator (B) that drives an in-vehicle device connected to an ECU connected to them, and they can transmit it to the ECUs (250_3, 260_3, 270_3, 280_3) connected to them.

The ECUs (250_3, 260_3, 270_3, 280_3) generate an actuator driving signal (C) using the calculation result value for driving an actuator (B) transmitted by the zone control units (210_3, 220_3, 230_3, 240_3), and they can transmit it to the actuators (290) connected to them.

The zone control units (210_3, 220_3, 230_3, 240_3) may further include first hidden computing units (212_3, 222_3, 232_3, 242_3). The first hidden computing units (212_3, 222_3, 232_3, 242_3) can calculate the same calculation result value for driving an actuator (B) as that calculated by the central computing unit (201_2) for the same actuator command data (A).

In the vehicle control system (2-4) of FIG. 4, while the central computing unit (201_2) is operating normally, the first hidden computing units (212_3, 222_3, 232_3, 242_3) of the zone control units (210_3, 220_3, 230_3, 240_3) and the second hidden units (251_3, 261_3, 271_3, 281_3) of the ECUs (250_3, 260_3, 270_3, 280_3) may be deactivated.

A monitoring device (e.g., a lockstep structure) within the central computing unit (201_2) detects a computation error of the central computing unit (201_2). If an error occurs in the central computing unit (201_2), the central gateway (202) of the central control unit (200_2) and the L2/L3 switches (211, 221, 231, 241) of the zone control units (210_3, 220_3, 230_3, 240_3) can transmit the actuator command data (A) input to the central control unit (200_2) after the error detection of the central computing unit (201_2) to the zone control units (210_3, 220_3, 230_3, 240_3).

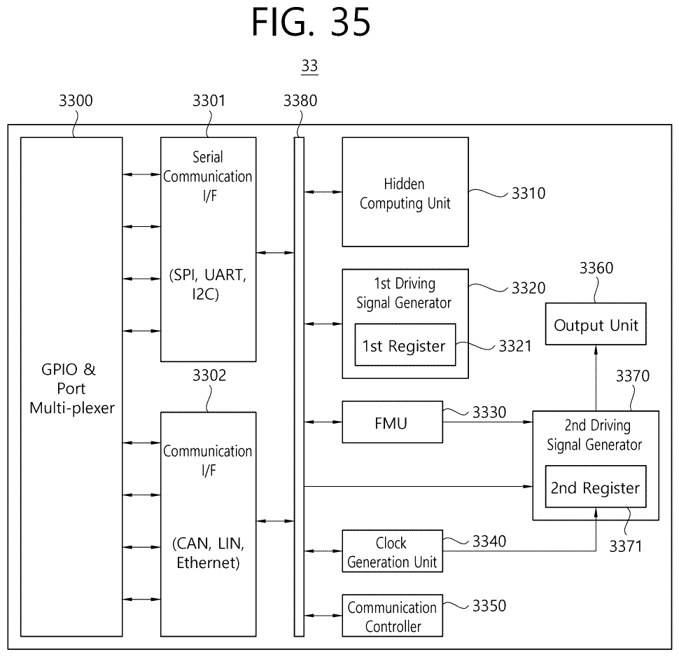

The ECUs (250_3, 260_3, 270_3, 280_3) transmit the actuator command data (A) that drives a device directly connected to them among the received actuator command data (A) to the first hidden computing units (212_3, 222_3, 232_3, 242_3). The first hidden computing units (212_3, 222_3, 232_3, 242_3) can calculate a calculation result value for driving an actuator (B) using the received actuator command data (A) and transmit it to the register interface (3510 of FIG. 35) of the first driving signal generators (213, 223, 233, 243).

The first driving signal generators (213, 223, 233, 243) can generate an actuator driving signal (C) according to the calculation result value for driving an actuator (B) transmitted by the first hidden computing units (212_3, 222_3, 232_3, 242_3) and their own clock signals.

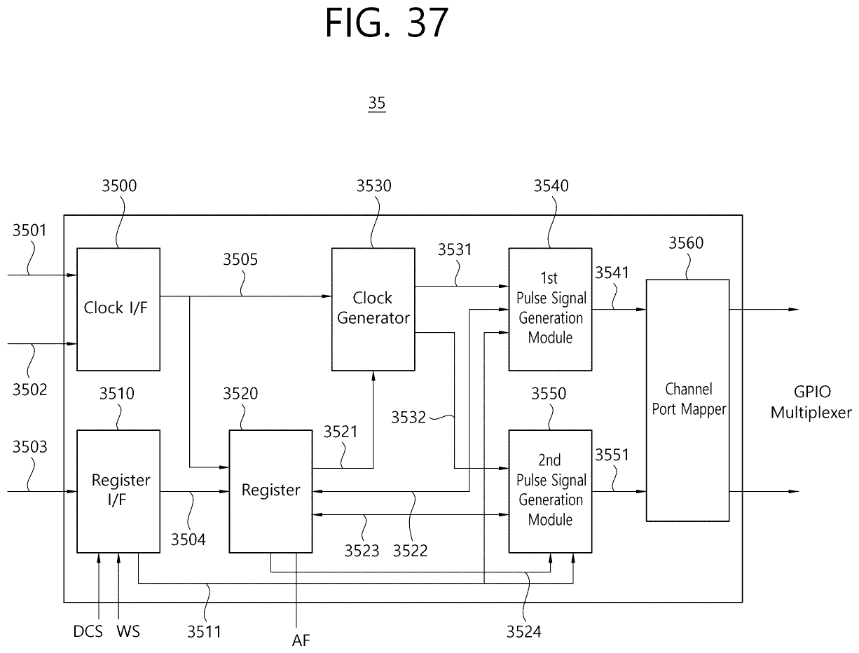

The L2 switches (211, 221, 231, 241) of the zone control units (210_3, 220_3, 230_3, 240_3) transmit the actuator command data (A) corresponding to an in-vehicle device connected to an ECU (250_3, 260_3, 270_3, 280_3) connected to them among the received actuator command data (A) to the ECU (250_3, 260_3, 270_3, 280_3). The second hidden computing units (251_3, 261_3, 271_3, 281_3) of the ECUs (250_3, 260_3, 270_3, 280_3) can transmit the calculation result value for driving an actuator (B) calculated using the received actuator command data (A) to the register interface (3510 of FIG. 37) of the second driving signal generators (252, 262, 272, 282).

The second driving signal generators (252, 262, 272, 282) can generate an actuator driving signal (C) according to the calculation result value for driving an actuator (B) transmitted by the second hidden computing units (251_3, 261_3, 271_3, 281_3) and a clock signal. Meanwhile, if an error is detected in the second hidden computing units (251_3, 261_3, 271_3, 281_3), the first hidden computing units (212_3, 222_3, 232_3, 242_3) or the L2 switches (211, 221, 231, 241) of the zone control units (210_3, 220_3, 230_3, 240_3) can transmit the calculation result value for driving an actuator (B) calculated by the first hidden computing units (212_3, 222_3, 232_3, 242_3) to the register interface (3510 of FIG. 37) of the second driving signal generators (252, 262, 272, 282) of the ECUs (250_3, 260_3, 270_3, 280_3).

The register interface and register (3510 and 3520 of FIG. 37) of the second driving signal generators (252, 262, 272, 282) receive a direct control signal (DCS) transmitted by the central computing unit (201_2), the first hidden computing units (212_3, 222_3, 232_3, 242_3), or the second hidden computing units (251_3, 261_3, 271_3, 281_3). Then, they directly transmit the input calculation result value for driving an actuator (B) to the pulse signal generation modules (see 3540, 3550 of FIG. 37) within the second driving signal generators (252, 262, 272, 282).

The register interface and register (3510 and 3520 of FIG. 37) of the second driving signal generators (252, 262, 272, 282) receive a write control signal (WS) transmitted by the central computing unit (201_2), the first hidden computing units (212_3, 222_3, 232_3, 242_3), or the second hidden computing units (251_3, 261_3, 271_3, 281_3). Then, they can write the input calculation result value for driving an actuator (B) to a specific address of the register (see 3520 of FIG. 37).

The direct control signal (DCS) input to the register interface (see 3510 of FIG. 37) is input from an upper-level system (e.g., central computing unit, computing unit of a zone control unit) when driving an urgent device, and the write signal can be input when driving a less urgent device. That is, the pulse signal generation modules (see 3540, 3550 of FIG. 37) can finally output the actuator driving signal (C) by directly using the configuration value stored in the register (3520) or the calculation result value for driving an actuator (B), or the calculation result value for driving an actuator (B) transmitted from the central computing unit (201_2), the first hidden computing units (212_3, 222_3, 232_3, 242_3), or the second hidden computing units (251_3, 261_3, 271_3, 281_3).

Also, if an error is detected in the calculation result value for driving an actuator (B) transmitted from the central computing unit (201_2), the first hidden computing units (212_3, 222_3, 232_3, 242_3), or the second hidden computing units (251_3, 261_3, 271_3, 281_3), or if the state of the target device exceeds a limit value (i.e., if the register receives an error signal (AF) from the actuator), the register (3520) transmits a safety control parameter stored at a specific address to the pulse signal generation modules (see 3540, 3550 of FIG. 37). The safety control parameter can be an actuator control parameter that causes the device to stop or decelerate.

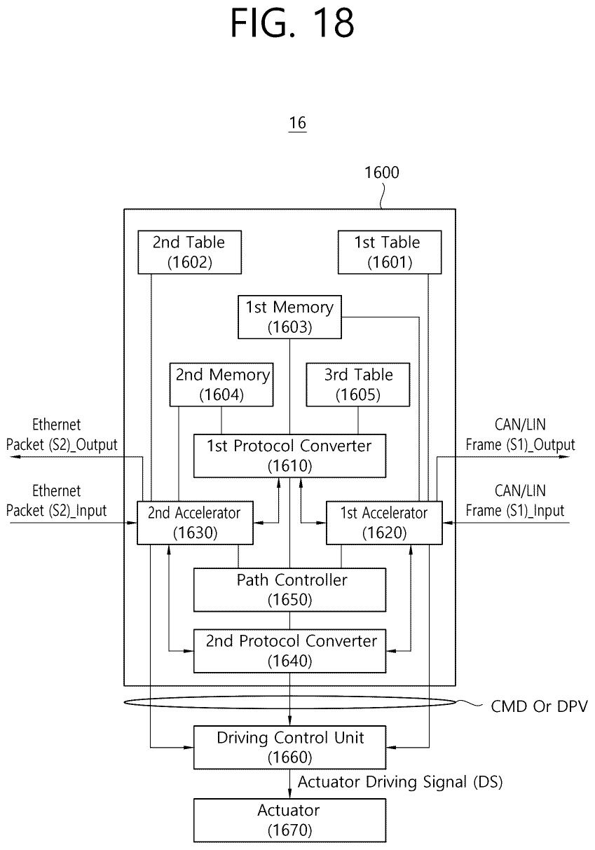

The vehicle control system (2-4) of FIG. 4 may include a signal tunneling module (not shown) that transmits the calculation result value for driving an actuator (B) calculated by the central control unit (200_2) or the zone control units (210_3, 220_3, 230_3, 240_3) to the first driving signal generators (213, 223, 233, 243) and the first and second pulse signal generation modules (3540 and 3550) within the second driving signal generators (252, 262, 272, 282) connected to the target device. The signal tunneling module may include a network stack and the register interface and register (see 3510 and 3520 of FIG. 37) within the first driving signal generators (213, 223, 233, 243) and the second driving signal generators (252, 262, 272, 282). The network stack may include the network device (16 of FIG. 18) of the central gateway (202), a communication interface, and the L2 switches (211, 221, 231, 241) and communication interface of the zone control units (210_3, 220_3, 230_3, 240_3).

The vehicle control system (2-4) of FIG. 4 uses the first hidden computing units (212_3, 222_3, 232_3, 242_3) and the second hidden computing units (251_3, 261_3, 271_3, 281_3). Through this, it becomes possible to continuously control the in-vehicle device (291) without interruption even if an error occurs in the central computing unit (201_2) of the central control unit (200_2).

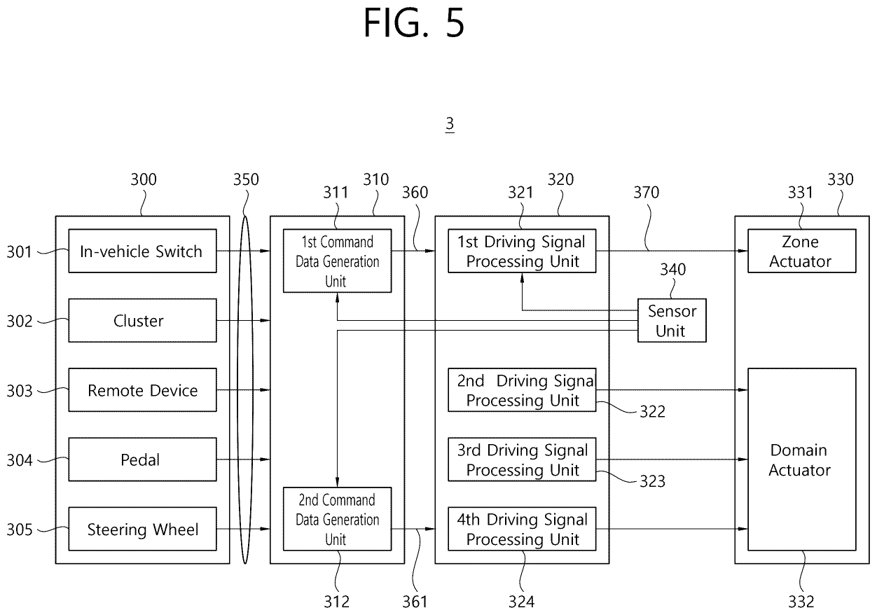

FIG. 5 is a diagram showing a signal flow of a vehicle control system (3) according to another embodiment of the present disclosure.

The command data generation unit (310) and the driving signal processing unit (320) shown in FIG. 5 can be included in the central control unit (100), zone control units (110, 120, 130, 140), and ECUs (111, 121, 131, 141) of FIG. 1a. Also, the actuator unit (330) shown in FIG. 5 may include zone actuators (331) that drive doors, seats, lighting, mirrors, etc., located in each zone. And it may include domain actuators (332) that control in-vehicle devices in the driving, braking, and steering domains. The sensor unit (340) may include sensors such as cameras, radars, and lidars.

A command signal (350) can be generated from an in-vehicle switch (301), a touch panel (302) of a cluster, a remote device (303), a pedal (304), or a steering wheel (305) within the user manipulation unit (300). Or it can be generated from an Advanced Driver Assistance System (ADAS) or an autonomous driving system. Thereafter, command data (360) is generated in a Command Data Generation Unit (310) (e.g., included within a central control unit, zone control unit, or ECU). Then, the command data (360) is calculated and interpreted in a Driver Signal Handler (320) to generate a driving signal (370). And it can be transmitted to the actuator unit (330).

The first command data generation unit (311) of the command data generation unit (310) identifies a command signal (350) (e.g., switch type, switch direction, switch activation time, etc.) input from the in-vehicle switch (301), the cluster's touch panel (302), and the remote device (303). And it can generate command data (360) indicating the target operation and target state of the target in-vehicle device.

The second command data generation unit (312) of the command data generation unit (310) is connected to the sensor unit (340). And the sensor unit (340) can detect the operating direction, position state of the vehicle's accelerator pedal, brake pedal, steering wheel, and the surrounding situation of the windows, doors, and vehicle.

The command data generation unit (310) finally determines the target operation (e.g., actuator driving speed, braking magnitude, driving path, etc.) by referring to the outputs of the first command data generation unit (311) and the second command data generation unit (312). And it can transmit it to the driving signal processing unit (320).

The command data generation unit (310) may include a plurality of computing units and communication interfaces.

The first to fourth driving signal processing units (321, 322, 323, 324) of the driving signal processing unit (320) achieve the target operation and target state of the target device included in the first and second command data (360, 361) transmitted from the first and second command data generation units (311, 312). For this purpose, they calculate the polarity and output amount of the driving signal (370). And they may include a computing unit (not shown) that calculates control parameter values (e.g., amplitude, period, width, etc. of a PWM signal) corresponding to the calculated polarity and output amount.

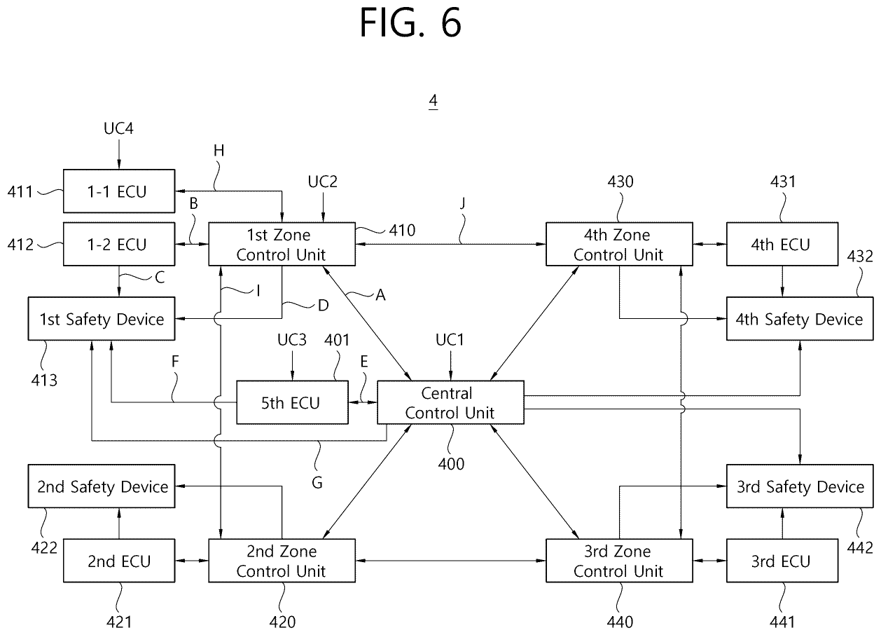

FIG. 6 is a schematic block diagram of a vehicle control system (4) capable of controlling a plurality of zones in a vehicle according to another embodiment of the present invention.

The vehicle control system (4) shown in FIG. 6 may include one central control unit (400) and a plurality of zone control units (410, 420, 430, 440). The one central control unit (400) and the plurality of zone control units (410, 420, 430, 440) can drive a plurality of ECUs (411, 412, 421, 431, 441) and a plurality of safety devices (413, 422, 442, 432).

The plurality of safety devices (413, 422, 442, 432) may include actuators that drive in-vehicle devices that are important for safety during vehicle operation. Hereinafter, such actuators and devices are collectively defined as safety devices. Safety devices may include, for example, an actuator that drives the brakes or an actuator that drives the steering system.

The vehicle control system (4) shown in FIG. 6 provides not just one, but a plurality of control paths for controlling the first safety device (413) in the first zone. This can ensure seamless control of the first safety device (413).

One of the plurality of paths may be determined according to at least one of the location, type, and identifier of the unit (e.g., central control unit, zone control unit, or ECU) to which the user manipulation unit (UC1, UC2, UC3, UC4) that generates the command signal for the in-vehicle device is connected. That is, when the central control unit (400) receives a command signal for the first safety device (413) from the first user manipulation unit (UC1), the control paths for the first safety device (413) may include the A-B-C path, the A-D path, the E-F path, and the G path. And when the first zone control unit (410) receives a command signal for the first safety device (413) from the second user manipulation unit (UC2), the control paths for the first safety device (413) can be the B-C path, the D path, and the A-E-F path. And when the fifth ECU (401) receives a command signal for the first safety device (413) from the third user manipulation unit (UC3), the control paths for the first safety device (413) may include the F path, the E-G path, the E-A-B-C path, and the E-A-D path.

Meanwhile, the vehicle control system (4) can update the plurality of paths for transmitting the command signal for the first safety device (413) in real-time or periodically. That is, the updated control path can be determined by the location and type of the unit receiving the command signal for the device, and the reliability of each path (including paths with short signal delay, low signal congestion, and large transmission bandwidth).

Also, each of the one central control unit (400), the plurality of zone control units (410, 420, 430, 440), and the plurality of ECUs (411, 412, 421, 431, 441) of FIG. 6 may include a monitoring device (not shown) that monitors its own status, the control paths connected to it, and the status of the safety devices connected to it. The monitoring device checks in real-time whether command data for a safety device has been received. And it determines whether its own operating state is normal. And it judges the reliability level for each control path connected to it. And it can check whether the state of the safety device is within a preset state range. If the operating result of the safety device confirmed by the monitoring device deviates from a preset state range corresponding to the device command data, the central control unit or zone control unit can make a decision to transmit the device driving signal for the safety device through at least one of a path with a higher reliability level according to a predetermined rule among the paths excluding the current path (including a path with short signal delay, a path with low signal congestion, and a path with large transmission bandwidth).

Also, the central control unit (400) can determine a new control path that does not pass through the faulty zone control unit or ECU.

Also, the zone control unit may include a signal conversion unit (not shown). And the signal conversion unit can perform at least one of protocol conversion between Ethernet and Ethernet, protocol conversion between CAN and CAN, protocol conversion between LIN and LIN, protocol conversion between CAN and LIN, protocol conversion between Ethernet and CAN, protocol conversion between Ethernet and LIN, signal conversion between Ethernet and serial communication, signal conversion between CAN and serial communication, and signal conversion between LIN and serial communication. That is, Ethernet-to-Ethernet protocol conversion is used when the first zone control unit (410) communicates with the central control unit (400) and adjacent zone control units (420, 430). And Ethernet-to-CAN and Ethernet-to-LIN protocol conversion can be used for the path (A-B-C path) where the first zone control unit (410) receives a signal (e.g., device command data or device driving calculation result value) from the central control unit (400) and transmits it to the first safety device (413) via the first-2 ECU (412). And protocol conversion between CAN and CAN, LIN and LIN, and CAN and LIN is used for the path (H-B-C) where a command signal for the first safety device (413) is received from the fourth user manipulation unit (UC4) connected to the first-1 ECU (411), transmitted to the first zone control unit, and the first zone control unit (410) transmits the command signal to the first-2 ECU (412) to which the first safety device (413) is connected. And signal conversion between Ethernet communication and serial communication can be used for the path (I-D, J-D) where the first zone control unit (410) receives a command signal from adjacent zone control units (420, 430) or the central control unit (400) and directly transmits it to the first safety device (413). And signal conversion between CAN communication and serial communication and LIN communication and serial communication can be used for the path (H-D) where the first zone control unit (410) receives a command signal from the first-1 ECU (411) and directly transmits it to the first safety device (413). That is, the procedure for protocol conversion of the signal conversion unit of the zone control unit can be determined according to the unit to which the command signal for the device is input and the transmission path of the command signal.

In FIG. 6, if an error occurs in the ECU or zone control unit connected to the first to fourth safety devices (413, 422, 432, 441), the central control unit (400) can determine a new path that does not pass through the faulty ECU or zone control unit and transmit data.

The central control unit (400), zone control units (410, 420, 430, 440), and ECUs (411, 412, 421, 431, 441) shown in FIG. 6 can receive command signals generated from user manipulation units (UC1, UC2, UC3, UC4) or sensors (not shown).

The central control unit (400), zone control units (410, 420, 430, 440), and ECUs (411, 412, 421, 431, 441) shown in FIG. 6 correspond to a command signal for a specific actuator (not shown) that controls a safety device (413, 422, 432, 442) among the command signals received from the user manipulation units (UC1, UC2, UC3, UC4) or sensors (not shown). And they generate at least one of command data, a calculation result value for driving, and a driving signal. And they can transmit at least one of the command data, the calculation result value for driving, and the driving signal to the central control unit (400), zone control units (410, 420, 430, 440), and ECUs (411, 412, 421, 431, 441) that directly control the specific actuator through a plurality of control paths.

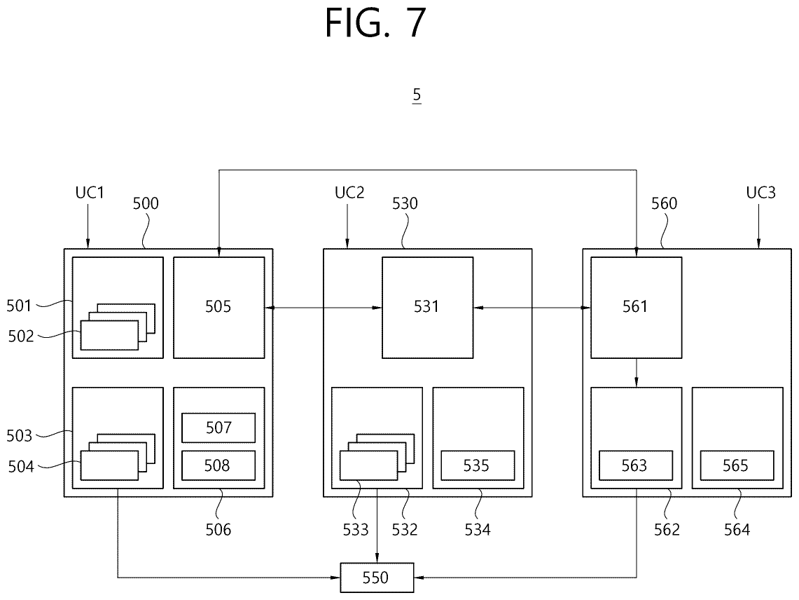

FIG. 7 is a block diagram showing a partial internal configuration of a vehicle control system (5) according to another embodiment of the present disclosure.

As shown in FIG. 7, the vehicle control system (5) that controls the safety actuator shown in FIG. 6 may include a central control unit (500), a zone control unit (530), and an ECU (560). And each can be connected to the safety actuator (550). Each of the central control unit (500), the zone control unit (530), and the ECU (560) can be connected to user manipulation units (UC1 to UC3) for the safety actuator (550).

The central control unit (500) may include a CPU subsystem (501) composed of a plurality of computing units (502). Also, the central control unit (500) may include a first MCU subsystem (503) composed of a plurality of computing units (504) that execute a specific operation program. Also, the central control unit (500) may include a first network subsystem (505) that receives at least one of the actuator command signals from the first to third user manipulation units (UC1 to UC3) and transmits it to the second network subsystem (531) of the zone control unit (530) or the communication module (561) of the ECU. Also, the central control unit (500) may include a first memory subsystem (506) for program storage and temporary data storage.

The zone control unit (530) may include a second MCU subsystem (532) composed of a plurality of computing units (533) that execute a specific operation program. Also, the zone control unit (530) may include a second network subsystem (531) that receives at least one of the command signals from the first to third user manipulation units (UC1 to UC3) and transmits it to the first network subsystem (505) of the central control unit (500) or the communication module (561) of the ECU (560). Also, the zone control unit (530) may include a second memory subsystem (534) for storing programs and temporarily storing data.

The ECU (560) may include a communication module (561) including a communication interface and a communication controller (not shown). Also, the ECU (560) may include a third MCU subsystem (562) that calculates a calculation result value for driving an actuator using actuator command data and generates an actuator driving signal. Also, the ECU (560) may include a third memory subsystem (564) for storing programs and temporarily storing data. Meanwhile, the first MCU subsystem (503), the second MCU subsystem (532), and the third MCU subsystem (562) can generate the same actuator driving signal for the same command data.

If it is identified that the target device in the input command data corresponds to the safety actuator (550) connected to the first network subsystem (505) of the central control unit (500), at least one computing unit within the first MCU subsystem (503) can generate a driving signal using the received command data or calculation result value for driving and transmit it to the safety actuator (550).

If it is identified that the target device in the input command data or calculation result value for driving corresponds to the safety actuator (550) connected to the second network subsystem (531) of the zone control unit (530), at least one computing unit within the second MCU subsystem (532) can generate a driving signal using the received command data or calculation result value for driving and transmit it to the safety actuator (550).

The ECU (560) uses the command data or calculation result value for driving received through the communication module (561). Through this, the seventh computing unit (563) of the third MCU subsystem (562) calculates the calculation result value for driving, generates a driving signal, and can transmit it to the safety actuator (550) connected to it.

The first and second network subsystems (505, 531) may include a communication interface, routing, switching, and a packet processing engine. And the packet processing engine may include a protocol conversion function between heterogeneous packets. Also, the first to third MCU subsystems (503, 532, 562), the first and second network subsystems (505, 531), and the communication module (561) can monitor the reception status of the command signal for the safety actuator (550), the transmission path of the command signal, and its reliability. And they can monitor the operation result of the safety actuator (550) corresponding to the command data in real-time through a sensor installed in the safety actuator (550).

If the operation result of the safety actuator (550) is different from the state pre-predicted from the command data (e.g., if the target state is outside the allowable range), the first to third MCU subsystems (503, 532, 562) or the first and second network subsystems (505, 531) exclude the existing signal transmission path. They can decide to transmit the driving signal for the safety actuator (550) through another path determined according to a predetermined rule based on arrival time, packet congestion, transmission speed, and bandwidth, which is the most reliable path.

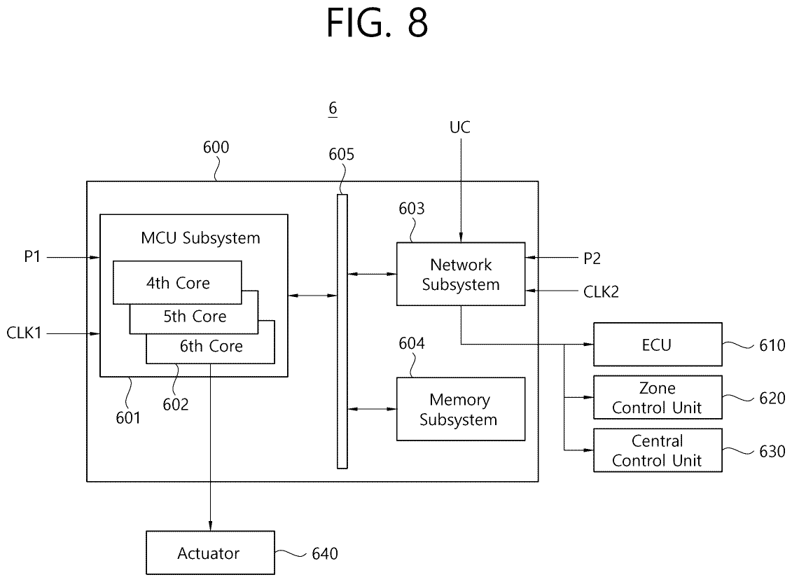

FIG. 8 is a block diagram of a system (6) for controlling in-vehicle devices according to a comparative embodiment of the present disclosure.

The system (6) for controlling in-vehicle devices shown in FIG. 8 may include zone control units (600, 620), a central control unit (630), and an ECU. The system (6) for controlling in-vehicle devices may further include an actuator (640).

The zone control units (600, 620) may include an MCU subsystem (601), a network subsystem (603), and a memory (604).

The network subsystem (603) interprets and analyzes sensor information, update information, user operation information, etc., input from an in-vehicle ECU (610), an adjacent zone control unit (620), and a central control unit (630). And it can identify the type and kind of information and decide whether to consume the input information itself or retransmit it to the outside.

The MCU subsystem (601) may include a plurality of cores (602). And at least one of the cores can be allocated for direct driving of the actuator (640).

The power, clock, and ground of each of the MCU subsystem (601) and the network subsystem (603) are independent of each other. Therefore, even if an error occurs in the MCU subsystem (601), the communication and switching functions of the network subsystem (603) are maintained. This can maintain the continuity of the data flow. However, if a problem occurs with the power and clock input to the MCU subsystem (601), the control of the actuator (640) that drives the in-vehicle devices can be interrupted, potentially causing a serious accident for the driver.

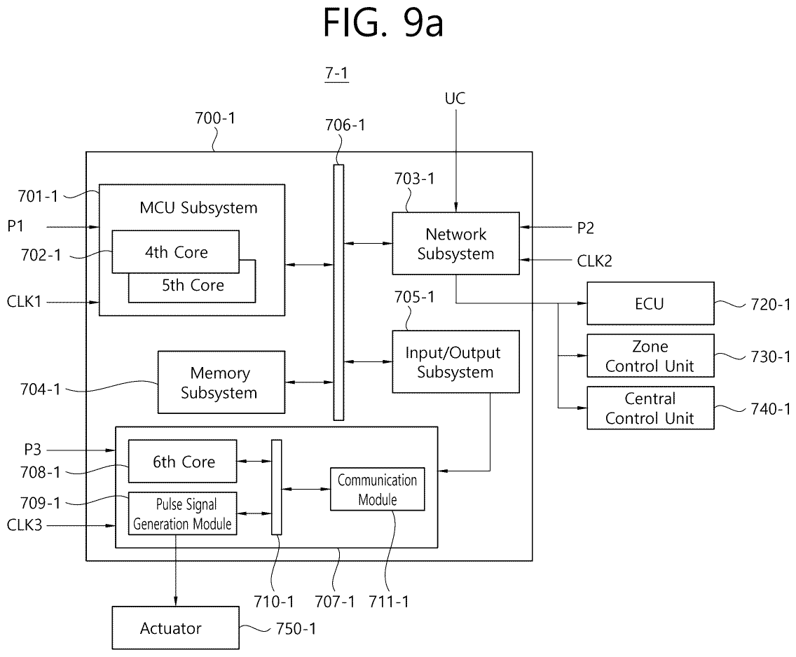

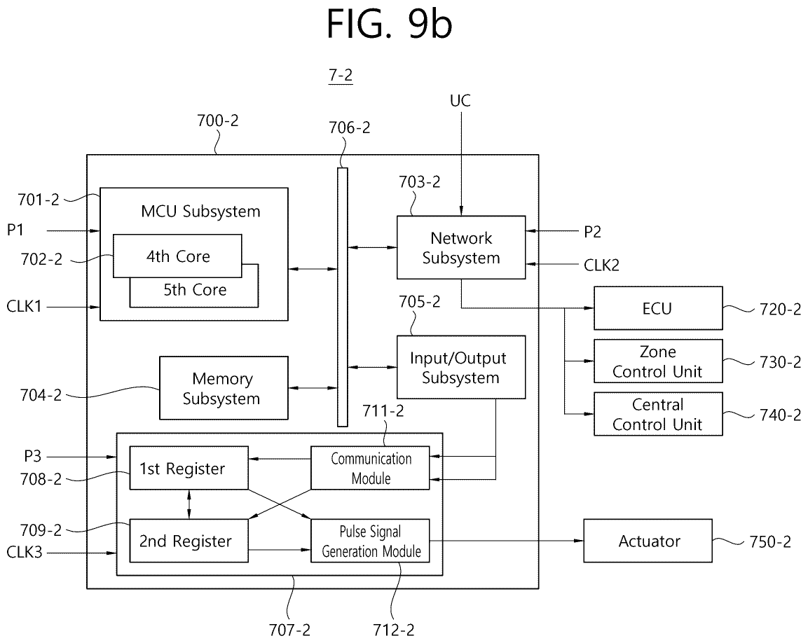

FIGS. 9a and 9b are block diagrams of a device (7-1, 7-2) for controlling in-vehicle devices according to an embodiment of the present disclosure.

The system (7-1) for controlling in-vehicle devices shown in FIG. 9a may include zone control units (700-1, 730-1), an MCU subsystem (701-1), a network subsystem (703-1), an input/output subsystem (705-1), and a driving control unit (707-1). That is, the driving control unit (707-1) can be configured as one of the input/output devices managed by the input/output subsystem (705-1). The power and clock of each of the MCU subsystem (701-1), the network subsystem (703-1), and the driving control unit (707-1) are configured independently of each other. Therefore, even if the fourth core (702-1) of the MCU subsystem (701-1) fails to operate, or the sixth core (708-1) of the driving control unit (707-1) fails to operate, the control of the actuator (750-1) can be seamlessly maintained through the complementary functions of the fourth core (702-1) and the sixth core (708-1). That is, if an error occurs in the fourth core (702-1), the sixth core (708-1) can calculate a calculation result value for driving using the command data and transmit it to the driving signal generation module (709-1).

The driving control unit (707-1) shown in FIG. 9a may largely include a sixth core (708-1), a driving signal generation module (709-1), and a communication module (711-1). The sixth core (708-1) interprets the actuator command data and calculates a calculation result value for driving an actuator, and it performs a write operation to a register (not shown) of the driving signal generation module (709-1). The driving signal generation module (709-1) can generate an actuator driving signal using the calculation result value for driving an actuator stored in the register.

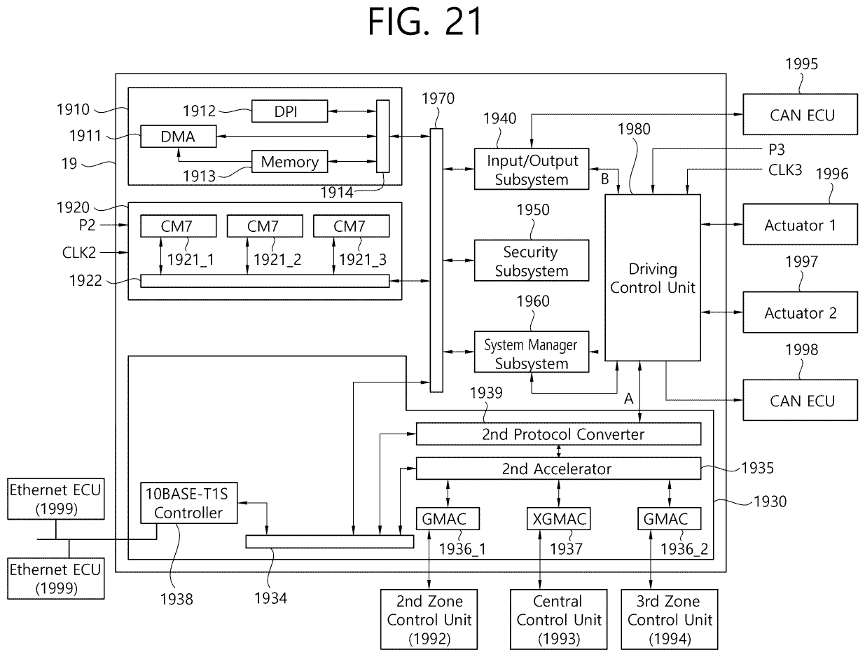

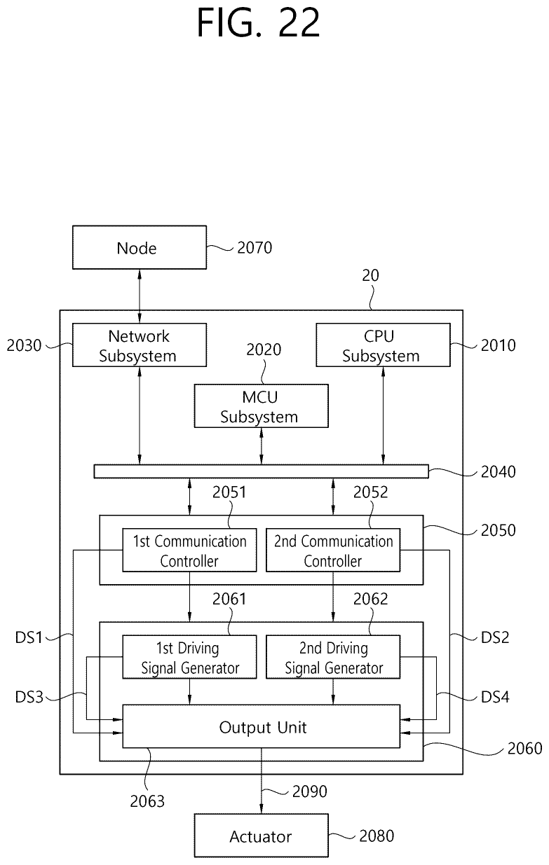

The input/output subsystem (705-1) connected to the driving control unit (707-1) may include a plurality of communication controllers and a GPIO multiplexer (see FIG. 21, FIG. 22). The plurality of communication controllers can convert a signal in the form of a packet or frame transmitted from the network subsystem (703-1) into a serial communication form and transmit it to the driving control unit (707-1). Also, the communication module (711-1) of the driving control unit (707-1) includes a communication interface and Ethernet, CAN, and LIN communication controllers. Through this, it can be connected to external communication devices including an ECU.

If the same third-party semiconductor design intellectual property (IP) or system architecture is used for the fourth core (702-1) and the sixth core (708-1) of FIG. 9a to implement the functional purpose of the present disclosure, it may lead to increased costs and a significant development period due to the use of high-cost semiconductor design IP, excessive specifications, and software complexity. Therefore, the sixth core (708-1) can be implemented with a lower-performance processor and system architecture compared to the fourth core (702-1).

The first register (708-2) within the driving control unit (707-2) shown in FIG. 9b can store the calculation result value for driving an actuator calculated by interpreting the actuator command data transmitted from the input/output subsystem (705-2) by the sixth core (708-1) of FIG. 9a. If an error occurs in the sixth core (708-1) of FIG. 9a or in writing to the first register (708-2), the driving control unit (707-2) detects it. And it can transmit this to the MCU subsystem (701-2) through the input/output subsystem (705-2) or the NoC bus system (706-2). Thereafter, at least one computing unit (702-2) of the MCU subsystem (701-2) fetches the actuator command data input from the network subsystem (703-2). And it can generate the control parameter value of the actuator driving signal, that is, the calculation result value for driving an actuator, and transmit it to the driving control unit (707-2) through the NoC bus system (706-2) and the input/output subsystem (705-2).

The second register (709-2) of the driving control unit (707-2) writes the calculation result value for driving an actuator transmitted by at least one computing unit (702-2) of the MCU subsystem (701-2) to a specific address. And the driving signal generation module (712-2) can generate an actuator driving signal with the value written at the specific address of the second register (709-2) and transmit it to the actuator (750-2).

The input/output subsystem (705-2) of FIG. 9b can perform signal conversion from Ethernet protocol, CAN protocol, or LIN protocol to serial communication protocol between the network subsystem (703-2) and the driving control unit (707-2). Alternatively, the network subsystem (703-2) parses the actuator command signal or the calculation result value for driving from the Ethernet, CAN, or LIN packet or frame and transmits it to the input/output subsystem (705-2). And the input/output subsystem (705-2) can convert the received actuator command signal or calculation result value for driving into serial communication and transmit it to the driving control unit (707-2).

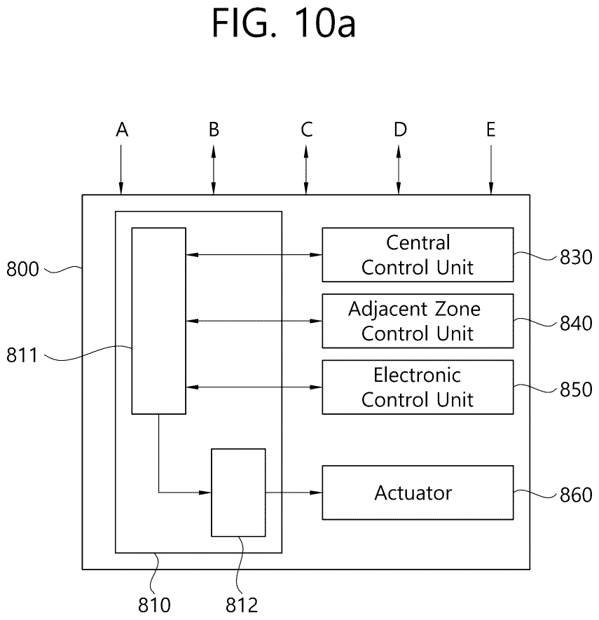

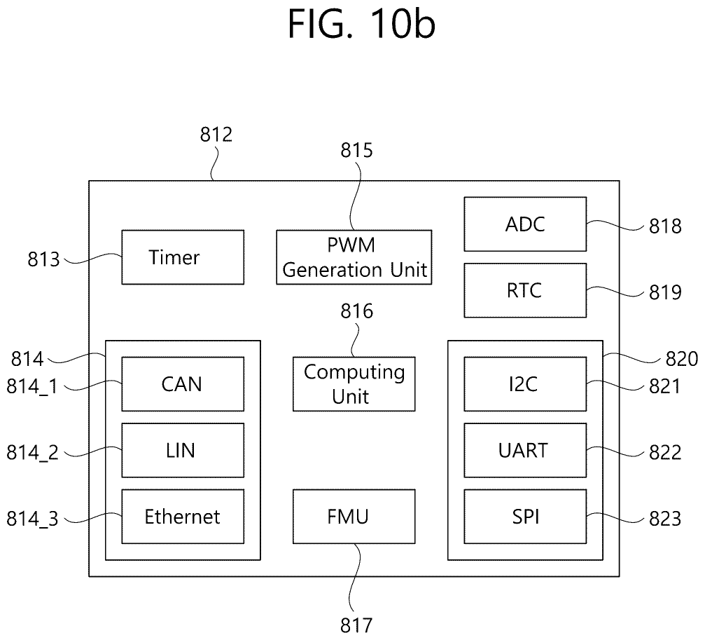

FIGS. 10a and 10b are schematic block diagrams of a vehicle control system (800) according to another embodiment of the present disclosure.

The vehicle control system (800) shown in FIGS. 10a and 10b may include a central control unit (830), a first zone control unit (810), an adjacent zone control unit (840), and an ECU (850). Each of the zone control units (810, 840) may include a network subsystem (811) and a driving signal processing unit (812).

The vehicle control system (800) can receive various command signals from an in-vehicle switch (A), an in-vehicle HMI (B), a remote device (C), a remote server (D), and a sensor (E). The node that receives the command signals can be at least one of the zone control units (810, 840), the central control unit (830), and the ECU (850) located in the vehicle.

The network subsystem (811) of the first zone control unit (810) of FIG. 10a can transmit command data or a calculation result value for driving to an adjacent zone control unit (see FIG. 1a), the central control unit (830), the ECU (850), and the driving signal processing unit (812) according to the location of the target device included in the received command signal. For example, if the central control unit (830) receives a command signal, the central control unit (830) converts it into a signal in the form of a packet or frame including command data according to the information of the target device to which the command signal is directed (e.g., the identification ID of the vehicle control apparatus and actuator to which the target device is connected, protocol type, etc.). And it can transmit the command data to all zone control units or domain control units (not shown) with a TSN-based communication protocol. Similarly, all zone control units also convert command data into command data in the form of a packet or frame according to the information of the target device to which the command signal is directed. And they can transmit it to the central control unit (830), adjacent zone control units (840), and ECUs (850) with Ethernet, CAN, or LIN communication protocols. In particular, if the target in-vehicle device included in the command signal is an actuator directly connected to itself, the network subsystem (811) can transmit the command data or the calculation result value for driving to the driving signal processing unit (812) in a serial communication form. That is, the network subsystem (811) can set the driving signal processing unit (812) as the same node as the central control unit (830), adjacent zone control units (840), and ECUs.

The vehicle control system (800) can be used for automotive applications of powertrain, chassis, and body control modules. And it can be used for many other purposes related to the application to body control modules in particular.

The driving signal processing unit (812) of the first zone control unit (810) of FIG. 10b can be programmed to control actuators for headlights, an air conditioning controller, side mirrors, seats, mood lamps, power windows, door locks, soft closing, trunk door locks, a power trunk, taillights, wipers, a rear curtain, washers, wireless charging, telescopic steering, a sunroof, steering, and the like. Also, the driving signal processing unit (812) may include a PWM generation unit (815) that directly drives door locks and windows by connecting to an external H-Bridge (not shown). Also, the ADC (Analog to Digital Converter, 818) of the driving signal processing unit (812) can receive a plurality of sensor input signals through a multiplexer (not shown). Also, the input/output interface (820) of the driving signal processing unit (812) may include serial communication ports such as I2C (Inter-Integrated Circuit), UART (Universal asynchronous receiver/transmitter), and SPI (Serial Peripheral Interface) for communication with internal and external peripheral devices. Also, the driving signal processing unit (812) may include a computing unit (816). And the computing unit (816) can interpret the command data and transmit control parameters, which are calculation result values for driving (e.g., prescale value, counter value, compare value related to timer setting, and clock division value, clock count, output pattern, etc. related to pulse signal setting), to the timer (813) and the PWM generation unit (815).

In FIGS. 10a and 10b, the network subsystem (811) and the driving signal processing unit (812) are connected using one of the input/output interfaces (820). And they can communicate using SPI, UART, and I2C protocols. On the other hand, the command data or the calculation result value for driving transmitted between the network subsystem (811) and the central control unit (830), adjacent zone control units (840), and ECUs (850) can be packetized or framed with one of Ethernet, CAN, or LIN communication protocols and transmitted. In this way, the network subsystem (811) performs the functions of communication interface, routing, switching, and protocol conversion. And the driving signal processing unit (812) generates a driving signal using the received command data or calculation result value for driving. And the vehicle control system and vehicle control apparatus of the present invention can include various embodiments that ensure the transmission of command data to a target device with improved functional safety. That is, the network subsystem (811) can achieve time synchronization, low latency, and seamless data delivery between nodes for the entire vehicle network through high-speed TSN-based Ethernet communication and compliance with the 802.1CB standard. And the driving signal processing unit (812) may include a driving signal control unit (not shown) that enables direct control of the driving signal generation module of the upper-level system. Therefore, the vehicle control system of the present disclosure can perform the mission of accurately controlling in-vehicle devices without interruption through various embodiments such as register mirroring and signal tunneling methods.

The network subsystem (811) includes a plurality of communication interfaces. And a first communication interface among the plurality of communication interfaces is connected to an ECU (850). And a second communication interface among the plurality of communication interfaces is connected to a first communication port of the driving signal processing unit (812), wherein the communication protocols output from the first communication interface and the second communication interface may be different.

The driving signal processing unit (812) includes a communication controller. And if a communication error occurs between the first communication interface of the network subsystem (811) and the ECU (850), the driving signal processing unit (812) can mirror the packet transmitted by the network subsystem (811) through the communication controller and transmit it to the ECU (850).

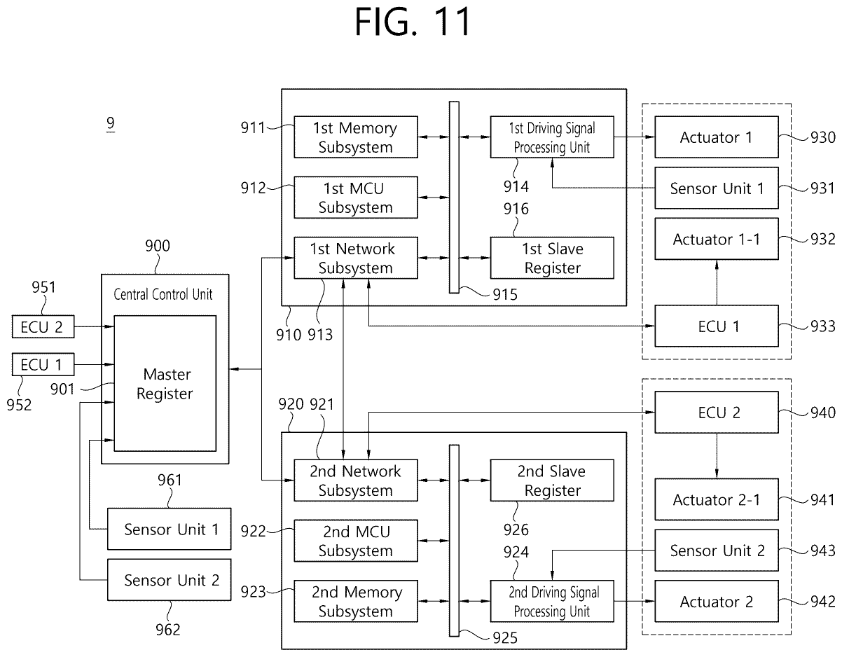

FIG. 11 is an internal block diagram of a vehicle control system (9) constituting a vehicle network according to another embodiment of the present disclosure.

The central control unit (900) of the vehicle control system (9) shown in FIG. 11 can generate and control various driving signals in conjunction with the values stored in the registers (901, 916, 926). Through this, the central control unit (900) can perform real-time control and integrated control of the first zone control unit (910), the second zone control unit (920), and the vehicle's driving, steering, brake, and body devices.

The vehicle control system (9) shown in FIG. 11 may largely include a central control unit (900), at least two zone control units (910, 920), and a plurality of ECUs (933, 940). The vehicle control system (9) may further include a plurality of actuators (930, 932, 941, 942) and a plurality of sensors (931, 943). Here, the central control unit (900) can control in-vehicle devices by communicating with zone control units (910, 920), an Advanced Driver Assistance System (ADAS), and domain controllers for chassis, powertrain, and body.

The master register (901) within the central control unit (900) can receive and store various sensor data of the vehicle (e.g., brake pedal position, speed, steering angle, etc.) from sensor units (961, 962) and command data from ECUs (951, 952). And the master register (901) can also store a calculation result value for driving calculated by a computing unit (not shown).

The master register (901) can mirror the stored sensor data, command data, and calculation result value for driving to the slave registers (916, 926). And the slave registers (916, 926) can store the mirrored sensor data, command data, and calculation result value for driving.

The driving signal processing units (914, 924) can generate a driving signal using at least one of the sensor data, command data, and calculation result value for driving stored in the slave registers (916, 926).

At least one of the pluralities of computing units (not shown) within the central control unit (900) receives sensor data and command data (including actuator command data, driving, steering, brake command data). And it calculates a calculation result value for driving (including control parameter values for timers and controllers such as prescale value, counter value, compare value, etc.) and stores it at a specific address of the master register (901) for a certain period. If an error occurs in the computing unit (not shown) of the first driving signal processing unit (914) or the second driving signal processing unit (924), the central control unit (900) can mirror the latest actuator driving calculation result value stored in the master register (901) to the first slave register (916) or the second slave register (926) connected to the driving signal processing unit where the error is detected.

The computing unit (not shown) within the central control unit (900), the MCU subsystems (912, 922), network subsystems (913, 921), and driving signal processing units (914, 924) within the first and second zone control units (910, 920) can refer to the data stored in the master register (901) and slave registers (916, 926) in real-time. In particular, the driving signal processing units (914, 924) can generate and control a driving signal using at least one of the sensor data, command data, and calculation result value for driving stored in the master register (901) or slave registers (916, 926).

The driving signal processing units (914, 924) receive the state of the in-vehicle devices controlled by the actuators (930, 942), transmit it to the master register (901) for updating. And in the subsequent control cycle, the MCU subsystems (912, 922), network subsystems (913, 921), and driving signal processing units (914, 924) can process signals by referring to the updated data in the master register (901).

Also, the central control unit (900) or zone control units (910, 920) include a monitoring device (not shown) and a safety register (not shown). If the value written to a specific address of the master register (901) or slave registers (916, 926) used to generate the driving signal exceeds a predetermined specific threshold, the monitoring device activates a safety control signal and transmits it to a computing unit (not shown) within the central control unit (900). After the generation of the safety control signal, the computing unit deactivates the current calculation result value for driving and can transmit a safety calculation result value pre-stored in the safety register to the slave registers (916, 926) or the driving signal processing units (914, 924).

That is, the master register (901) of the central control unit (900) stores sensor data and command data generated in the vehicle in real-time. And upon the occurrence of a specific event, it calculates a calculation result value for driving using the sensor data and command data stored in real-time. And it can directly control the in-vehicle actuators (930, 942) by transmitting the calculated calculation result value for driving to the slave registers (916, 926) of the zone control units (910, 920).

Also, if an error occurs in the computing unit (not shown) inside the ECUs (951, 952) directly connected to the central control unit (900) or in the computing unit (not shown) inside the ECUs (933, 940) connected to the zone control units (910, 920), the central control unit (900) can transmit the calculation result value for driving stored in the master register (901) to a slave register (not shown) within the ECUs (951, 952, 933, 940).

Each of the zone control units (910, 920) may include a memory subsystem (911, 923), an MCU subsystem (912, 922), a network subsystem (913, 921), a driving signal processing unit (914, 924), a slave register (916, 926), and a NoC bus system (915, 925). Each of the first and second network subsystems (913, 921) of the zone control units (910, 920) can be connected to the central control unit (900) via TSN-based high-speed Ethernet communication. The first network subsystem (913) and the second network subsystem (921) can be connected to each other via low-speed Ethernet communication. Also, the first and second network subsystems (913, 921) and the plurality of ECUs (933, 940) can be connected to each other by one of low-speed Ethernet communication or CAN/LIN communication.

The first zone control unit (910) can be connected to a plurality of first actuators (930), a first sensor unit (931), and a first ECU (933) located in the first zone of the vehicle. The first zone control unit (910) identifies a signal transmitted from the central control unit (900) or the second zone control unit (920). If the target device of the received signal is directly connected to the first zone control unit (910), it activates the first driving signal processing unit (914) (e.g., supplying power and clock, etc.).

Thereafter, the first network subsystem (913) transmits the received signal to the first slave register (916) or the first driving signal processing unit (914). The first driving signal processing unit (914) generates a driving signal using the received command data or the value stored at a specific address of the slave register. And it can transmit it to the actuator (930) connected to it.

The first network subsystem (913) analyzes the input signal and can transmit the input signal to the first driving signal processing unit (914), the central control unit (900), the second network subsystem (921), or an ECU (933) located in the corresponding zone.

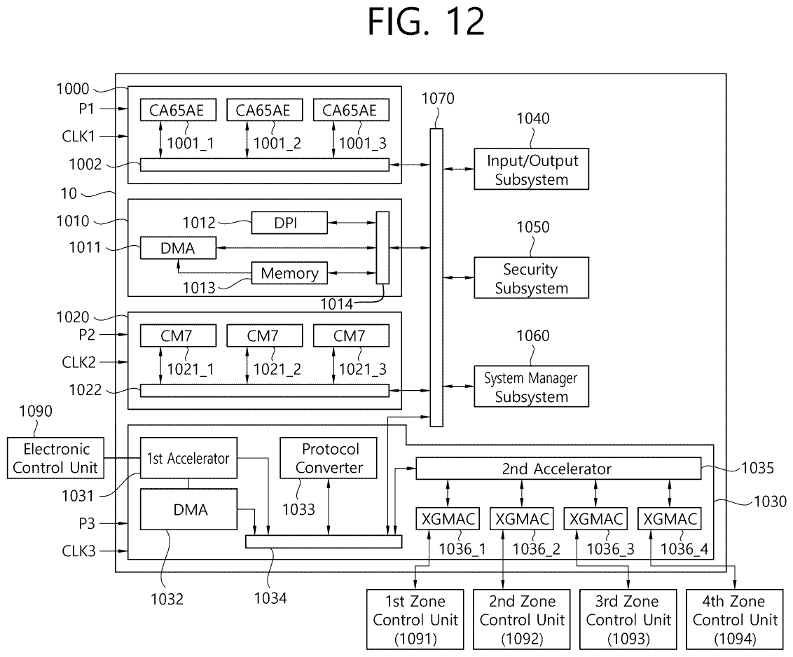

FIG. 12 is a block diagram showing a detailed internal configuration of a central control unit (10) according to an embodiment of the present disclosure.

As shown in FIG. 12, the central control unit (10) according to an embodiment of the present disclosure may largely include a CPU subsystem (1000), a memory subsystem (1010), an MCU subsystem (1020), a network subsystem (1030), an input/output subsystem (1040), and a main NoC bus system (1070).

The central control unit (10) is connected to at least two zone control units (1091, 1092, 1093, 1094) via a TSN-based backbone network. And it can also be connected to a plurality of domain controllers (not shown) and auxiliary driving devices (not shown).

The CPU subsystem (1000) may include three high-performance cores (1001_1, 1001_2, 1001_3) (e.g., Arm's Cortex-A65AE) that are physically isolated in a hypervisorless structure. The hypervisorless structure is a multi-core architecture comprising physically isolated processor cores, each configured to directly execute a distinct and unmodified application stack without an intervening virtualization layer. And each of the three high-performance cores can independently manage the multi-domains (chassis, body, powertrain domain) of the vehicle and can operate as an application processor. Also, the CPU subsystem (1000) includes an interrupt controller and a clock generation and monitoring unit. Through this, it can manage interrupts from peripheral devices within the system, and generate and monitor the clocks required for all modules in the system.

The MCU subsystem (1020) may include a plurality of cores (1021_1, 1021_2, 1021_3). And a master register (not shown) stores and manages various device control command data generated by the MCU subsystem (1020). And through event-based register mirroring, it can control specific functions and check system errors to handle interrupts. Also, one of the plurality of cores (1021_1, 1021_2, 1021_3) processes real-time data. And another core is responsible for monitoring the system status or detecting errors and manages the overall control flow of the system. And when an error occurs, it can record the error and, if necessary, execute a corresponding command.

The memory subsystem (1010) can manage data transmission between computing units and peripheral devices in conjunction with the main NoC bus system (1070) and can be responsible for memory access. Here, the memory (1013) may include an external Double Data Rate (DDR) memory and an external Serial-NOR flash memory.

The NoC bus system (1070) is a switched fabric where any master device can be connected to any slave device and multiple master devices can be connected to multiple slave devices simultaneously.

Also, the DMA controller (1011) supports efficient data transmission between the memory (1013) and peripheral devices. And the Deep Packet Inspection (DPI) engine (1012) can identify malicious attacks from the outside by deeply analyzing data packets transmitted through the vehicle network.

The security subsystem (1050) may include a security processor with dedicated memory, encryption, a random number generator, and other peripherals. Once secure boot is complete, devices outside the security subsystem (1050), including the security processor, cannot directly access or control most of the hardware blocks inside the security subsystem (1050). The security subsystem (1050) can communicate with other computing units via a mailbox.

The network subsystem (1030) receives a package containing data, converts it to a specific format. And it can perform a process of creating a new package composed by adding additional information or copying existing information.

The network subsystem (1030) may include a first accelerator (1031), a second accelerator (1035), a protocol converter (1033), and a NoC sub-bus system (1034).

The first accelerator (1031) can perform legacy communication conversion between ECUs (1090) based on hardware, that is, CAN-to-CAN conversion, CAN-to-LIN conversion, and LIN-to-LIN conversion. And it can have a plurality of CAN/CAN-FD/LIN controllers, a Legacy Packet Processing Engine (LPP engine), and a dedicated DMA controller.

The second accelerator (1035) can perform routing functions between Ethernet ports based on hardware. And it has a multi-gigabit Ethernet communication interface (e.g., USXGMII, SGMII, RGMII), a plurality of gigabit media access controllers (XGMAC, 1036_1 to 1036_4), and an Ethernet Packet Processing Engine (EPP engine). Also, the second accelerator (1035) complies with the IEEE TSN/AVB standard and the IEEE 1599-time stamp standard, and can perform MAC security and IPsec security for incoming packets. The EPP engine acts as a multi-port IEEE 802.3 gigabit Ethernet switch/router. And it controls the data flow through hardware packet classification, scheduling, and shaping. It can also interpret Ethernet packets received at an Ethernet port based on software or hardware and switch them to the Ethernet port where the target node is located.

The EPP engine performs internal packet scheduling tasks when there is congestion or a certain schedule is needed for the internal traffic of the central control unit (10). And if communication is difficult due to a lack of internal buffer, it can decide to drop the incoming packet.

The EPP engine may include a hardware-based classifier. And the hardware-based classifier can quickly dismantle the internal structure of a packet when it comes in and compares it with predefined rules for the header and payload. Specifically, it can determine the type and destination of the input packet through specific conditions (e.g., if statements, gate operations, parallel operations). That is, the EPP engine uses a lookup table to check for items that match the attributes of the packet. And it can quickly decide on a forwarding or drop action.

The EPP engine can use a MAC HASH table as a lookup table for L2 switching. And it can use the MAC address (corresponding to an in-vehicle device) and VLAN ID (an ID that groups MAC addresses) to determine the port forwarding of the packet.

The MAC HASH table is divided into a general area and a collision area. And the collision area can be a space to prepare for an overflow of the general area. For example, a collision may occur when address A and address B come in. And to prevent such a collision, the collision space can be used. That is, if address A is matched to packet 1, it can have a structure where a pointer is written in packet 1 saying, “if it doesn't match, refer to the collision space.”

However, it can be difficult to find which entry in the table the MAC address corresponds to and what content is there one by one using a HASH algorithm when a MAC address comes in. Therefore, the EPP engine generates a hash value using a specific algorithm with the MAC address and VALAN ID. And it uses the corresponding hash value as an address and can find the entry based on the address.

The looked-up contents are stored in a 188-bit memory. And the 188-bit memory content may include table size adjustment, access information, and action entries.

The content of the action entry field may include whether to discard the input packet, which Ethernet port to forward it to, which scheduler to put the corresponding traffic in, which traffic control side to pass it to, or if it is a new packet, PUNTing (sending up) it to the CPU side, and for packets that need to be processed by overlapping, searching multiple tables to override, as the action content.

The lookup table may include a plurality of tables including a MAC table, a routing table, and an ACL table. And the operation matching can be determined by the priority among the plurality of tables, and forwarding or routing can be determined.

The first priority is the Access Control List (ACL) table, and if the input packet matches the content stored in the ACL, the determined action of the ACL table can be performed. The second priority is to determine whether the input packet has been processed with IPsec, and if it has been processed with IPsec, the action of decryption can be performed. The third priority is to process the data transmitted from the Host CPU. After that, the EPP engine can perform processing such as streaming, blocking DDoS attacks, and PUNTing to the host CPU when a wrong packet or an unknown packet comes in.

Finally, the EPP engine can find matching ones based on rules set in hardware through the MAC hash table and determine the forwarding action.

Also, the MAC hash table may also include a field that determines whether to operate a specific MAC address statically or dynamically.

The protocol converter (1033) can be responsible for conversion and forwarding between heterogeneous packet formats. And it can be implemented and executed as a processor that operates based on software. That is, the protocol converter (1033) can perform at least one of Ethernet-to-CAN protocol conversion and Ethernet-to-LIN protocol conversion.

The CAN message converted into an Ethernet packet through the protocol converter (1033) can be delivered to the Ethernet port containing the destination node of the CAN message through the EPP engine. Also, the Ethernet packet delivered through the EPP engine can be converted into a CAN message through the protocol converter (1033) and transmitted to the CAN port where the target node is located by the LPP engine.

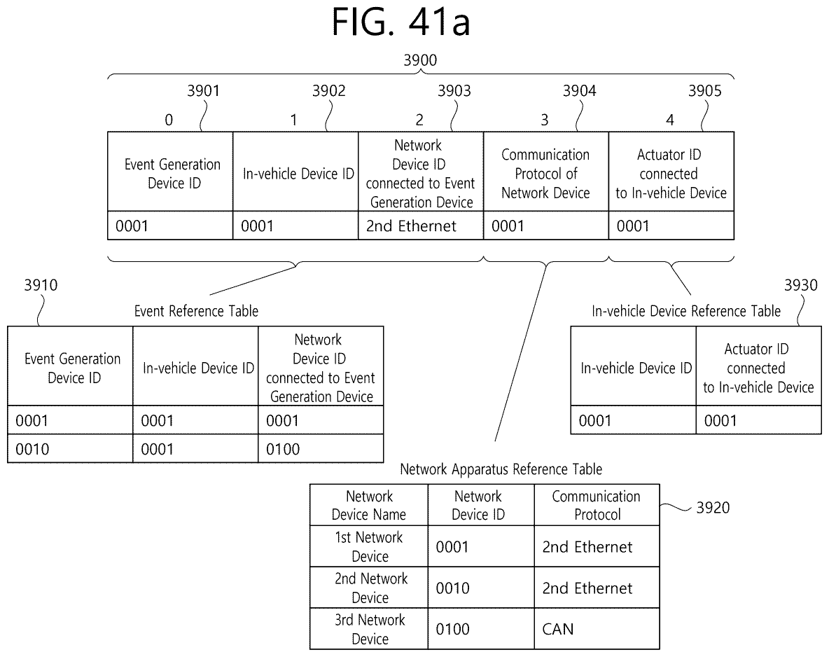

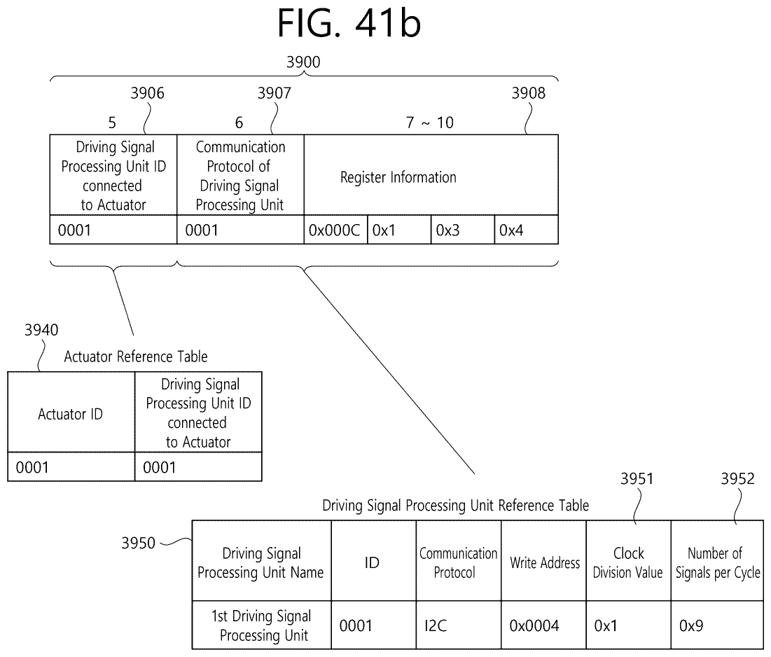

The network subsystem (1030) can automatically route for a specific type of frame (see FIGS. 41a and 41b).

The network subsystem (1030) further includes a parsing unit (not shown). And the parsing unit can extract data in a specific field from a specific type of frame (see FIGS. 41a and 41b).

The package includes a protocol-dependent address and a payload. And the format of the address and the method of using the address depend on the communication protocol. For example, Ethernet uses a 48-bit Media Access Control (MAC) address to identify the destination node used for unicast or multicast packets. And CAN uses an 11-bit or 29-bit message identifier to identify the message content used for multicast. FlexRay uses temporal relationships to identify the message content used to multicast messages.

The input/output subsystem (1040) includes an external device controller. And it can provide a connection between the network subsystem (1030) and an external device. Here, external device controllers may include eMMC, USB 2.0 devices, Ethernet MACs, and the like. The input/output subsystem (1040) may include SPI (Serial Peripheral Interface), I2C, PDM (Pulse Density Modulation), UART, CAN communication controllers, and an ADC.

In FIG. 12, the central control unit (10) may include a port that can receive an actuator driving signal transmitted from a zone control unit (1091, 1092, 1093, 1094) or an ECU (1090). And if the actuator driving signal received at the port includes a predetermined signal pattern corresponding to an actuator connected to it, it can have a path to bypass the actuator driving signal and transmit it to the actuator connected to it.

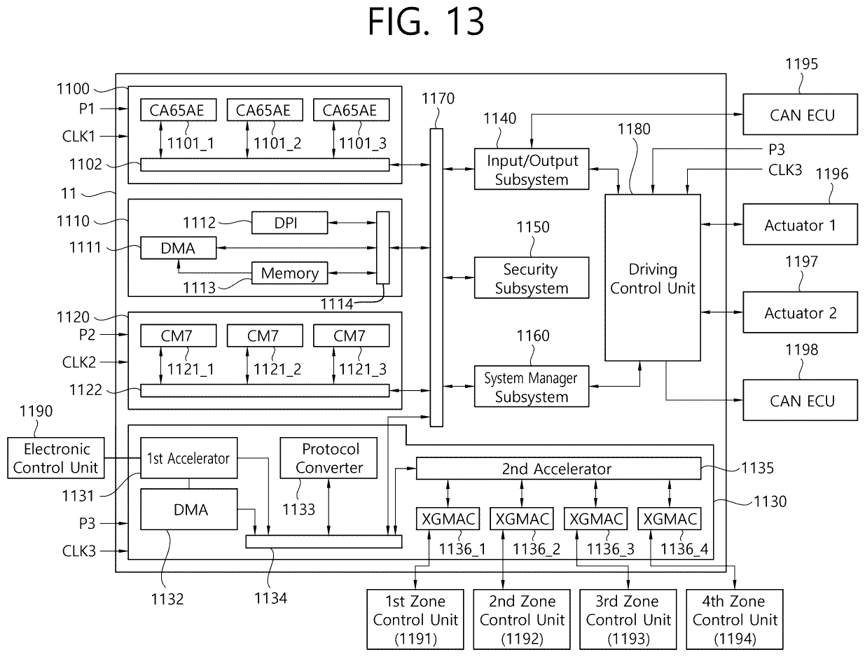

FIG. 13 is a block diagram showing a detailed internal configuration of a central control unit (11) according to another embodiment of the present disclosure.

FIG. 13 further includes a driving control unit (1180) in the central control unit (10) shown in FIG. 12. Through this, it can directly drive a plurality of actuators (1196, 1197) (e.g., window actuators, mirror actuators, etc.).

The driving control unit (1180) is composed of an islanded block with a chip-in-chip concept. And it can be connected to other components via a Serial Peripheral Interface (SPI).

The driving control unit (1180) processes the actuator command data received through at least one communication controller of the input/output subsystem (1140). And it can generate an actuator driving signal corresponding to the command data and transmit it to the actuators (1196, 1197). Here, the actuator command data may include a target device, a target operation, a target state, and the like. And an embodiment of the driving signal may include a PWM signal. Here, the at least one communication controller may include one of SPI, I2C, and UART communication. The driving control unit (1180) interprets and calculates the received actuator command data to generate a PWM signal corresponding to the target output. And it can transmit it to the corresponding actuator.

The network subsystem (1130) identifies the message identifier or address for communication packets received through the ECUs (1190, 1195) and the first to fourth zone control units (1191 to 1194). If the target device of the corresponding packet is the first actuator (1196) or the second actuator (1197) connected to the driving control unit (1180), it extracts the data (e.g., actuator command data) in the payload of the corresponding packet. And it transmits it to the input/output subsystem (1140), and a communication controller inside the input/output subsystem (1140) can convert the data into a serial communication protocol and transmit it to the driving control unit (1180).

The driving control unit (1180) identifies the target actuator to be controlled from the actuator command data transmitted from the communication controller of the input/output subsystem (1140). And it can generate a PWM signal corresponding to the target output for the target state and transmit it to the target actuator. Here, the communication packet has a device ID data field. And the first accelerator (1131) and the second accelerator (1135) extract the device ID and data and transmit them to the main NoC bus system (1170). The main NoC bus system (1170) (or the MUC subsystem (1120)) can transmit the command data to the input/output subsystem (1140) if the device ID is identified as an actuator directly connected to it. For example, if a signal to lower the passenger side window is input through a switch connected to the CAN ECU (1190), the CAN ECU (1190) can generate a packet including its CAN ID (i.e., the target device ID) and the lowering command signal and transmit it to the central control unit (11).

The first accelerator (1131) of the central control unit (11) interprets the received packet and identifies the device ID. And it can search a pre-stored table of device ID-actuator connection information to identify the target actuator.

The first accelerator (1131) identifies that the target actuator is an actuator connected to it. And it parses the command data from the packet and transmits it to the main NoC bus system (1170). And the main NoC bus system (1170) can transmit the command data to the input/output subsystem (1140). The input/output subsystem (1140) can select at least one of at least one communication controller and convert the command data into a serial communication protocol and transmit it to the driving control unit (1180).

If a CAN ECU (1198) that receives command data for a safety actuator (1196) important for passenger safety is directly connected to the driving control unit (1180) in the central control unit (11) of FIG. 13, the driving control unit (1180) receives the command data for the safety actuator transmitted by the CAN ECU (1198) through a CAN controller (not shown) within the driving control unit (1180). And a computing unit (not shown) and a driving signal generator (not shown) within the driving control unit (1180) can generate a driving signal for the safety actuator. Through such a flexible internal configuration, for signals related to actuators that require urgent command delivery, the driving control unit (1180) can interpret the command on its own and control the actuator without using the internal resources of the central control unit (11), that is, the MCU subsystem (1120) and the network subsystem (1130). Therefore, the processing delay of emergency messages can be reduced when multiple messages are input to the central control unit (11) simultaneously.

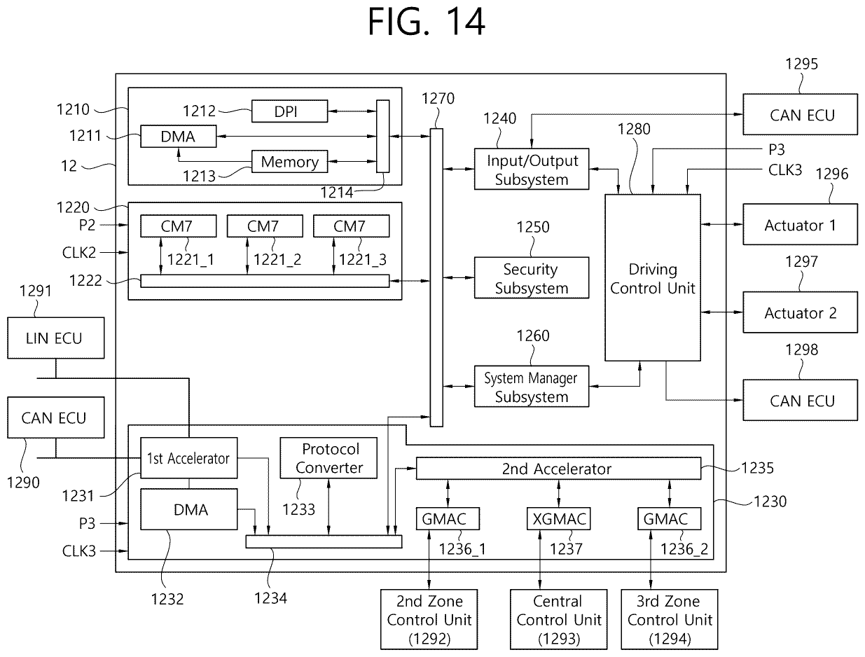

FIG. 14 is a block diagram showing a detailed internal configuration of a first zone control unit (12) according to another embodiment of the present disclosure.

As shown in FIG. 14, the first zone control unit (12) may largely include a memory subsystem (1210), an MCU subsystem (1220), a network subsystem (1230), an input/output subsystem (1240), a driving control unit (1280), and a main NoC bus system (1270). The first zone control unit (12) can be connected to a plurality of ECUs (1290, 1291, 1295, 1298) and a plurality of actuators (1296, 1297) assigned to the first zone, second and third zone control units (1292, 1294) located in adjacent zones, and a central control unit (1293) (CCU: Central Control Unit).

The MCU subsystem (1220) may include three core wrappers in dual-core lockstep. And it can control specific functions through event-based register mirroring.

The memory subsystem (1210) can manage data transmission between computing units and peripheral devices in conjunction with the main NoC bus system (1270), and can be responsible for memory access. Here, the memory (1213) may include an external Double Data Rate (DDR) memory and/or an external Serial-NOR flash memory. Also, the DMA controller (1211) supports efficient data transmission between the memory (1213) and peripheral devices. And the Deep Packet Inspection (DPI) engine (1212) can identify malicious attacks from the outside by deeply analyzing data packets transmitted through the network.

The security subsystem (1250) may include a security processor with dedicated memory, encryption, a random number generator, and other peripherals. Once secure boot is complete, devices outside the security subsystem, including the security processor, cannot directly access or control most of the hardware blocks inside the security subsystem. The security subsystem (1250) can communicate with other processors via a mailbox.

The network subsystem (1230) may include a first accelerator (1231), a second accelerator (1235), and a protocol converter (1233).

The first accelerator (1231) performs legacy communication conversion between CAN or LIN-based ECUs (1290, 1291) based on hardware, that is, CAN-to-CAN conversion and CAN-to-LIN conversion. And it may include a plurality of CAN/CAN-FD/LIN controllers, a Legacy Packet Processing Engine (LPP engine), and a dedicated DMA controller.

The second accelerator (1235) performs routing functions between Ethernet ports based on hardware. And it may include a multi-gigabit Ethernet communication interface (e.g., USXGMII, SGMII, RGMII), a plurality of gigabit media access controllers (1236_1, 1236_2), and an Ethernet Packet Processing Engine (EPP engine). Also, the second accelerator (1235) complies with the IEEE TSN/AVB standard and the IEEE 1599-time stamp standard, and can perform MAC security and IPsec security for incoming packets. The EPP engine acts as a multi-port IEEE 802.3 gigabit Ethernet switch/router. And it controls the data flow through hardware packet classification, scheduling, and shaping. It can also interpret Ethernet packets received at an Ethernet port based on hardware and switch them to the Ethernet port where the target node is located.

The EPP engine performs internal packet scheduling tasks when there is congestion or a certain schedule is needed for the internal traffic of the central control unit (10). And if communication is difficult due to a lack of internal buffer, it can decide to drop the incoming packet.

The EPP engine may include a hardware-based classifier. The hardware-based classifier can quickly dismantle the internal structure of a packet when it comes in and compares it with predefined rules for the header and payload. Specifically, it can determine the type and destination of the input packet through specific conditions (e.g., if statements, gate operations, parallel operations). That is, the EPP engine uses a lookup table to check for items that match the attributes of the packet. And it can quickly decide on a forwarding or drop action.

The EPP engine can use a MAC HASH table as a lookup table for L2 switching. And it can use the MAC address (corresponding to an in-vehicle device) and VLAN ID (an ID that groups MAC addresses) to determine the port forwarding of the packet.

The MAC HASH table is divided into a general area and a collision area. And the collision area can be a space to prepare for an overflow of the general area. For example, a collision may occur when address A and address B come in. And to prevent such a collision, the collision space can be used. That is, if address A is matched to packet 1, it can have a structure where a pointer is written in packet 1 saying, “if it doesn't match, refer to the collision space.”

However, it can be difficult to find which entry in the table the MAC address corresponds to and what content is there one by one using a HASH algorithm when a MAC address comes in. Therefore, the EPP engine generates a hash value using a specific algorithm with the MAC address and VLAN ID. And it uses the corresponding hash value as an address and can find the entry based on the address.

The looked-up contents are stored in a 188-bit memory. And the 188-bit memory content may include table size adjustment, access information, and action entries.

The content of the action entry field may include whether to discard the input packet, which Ethernet port to forward it to, which scheduler to put the corresponding traffic in, which traffic control side to pass it to, or if it is a new packet, PUNTing (sending up) it to the CPU side, and for packets that need to be processed by overlapping, searching multiple tables to override, as the action content.

The lookup table may include a plurality of tables including a MAC table, a routing table, and an ACL table. And the operation matching can be determined by the priority among the plurality of tables, and forwarding or routing can be determined.

The first priority is the Access Control List (ACL) table, and if the input packet matches the content stored in the ACL, the determined action of the ACL table can be performed. The second priority is to determine whether the input packet has been processed with IPsec, and if it has been processed with IPsec, the action of decryption can be performed. The third priority is to process the data transmitted from the Host CPU. After that, the EPP engine can perform processing such as streaming, blocking DDoS attacks, and PUNTing to the host CPU when a wrong packet or an unknown packet comes in.

Finally, the EPP engine can find matching ones based on rules set in hardware through the MAC hash table and determine the forwarding action.

Also, the MAC hash table may also include a field that determines whether to operate a specific MAC address statically or dynamically.

The protocol converter (1233) may include a computing unit (not shown). And it is responsible for conversion and forwarding between heterogeneous packet formats. For example, the protocol converter (1233) can perform protocol conversion between Ethernet and CAN, and Ethernet and LIN. The CAN message converted into an Ethernet packet through the protocol converter (1233) can be delivered to the Ethernet port containing the target node of the CAN message through the EPP engine. Also, the Ethernet packet delivered through the EPP engine can be converted into a CAN message through the protocol converter (1233) and transmitted to the CAN port where the target node is located by the LPP engine.

The input/output subsystem (1240) includes an external device controller. And it can provide a connection between the main NoC bus system (1270) and an external device. Here, external device controllers may include eMMC, USB 2.0 devices, Ethernet MACs, and the like. The input/output subsystem (1240) may further include SPI, I2C, PDM, UART, CAN communication controllers, and an ADC.

The first zone control unit (12) can be directly connected to a plurality of actuators (1296, 1297) (e.g., window actuators, mirror actuators, etc.).

The driving control unit (1280) processes the actuator command data received through at least one of at least one communication controller of the input/output subsystem (1240). And it can generate an actuator driving signal corresponding to the command data and transmit it to the target actuator. Here, the actuator command data may include a target device, a target operation, a target state, and the like. And an embodiment of the driving signal may include a PWM signal. Here, the at least one communication controller may include one of SPI, I2C, and UART communication. The driving control unit (1280) interprets and calculates the received actuator command data to generate a PWM signal corresponding to the target output. And it can transmit it to the corresponding actuator.

In FIG. 13, the first zone control unit (12) may include a port that can receive an actuator driving signal transmitted from a zone control unit (1292, 1294) or a central control unit (1293) or an ECU (1290, 1291). And if the actuator driving signal received at the port includes a predetermined signal pattern corresponding to an actuator connected to it, it can have a path to bypass the actuator driving signal and transmit it to the actuator (1296, 1297) connected to it.

The network subsystem (1230) of FIG. 14 identifies the message identifier or address for packets or frames received through the CAN ECU (1290), LIN ECU (1291), second zone control unit (1292), third zone control unit (1294), and central control unit (1293). If the target device of the corresponding packet is the first actuator (1296) or the second actuator (1298) connected to the driving control unit (1280), it extracts the data (e.g., actuator command data) in the payload of the corresponding packet. And it transmits it to the input/output subsystem (1240), and a communication controller inside the input/output subsystem (1240) can convert the command data into a serial communication protocol and transmit it to the driving control unit (1280).

The driving control unit (1280) identifies the target actuator to be controlled from the actuator command data transmitted from the communication controller of the input/output subsystem (1240). And it can generate a PWM signal corresponding to the target output for the target state and transmit it to the target actuator. Here, the communication packet has a device ID and a data field. And the first accelerator (1231) and the second accelerator (1235) extract the device ID and data and transmit them to the main NoC bus system. And the main NoC bus system (1270) (or the MUC subsystem (1220)) can transmit the command data to the input/output subsystem (1240) if the device ID is identified as an actuator directly connected to it. For example, if the first zone control unit (12) is located at the passenger seat, and a signal to lower the passenger side window is input through a switch connected to the CAN ECU (1290), the CAN ECU (1290) can generate a packet including its CAN ID (i.e., the target device ID) and the lowering command signal and transmit it to the first zone control unit (12). The first accelerator (1231) of the first zone control unit (12) interprets the received packet and identifies the CAN ID. And it can search a pre-stored table of CAN ID-actuator connection information to identify the target actuator.

The first accelerator (1231) identifies that the target actuator is an actuator connected to it. And it parses the command data from the packet and transmits it to the main NoC bus system (1270). And the main NoC bus system (1270) can transmit the command data to the input/output subsystem (1240). The input/output subsystem (1240) can convert the command data into a serial communication protocol through at least one communication controller and transmit it to the driving control unit (1280).

In another embodiment, if it is determined that the command signal controlling the actuator (1296) in the first zone is received only through the CAN ECU (1295) in the first zone, the CAN ECU (1295) can be directly connected to the input/output subsystem (1240). And a CAN controller (not shown) within the input/output subsystem (1240) can extract the command data from the received packet and transmit it to the driving control unit (1280).

Meanwhile, if a CAN ECU (1298) that receives a command signal for a safety actuator (1297) important for passenger safety is directly connected to the driving control unit (1280), a CAN controller (not shown) within the driving control unit (1280) extracts the command data for the safety actuator from the received packet. And a computing unit (not shown) and a driving signal generator (not shown) within the driving control unit (1280) can generate a driving signal for the safety actuator using the extracted command data. Through such a flexible internal configuration, for signals related to actuators that require urgent command delivery, the driving control unit (1280) can interpret the command on its own and control the actuator without using the internal resources of the first zone control unit (12), that is, the MCU subsystem (1220) and the network subsystem (1230). Therefore, the processing delay of emergency messages can be reduced when multiple messages are input to the first zone control unit (12) simultaneously.

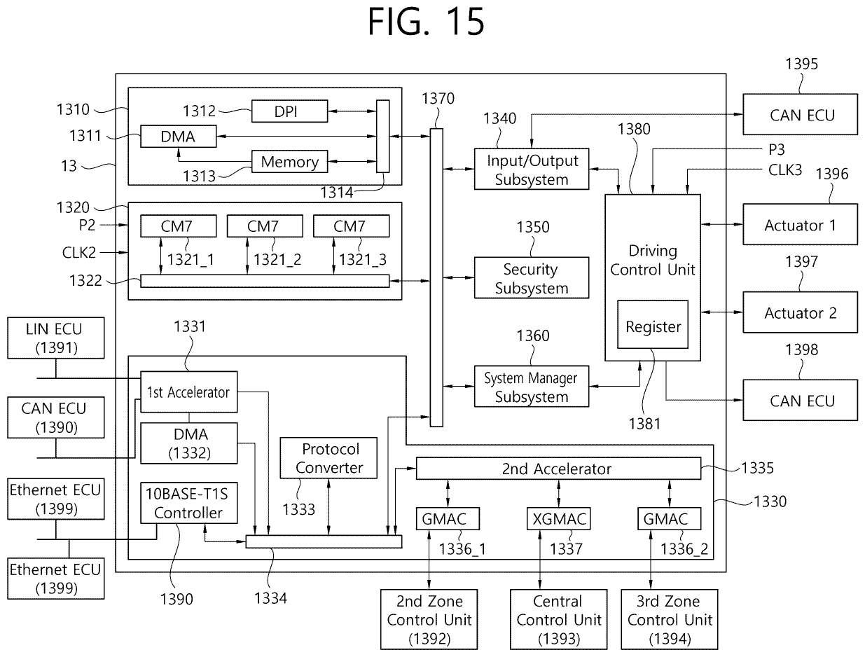

FIG. 15 is a diagram for explaining a method of directly controlling an actuator by a first zone control unit (13) according to another embodiment of the present disclosure.

As shown in FIG. 15, the MCU subsystem (1320), network subsystem (1330), and driving control unit (1380) within the first zone control unit (13) of the present invention are supplied with independent power and clocks. This can maximally prevent the control of the actuator from being interrupted due to a single point of failure.

The driving control unit (1380) may include a computing unit (not shown), a configuration register (1381), and a driving signal generator (not shown). And the computing unit of the driving control unit (1380) interprets the received actuator command data and calculates control parameter values necessary for generating a PWM signal. And it records the calculated control parameter values in the configuration register (1381). The driving signal generator of the driving control unit (1380) can generate an actuator driving signal (e.g., a PWM signal) using the value of the configuration register (1381).

If an error occurs in the computing unit of the driving control unit (1380), the system manager subsystem (1360) can detect the error and transmit an error signal to the MCU subsystem (1320). At least one computing unit of the MCU subsystem (1320) fetches the actuator command data transmitted to the driving control unit (1380) through the main NoC bus system (1370). And it executes the same program used by the computing unit of the driving control unit (1380) to calculate a calculation result value for driving an actuator (e.g., control parameter values for timers and controllers, prescale value, counter value, compare value, clock division value, output pattern value, etc.). Also, it can write the calculated calculation result value for driving an actuator to the configuration register (1381) through the register interface (see FIG. 37) of the driving control unit (1380) via the main NoC bus system and the input/output subsystem.

The first zone control unit (13) may include a signal tunneling module that can consistently and seamlessly transmit a data frame in different network environments while securely protecting a packet containing a specific type of data frame. That is, the first zone control unit (13) may include a signal tunneling module that transmits a calculation result value for driving an actuator, which is input from the outside or generated internally, to a register of a driving signal generator within the driving control unit (1380). The signal tunneling module may include the first accelerator (1331), the second accelerator (1335), the protocol converter (1333) of the network subsystem (1330), the main NoC bus system (1370), the input/output subsystem (1340), and the register interface of the driving signal generator. Through this, the first zone control unit (13) can continuously control the actuator connected to it without interruption even if an error occurs in the computing unit of the driving control unit (1380).

The signal tunneling module taught, the disclosure herein, performs a function of encapsulating data in a payload of an Ethernet or CAN frame, converting the encapsulated data to a serial communication protocol, and transmitting the converted data to a remote register. The signal tunneling module may include software and hardware devices involved in transmitting the register value to the remote register or a driving signal generator in a system that is physically or electrically separated from a specific computing unit.

The network subsystem (1330) may further include a 10BASE-T1S communication controller (1390). And the first zone control unit (13) can communicate with each ECU even when at least one Ethernet ECU (1399) is connected to a single bus. Through this, the first zone control unit (13) can significantly reduce the number of in-vehicle harnesses.

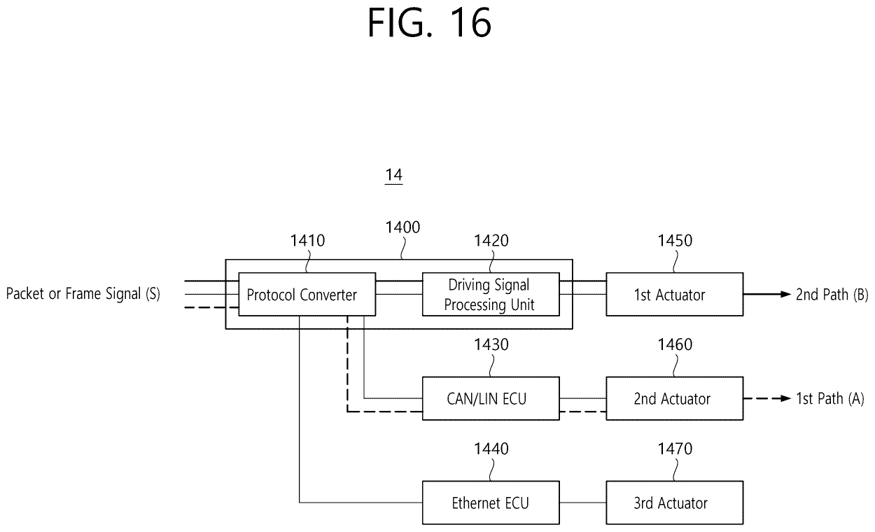

FIG. 16 is a diagram showing signal paths within a zone control unit (1400) in a vehicle control system (14) for a zone architecture according to another embodiment of the present disclosure.

As shown in FIG. 16, the zone control unit (1400) constituting the vehicle control system (14) for a zone architecture may include a protocol converter (1410) and a driving signal processing unit (1420).

A time-critical first actuator (1450) that is located close to the zone control unit (1400) of FIG. 16 or requires a short delay time can be directly connected to the zone control unit (1400). On the other hand, second and third actuators (1460, 1470) that are far from the zone control unit (1400) or have lower priority can be controlled via CAN/LIN/Ethernet ECUs (1430, 1440). This allows the system to reduce the number of ECUs and wiring harnesses.

As shown in FIG. 16, the actuator command data within the packet or frame signal(S) input to the zone control unit (1400) can control the actuators (1450, 1460, 1470) through a first path (A) or a second path (B).

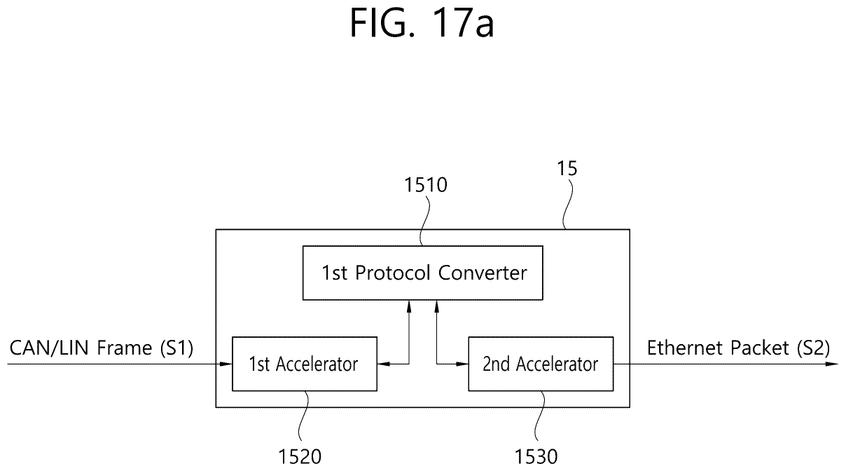

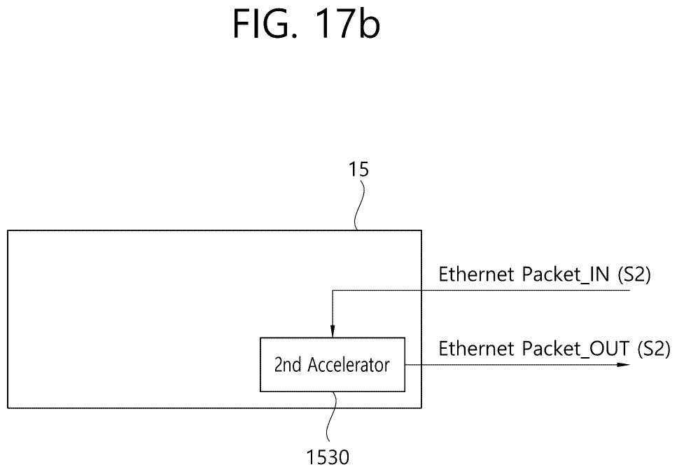

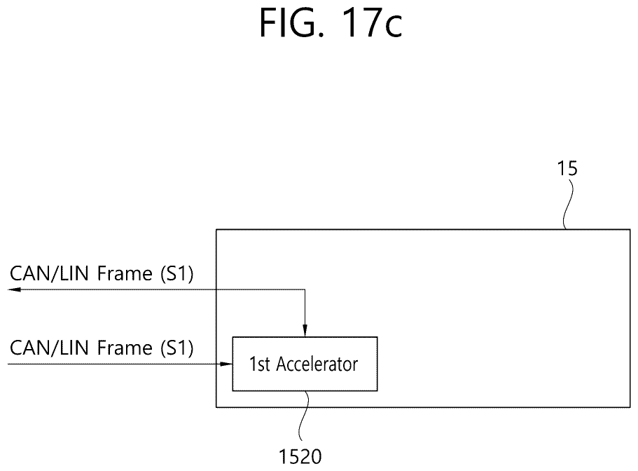

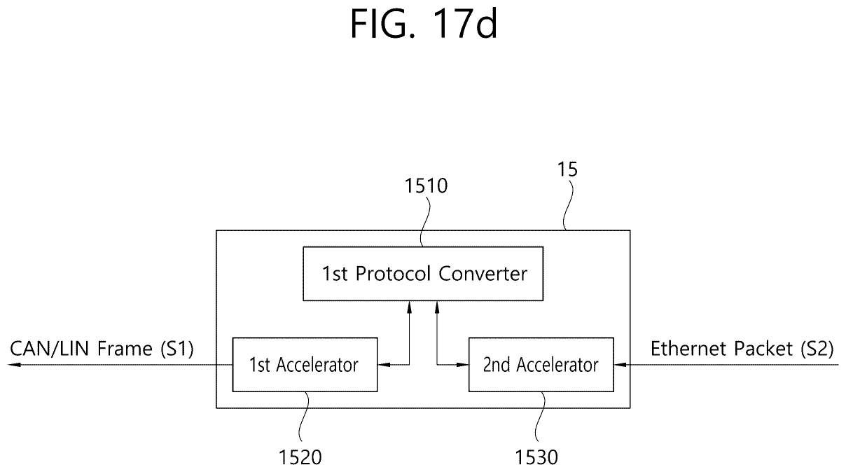

FIGS. 17a to 17d are diagrams showing a part of the operation of the network subsystems (1230, 1330) of FIG. 14 and FIG. 15, corresponding to the first path (A) shown in FIG. 16.

The first accelerator (1520) of the network subsystem (15) shown in FIGS. 17a, 17c, and 17d can perform protocol conversion and translation between CAN-CAN, CAN-LIN, and LIN-LIN. That is, the CAN/LIN frame (S1) received at the CAN/LIN port (not shown) of the network subsystem (15) is analyzed by the first accelerator (1520). And it can be transmitted to the CAN port, LIN port of the network subsystem (15), or the first protocol converter (1510) according to the information within the frame and the routing table stored in the memory (not shown).

The second accelerator (1530) shown in FIGS. 17a, 17b, and 17d is a hardware engine for switching between Ethernet ports of various speeds. The second accelerator (1530) may include functions such as MACsec, IPsec, a traffic shaper, a packet classifier, a scheduler, time synchronization, and frame duplication and elimination for incoming Ethernet packets (S2). Specifically, the second accelerator (1530) parses the L2 or L3 layer for an incoming Ethernet packet (S2). And it can extract the fields necessary for packet processing and perform an L2 or L3 routing table lookup. It can process the packet and make a packet forward decision according to the routing table lookup result and the parsed data (Ethernet type) according to priority. The switching decision of the second accelerator (1530) can be made based on two criteria: the input port information of the packet and the destination information of the packet.

The first protocol converter (1510) shown in FIGS. 17a and 17d executes software that performs conversion between Ethernet and legacy protocols (e.g., CAN/LIN). That is, it shows that the first accelerator (1520), the first protocol converter (1510), and the second accelerator (1530) operate in conjunction when an incoming Ethernet packet (S2) needs to be converted into a CAN/LIN frame (S1) or a CAN/LIN frame (S1) needs to be converted into an Ethernet packet (S2).

The network device (16) according to an embodiment of the present disclosure shown in FIG. 18 may include a network subsystem (1600) and a driving control unit (1660). The driving control unit (1660) can directly transmit a driving signal to an actuator (1670).

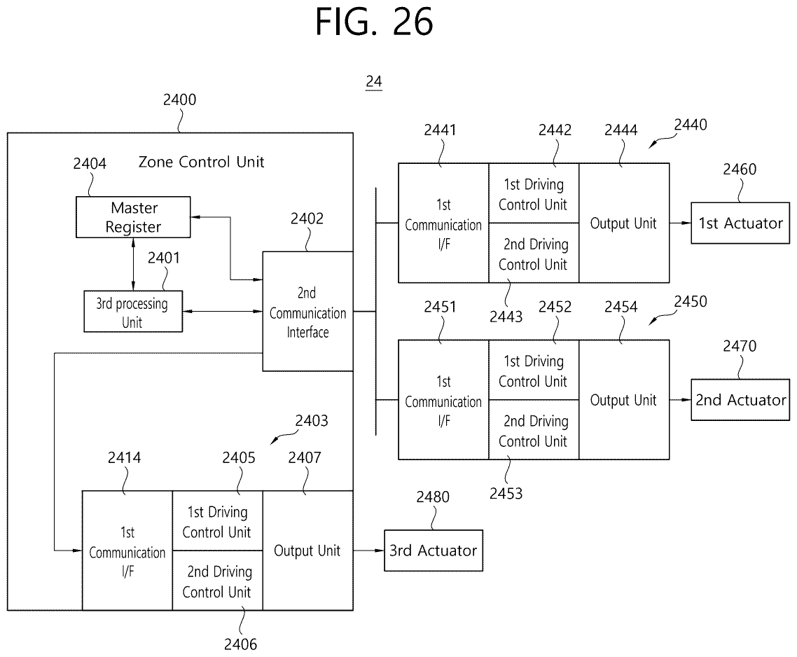

The network subsystem (1600) can determine the internal system path that an input packet (or frame) must take based on the identifier of the input device and the location of the target device included in a specific field within the input packet (or frame). The network subsystem (1600) performs protocol conversion or data parsing on the packet (or frame) flowing through the determined path. And it can transmit it to at least one of an Ethernet communication interface, a CAN communication interface, a LIN communication interface, and the driving control unit (1660) connected to the target device. Here, the location of the target device can be classified into an adjacent node and a self-node (see AN, SN of FIG. 26 to FIG. 28). The adjacent node (AN) may include a central control unit and a zone control unit. The self-node (SN) may include an actuator and an ECU directly connected to the zone control unit.

The network subsystem (1600) may include a first accelerator (1620) that processes a CAN/LIN frame (S1) input to at least one of a plurality of CAN/LIN communication interfaces (not shown). And it outputs it to at least one of the plurality of CAN/LIN communication interfaces (not shown).

The network subsystem (1600) may include a second accelerator (1630) that processes an Ethernet packet (S2) input to at least one of a plurality of Ethernet communication interfaces (not shown). And it outputs it to at least one of the pluralities of Ethernet communication interfaces (not shown).

The network subsystem (1600) may include a first protocol converter (1610) that performs protocol conversion between an Ethernet packet (S2) and a CAN/LIN frame (S1).

The network subsystem (1600) converts an Ethernet packet (S2) and a CAN/LIN frame (S1) into at least one serial communication protocol or converts specific data within the Ethernet packet (S2) and the CAN/LIN frame (S1) into at least one serial communication protocol. And it may further include a second protocol converter (1640) that transmits it to the driving control unit (1660).

The first accelerator (1620) is a CAN and LIN communication message transmission/reception block and can operate by determining a routing path based on hardware or software.

The first accelerator (1620) can transmit an incoming CAN/LIN frame (S1) to a CAN/LIN communication interface, a first protocol converter, a second protocol converter (1640), or a driving control unit (1660) connected to the first accelerator (1620) according to an action list stored in a first table (1601). Here, the action list may include a predetermined transmission path according to the packet type.

When a CAN/LIN frame (S1) is received, the first accelerator (1620) attaches the reception time information to the packet in the form of a timestamp and transmits it to the first protocol converter (1610). The first accelerator can store the timestamp in a first memory (1603). The packet with the reception timestamp and the transmission timestamp attached may each include a serial number and a source communication interface. A connection can be made between a specific packet transmitted from the output communication interface and the timestamp stored in the first memory (1603) using the reception timestamp and the transmission timestamp. Here, the serial number can be generated and incremented each time each CAN and LIN communication interface receives a new packet. The serial number is a counter that increments by 1 for each subsequent packet. And the source communication interface can be used to distinguish the serial numbers generated by each CAN and LIN communication interface. Through this, the first accelerator (1620) can clearly distinguish and manage the packets transmitted from a plurality of output communication interfaces.

The second accelerator (1630) is an Ethernet communication packet transmission/reception block and can operate by determining a routing path based on hardware or software.

The second accelerator (1630) can transmit an incoming Ethernet packet (S2) to an Ethernet communication interface, a first protocol converter, a second protocol converter (1640), or a driving control unit (1660) connected to the second accelerator (1630) according to an action list stored in a second table (1602).

The network subsystem (1600) may include a 2-channel DMA controller (not shown). Each of the 2-channel DMA controllers can directly transfer data between the first memory (1603) and the first accelerator (1620), and between a second memory (1604) and the second accelerator (1630). The DMA controller designated as “0” has a higher priority than the DMA controller designated as channel “1”. And when the same data transfer request is received, the DMA controller of channel “0” can operate first.

The first protocol converter (1610) is a communication protocol converter that converts CAN, CAN-FD, LIN protocols to Ethernet protocol, or converts Ethernet protocol to CAN, CAN-FD, LIN protocols.

The second protocol converter (1640) may include a parsing unit that extracts command data (CMD) or a calculation result value for driving (DPV) in a predetermined field within an Ethernet packet (S2) and a plurality of serial communication controllers. The parsing unit can convert the extracted command data (CMD) or calculation result value for driving (DPV) into a serial communication method (e.g., SPI, I2C, Uart) or a GPIO signal and transmit it to the driving control unit (1660). Each of the plurality of serial communication controllers can be changed to a different communication medium according to a configuration value transmitted from an upper level. At least some of the plurality of serial communication controllers can receive and transmit the same extracted data. At least some of the plurality of serial communication controllers can be connected or disconnected from the driving control unit (1660) according to a selection signal transmitted from an upper level. Each of the plurality of serial communication controllers can transmit data based on at least one of serial communication protocols such as SPI/I2C/UART.

The second protocol converter (1640) may further include the protocol conversion components of the first protocol converter (1610) to perform the protocol conversion function between Ethernet and CAN/LIN. That is, if a functional failure of the first protocol converter (1610) occurs, the second protocol converter (1640) receives the CAN/LIN frame (S1) input to the first accelerator (1620), converts it into an Ethernet communication protocol, and transmits it to the second accelerator (1630). Alternatively, the second protocol converter (1640) receives the Ethernet packet (S2) input to the second accelerator (1630), converts it into a CAN/LIN communication protocol, and transmits it to the first accelerator (1620).

The first and second accelerators (1620, 1630) can parse and extract the command data (CMD) or the calculation result value for driving (DPV) from the Ethernet packet (S2) and the CAN/LIN frame (S1). That is, if a functional failure of the second communication protocol converter (1640) and the computing unit (not shown) within the driving control unit (1660) occurs, the first and second accelerators (1620, 1630) can extract the command data (CMD) or the calculation result value for driving (DPV) from the incoming packet (or frame) and transmit it directly to the driving control unit (1660). The driving control unit (1660) can generate an actuator driving signal using the command data (CMD) or the calculation result value for driving (DPV).

The first table (1601) is a CAN, CAN-FD, LIN communication routing table. And the second table (1602) can be an Ethernet communication routing table. Here, the routing table can be a table including a destination node according to the header information of an input packet (or frame).

The third table (1605) can be a protocol conversion routing table used when converting CAN, CAN-FD, LIN communication to Ethernet communication, or converting Ethernet communication to CAN, CAN-FD, LIN communication. Here, the protocol conversion routing table can be a table including a protocol conversion method according to the source node and destination node of an incoming packet. The first protocol converter (1610) can perform conversion between heterogeneous protocols based on the third table (1605).

The second memory (1604) is a local memory connected to the second accelerator (1630). And it can store the original and a copy of the Ethernet packet (S2) and the Ethernet packet transmitted from the first protocol converter (1610) (where the Ethernet packet is a packet in which a CAN/LIN frame is converted into an Ethernet structure). If the destination node of the packet input to the second accelerator (1630) is the second accelerator (1630), the second accelerator (1630) retrieves the original and the copy stored in the second memory (1604). The second accelerator (1630) can transmit each of the retrieved original and copy to an Ethernet communication interface other than the Ethernet communication interface through which the initial packet was input. Also, the Ethernet communication interface that transmits the original and the Ethernet communication interface that transmits the copy may be different.

The driving control unit (1660) receives the command data (CMD) or the calculation result value for driving (DPV) transmitted from the network subsystem (1600). And through its own processing, it can generate a driving signal (DS) and transmit it to the actuator (1670).

The driving control unit (1660) may include Ethernet and CAN/CAN-FD/LIN communication interfaces. If a failure of the second protocol converter (1640) occurs, the driving control unit (1660) can directly receive the Ethernet packet (S2) and the CAN/CAN-FD/LIN packet (S1) transmitted by the first accelerator (1620) or the second accelerator (1630) and drive the actuator (1670).

The network subsystem (1600) may further include a path controller (1650). The path controller (1650) can be connected to the first accelerator (1620), the second accelerator (1630), the first protocol converter (1610), and the second protocol converter (1640), respectively.

The path controller (1650) can detect a functional failure of the first accelerator (1620), the second accelerator (1630), the first protocol converter (1610), and the second protocol converter (1640) themselves. Also, the path controller (1650) can detect a connection failure on a path including the path between the first accelerator (1620) and the first protocol converter (1610), the path between the first accelerator (1620) and the second protocol converter (1640), the path between the first accelerator (1620) and the driving control unit (1660), the path between the second accelerator (1630) and the first protocol converter (1610), the path between the second accelerator (1630) and the second protocol converter (1640), the path between the second accelerator (1630) and the driving control unit (1660), and the path between the second protocol converter (1640) and the driving control unit (1640).

The path controller (1650) can transmit the CAN/LIN frame (S1) input to the first accelerator (1620) through one of the path from the first accelerator (1620) to the first protocol converter (1610) to the second accelerator (1630), the path from the first accelerator (1620) to the second protocol converter (1640) to the second accelerator (1630), the path from the first accelerator (1620) to the second protocol converter (1640) to the driving control unit (1660), or the path from the first accelerator (1620) to the driving control unit (1660).

The path controller (1650) can transmit the Ethernet packet (S2) input to the second accelerator (1630) through one of the path from the second accelerator (1630) to the first protocol converter (1610) to the first accelerator (1620), the path from the second accelerator (1630) to the second protocol converter (1640) to the first accelerator (1620), the path from the second accelerator (1630) to the second protocol converter (1640) to the driving control unit (1660), or the path from the second accelerator (1630) to the driving control unit (1660).

The path controller (1650) is connected to the first accelerator (1620) and the second accelerator (1630) and can share information about the input packet. If the device to which the input packet is directed is an actuator connected to the driving control unit (1660), the path controller (1650) can control the first accelerator (1620) or the second accelerator (1630) to transmit the input Ethernet packet (S2) or CAN/LIN frame (S1) directly to the second protocol converter (1640) or the driving control unit (1660).

If a functional failure occurs in the first protocol converter (1610), the path controller (1650) can transmit the CAN/LIN frame (S1) input to the first accelerator (1620) through the path from the first accelerator (1620) to the second protocol converter (1640) to the second accelerator (1630), the path from the first accelerator (1620) to the second protocol converter (1640) to the driving control unit (1660), or the path from the first accelerator (1620) to the driving control unit (1660).

If a functional failure occurs in the first protocol converter (1610), the path controller (1650) can transmit the Ethernet packet (S2) input to the second accelerator (1630) through the path from the second accelerator (1630) to the second protocol converter (1640) to the first accelerator (1620), the path from the second accelerator (1630) to the second protocol converter (1640) to the driving control unit (1660), or the path from the second accelerator (1630) to the driving control unit (1660).

If a functional failure occurs in the second protocol converter (1640), the path controller (1650) can transmit the CAN/LIN frame (S1) input to the first accelerator (1620) through one of the path from the first accelerator (1620) to the first protocol converter (1610) to the second accelerator (1630), the path from the first accelerator (1620) to the first protocol converter (1610) to the second accelerator (1630) to the driving control unit (1660), or the path from the first accelerator (1620) to the driving control unit (1660).

If a functional failure occurs in the second protocol converter (1640), the path controller (1650) can transmit the Ethernet packet (S2) input to the second accelerator (1630) through one of the path from the second accelerator (1630) to the first protocol converter (1610) to the first accelerator (1620), the path from the second accelerator (1630) to the first protocol converter (1610) to the first accelerator (1620) to the driving control unit (1660), or the path from the second accelerator (1630) to the driving control unit (1660).

If a failure occurs on the path between the first accelerator (1620) and the first protocol converter (1610), the path controller (1650) can transmit the CAN/LIN frame (S1) input to the first accelerator (1620) through the path from the first accelerator (1620) to the second protocol converter (1640) to the second accelerator (1630), the path from the first accelerator (1620) to the second protocol converter (1640) to the driving control unit (1660), or the path from the first accelerator (1620) to the driving control unit (1660).

In this way, the path controller (1650) can seamlessly transmit an input packet to a target node through a path excluding the faulty path, in response to the type of fault on the path. Here, the target node may include a plurality of Ethernet communication interfaces connected to an Ethernet ECU, a central control unit, and a zone control unit, a plurality of CAN/LIN communication interfaces connected to a CAN/LIN ECU, and a driving control unit (1660) connected to an actuator.

When the fault signal is received, the path controller (1650) can determine the path of the packet with priority over the routing operations of the first accelerator (1620) and the second accelerator (1630).

Also, the path controller (1650) can detect at least one of a functional failure of the second protocol converter (1640), a path failure between the first accelerator (1620) and the second protocol converter (1640), a path failure between the second accelerator (1630) and the second protocol converter (1640), or a path failure between the second protocol converter (1640) and the driving control unit (1660). The path controller (1650) can transmit a functional failure signal and a path failure signal to the first accelerator (1620) and the second accelerator (1630). The first accelerator (1620) and the second accelerator (1630) that have received the functional failure signal and the path failure signal can directly transmit the packet to the driving control unit (1660) if the target device of the input packet is the actuator (1670).

Also, the network subsystem (1600) can detect a functional failure of the computing unit (not shown) of the driving control unit (1660). Here, the computing unit can be a device including a core that receives command data and calculates a calculation result value for driving. The network subsystem (1600) can transmit a functional failure signal of the computing unit of the driving control unit (1660) to the first accelerator (1620) and the second accelerator (1630) when it detects the functional failure of the computing unit. The first accelerator (1620), the second accelerator (1630), and the second protocol converter (1640) that have received the failure signal of the computing unit can extract the command data (CMD) or the calculation result value for driving (DPV) in a predetermined field within the input packet and transmit it to the driving control unit (1660).

In the present invention, the path where the Ethernet packet (S2) is transmitted from the second accelerator (1630) and the second protocol converter (1640) to the driving control unit (1660), and the path where the CAN/LIN frame (S1) is transmitted from the first accelerator (1620) and the second protocol converter (1640) to the driving control unit (1660), as shown in FIG. 18, can be defined as part of a tunneling path.

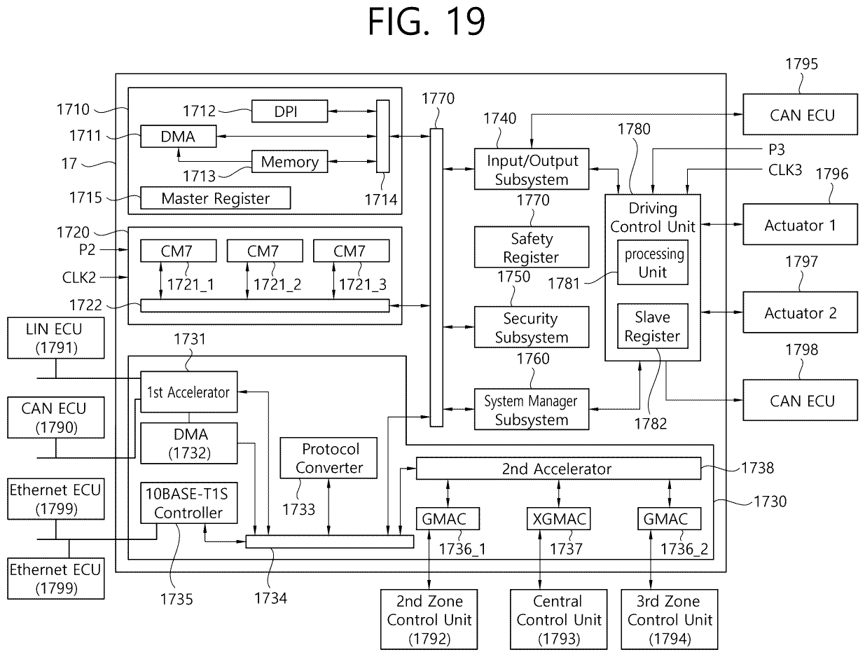

FIG. 19 is an internal block diagram of a first zone control unit (17) using register mirroring according to another embodiment of the present disclosure.

The MCU subsystem (1720) and the driving control unit (1780) of the first zone control unit (17) of FIG. 19 respond to the command data or the calculation result value for driving stored in the master register (1715), slave register (1782), and safety register (1770). And they can calculate a calculation result value for driving or generate a driving signal.

The master register (1715) shown in FIG. 19 can be located within the memory subsystem (1710) or the MCU subsystem (1720). And the slave register (1782) can be located in the driving control unit (1780).

A register that can operate as a master register (1715) is inherent in both the central control unit and the zone control unit. And the master register within the unit that initially receives the command signal can be designated as the master register (1715) of the vehicle control system. The designated master register (1715) can transmit the data stored in it to the slave register (1782) of its own driving control unit (1780) through the network subsystem (1730). Also, it can transmit it to a slave register within another unit through the network subsystem (1730). Here, the other unit means a central control unit or a zone control unit connected to it by communication.

The master register (1715) can store command signals collected from the vehicle, various sensor data of the vehicle (e.g., brake pedal position, speed, steering angle, etc.), command data, and calculation result values for driving. And the master register (1715) can mirror the stored data to the slave register (1782). And the slave register (1782) can store the data mirrored from the master register (1715). Here, mirroring means writing the same data to two storage devices (e.g., registers) identically. Alternatively, mirroring may include a device processing a packet transmitting only a certain part of the information within the packet to another device if that certain part of the information in the incoming packet matches pre-set reference information.

For example, if a certain part of the information of an incoming packet is related to the driving control unit inside the central control unit or a zone control unit, only the calculation result value for driving can be extracted from the incoming packet and mirrored to the driving control unit.

At least one of the pluralities of computing units (1721_1, 1721_2, and 1721_3) of the MCU subsystem (1720) generates command data using a command signal upon the occurrence of an event i.e., the reception of a command signal. And it can calculate a calculation result value for driving (e.g., control parameter values for timers and controllers, i.e., prescale value, counter value, compare value, etc.) using the sensor data and command data stored in the master register (1715) and update the value at a specific address of the master register (1715) and store it for a certain period. If an error occurs in the computing unit (1781) of the driving control unit (1780), the system manager subsystem (1760) detects it and transmits it to the MCU subsystem (1720). And the MCU subsystem (1720) can mirror the latest calculation result value for driving stored at a specific address of the master register (1715) to the slave register (1782) of the driving control unit (1780).

The MCU subsystem (1720), network subsystem (1730), and driving control unit (1780) can refer to the data stored in the master register (1715) and the slave register (1782) in real-time. In particular, the driving control unit (1780) can generate and control a driving signal in conjunction with the command signal, sensor data, command data, or calculation result value for driving stored in the master register (1715) and the slave register (1782).

The driving control unit (1780) collects the status of the actuators from actuators 1 and 2 (1796, 1797) and the ECU (1798). And it transmits it to the master register (1715) and stores the actuator status data. In the subsequent control cycle, the MCU subsystem (1720), network subsystem (1730), and driving control unit (1780) can refer to the actuator status data stored in the master register (1715).

Also, the zone control unit (17) may include a safety register (1770). A safety control signal is activated if an error occurs in the computing unit (1781) of the driving control unit (1780), or if the value of the master register (1715) or the slave register (1782) exceeds a specific threshold. When the MCU subsystem (1720) or the driving control unit (1780) receives the safety control signal, the MCU subsystem (1720) deactivates the current driving signal. And the MCU subsystem (1720) or the driving control unit (1780) can retrieve a pre-stored safety calculation result value for driving from the safety register (1783) and generate a driving signal and transmit it to the corresponding actuator.

The following is an example of an operation scenario performed by the zone control unit (17) of FIG. 19.

Changes in the vehicle's brake pedal, speed sensor, and steering angle sensor data or the driver's input (command signal) are collected in real-time through the first network subsystem (1730) of the zone control unit (17). (e.g., if the brake pedal is suddenly pressed, the brake pedal sensor detects this and generates a signal, and the speed sensor measures the current speed of the vehicle and generates a current vehicle speed sensing signal).

The collected signals are converted into data (e.g., brake pedal input data, vehicle speed data, command data, etc.) and stored at a specific address of the master register (1715). And the data stored at the specific address of the master register (1715) serves as a central repository and can be updated in real-time.

The data stored at the specific address of the master register (1715) is mirrored through the network subsystem (1730) to the master register or slave register within the zone control unit (17) and the zone control units (1792, 1794), central control unit (1793), and ECUs (1795, 1798) connected to the zone control unit (17). And the driving control units within the zone control units (1792, 1794), central control unit (1793), and ECUs (1795, 1798) can retrieve data from the master register or slave register and generate the necessary driving signals.

In this process, the computing unit (1781) of the driving control unit (1780) can calculate an appropriate calculation result value for driving according to the latest command data stored in the slave register (1782). (e.g., based on the data of the sudden pressure change of the brake pedal and the current speed of the vehicle, the computing unit (1781) can calculate a control signal such as pulse period, amplitude, etc. that generates the maximum braking force). A signal generation module (not shown) within the driving control unit (1780) can generate a driving signal using the calculated calculation result value for driving and transmit it to the corresponding actuator.

The network subsystem (1730) can distribute the sensor data, command data, and calculation result value for driving generated in the first zone to each driving device of the vehicle (e.g., brake system, steering system).

The driving control unit (1780) can collect feedback data (e.g., the braking force actually generated after the brake is operated and the change in vehicle speed, etc.) and transmit it to the master register (1715). The master register (1715) can use the feedback data to adjust subsequently received command data and calculated calculation result values for driving, or to adjust other operations of the vehicle control apparatus and vehicle control system.

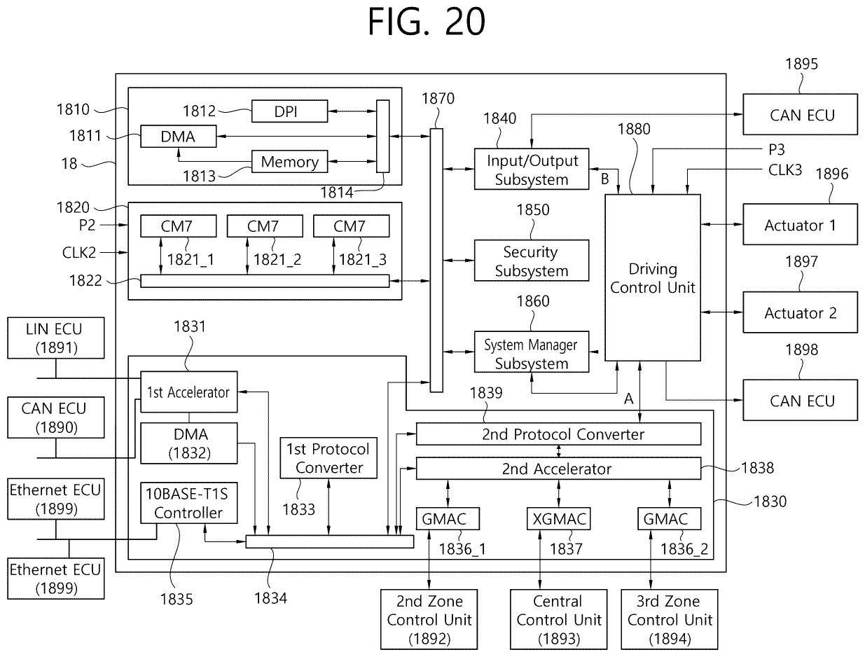

FIG. 20 is a block diagram showing a detailed internal configuration of a first zone control unit (18) according to another embodiment of the present disclosure.

As shown in FIG. 20, the first zone control unit (18) may further include a second protocol converter (1839). The second protocol converter (1839) receives an Ethernet packet or a CAN/LIN frame within the network subsystem (1830). And it parses and extracts command data or a calculation result value for driving for the actuators (1896, 1897) directly connected to the first zone control unit (18) from the data field of the packet or frame using hardware or software. And it can provide redundancy for the actuator driving signal line by transmitting the extracted command data or calculation result value for driving to the driving control unit (1880) through a B line that passes through the main NoC bus system (1870) and the input/output subsystem (1840) or an A line directly connected to the driving control unit (1880).

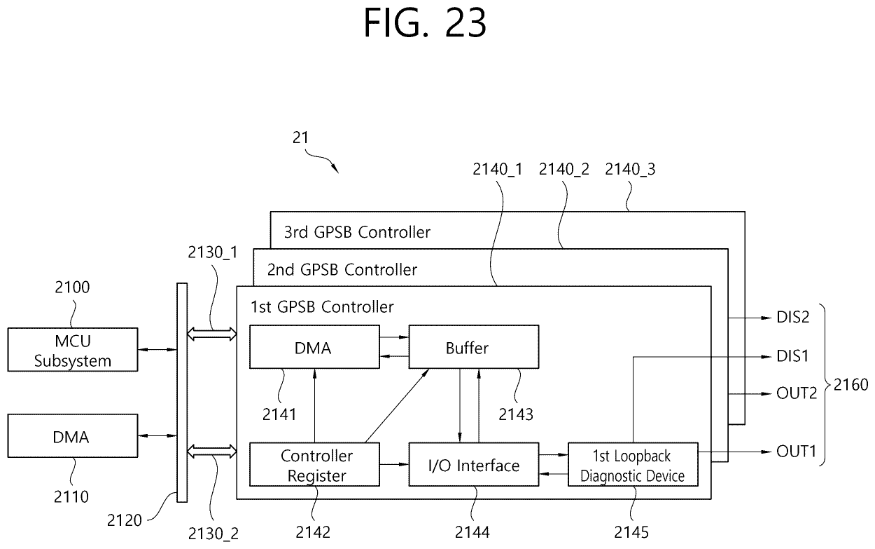

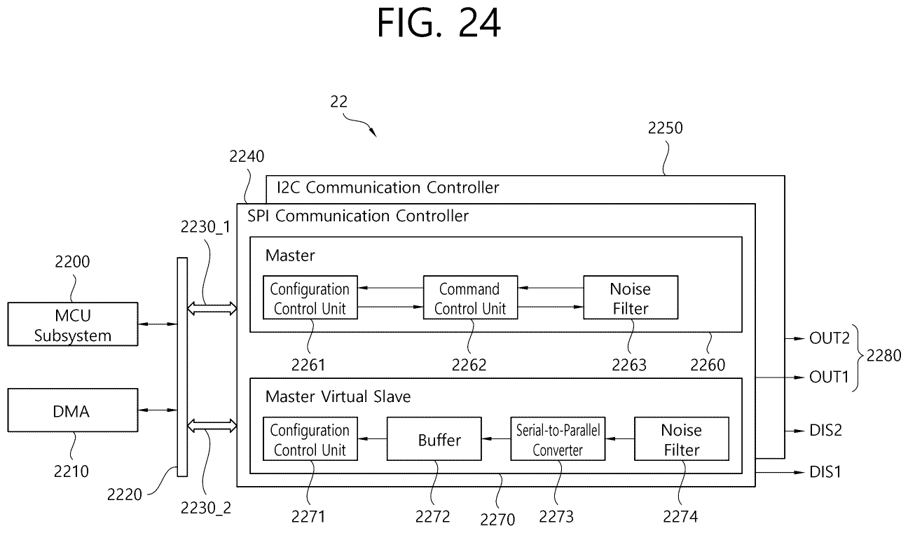

At this time, the network subsystem (1830) extracts the command data or the calculation result value for driving from the Ethernet packet or CAN/LIN frame. And if the actuator that drives the target device of the extracted command data or calculation result value for driving is connected to it, it activates at least one of a plurality of controllers (see GPSB controller of FIG. 23 and communication controller of FIG. 24) of the input/output subsystem (1840). Through this, it can convert the extracted command data or calculation result value for driving into a serial communication form and transmit it to the driving control unit (1880).

If an error occurs in the computing unit (not shown) within the driving control unit (1880), the calculation result value for driving calculated by the MCU subsystem (1820) can be transmitted to the driving control unit (1880) through the A line or the B line.

FIG. 21 is a block diagram showing a detailed internal configuration of a first zone control unit (19) according to another embodiment of the present disclosure.

In the future, all ECUs inside a vehicle may be changed to Ethernet ECUs (1999). Using the 10BASE-T1S controller (1938) shown in FIG. 19, it is possible to communicate individually with the ECUs (1999) connected to a single bus. Therefore, the first zone control unit (19) of FIG. 21 is a form in which the first accelerator (1831) and the first protocol converter (1833) are removed from the zone control unit (18) of FIG. 20, which can greatly simplify the configuration complexity of the first zone control unit (19). Also, since a plurality of Ethernet ECUs (1999) can be connected to a single bus, the weight and quantity of existing wire harnesses can be drastically reduced.

FIG. 22 is a block diagram of a vehicle control apparatus (20) for generating an actuator driving signal according to an embodiment of the present disclosure.

The vehicle control apparatus (20) shown in FIG. 22 can generate an actuator driving signal (2090) using its own stored manual, auxiliary, and autonomous driving control algorithms based on at least one of actuator command data, actuator status, actuator surrounding environment, and vehicle surrounding environment information transmitted from a node (2070) of the vehicle network (e.g., ECU, zone control unit, and central control unit, etc.).

The vehicle control apparatus (20) may include a CPU subsystem (2010), an MCU subsystem (2020), a network subsystem (2030), an input/output subsystem (2050), a driving control unit (2060), and a NoC bus system (2040).

The network subsystem (2030) may include a communication interface (not shown) and a switch (not shown). And it can process a packet transmitted from a node (2070), i.e., an in-vehicle central control unit, a zone control unit, or an ECU, and transmit it to an adjacent node. The input/output subsystem (2050) may include a plurality of communication controllers (2051, 2052). The input/output subsystem (2050) can provide the function of converting Ethernet communication to serial communication, CAN communication to serial communication, and LIN communication to serial communication for transmission.

The CPU subsystem (2010) may include application software including auxiliary and autonomous driving control algorithms.

The MCU subsystem (2020) is composed of cores capable of high-performance computation and can set the initial state of the vehicle control apparatus (20).

The NoC bus system (2040) can control the data flow between the MCU subsystem (2020), the network subsystem (2030), and the input/output subsystem (2050).

The input/output subsystem (2050) may include two communication controllers (2051, 2052). However, it is not limited to this and may include at least two serial communication controllers (e.g., SPI, I2C, UART, etc.) or at least two CAN communication controllers.

The driving control unit (2060) may include at least two driving signal generators (2061, 2062). And each of the at least two driving signal generators (2061, 2062) can output the same actuator driving signal for the same input signal. Here, the computing unit (not shown) of each of the two driving signal generators (2061, 2062) can be composed of a lower-performance computing unit than the computing unit (not shown) within the network subsystem (2030).

The input/output subsystem (2050) and the NoC bus system (2040) are connected by a pair of physically separated bus interfaces for communication. And the pair of bus interfaces may include at least one of AHB, AXI, and APB. The number of bus interfaces between the input/output subsystem (2050) and the NoC bus system (2040) can be determined by the number of communication controllers within the input/output subsystem (2050).

Both of the pair of communication controllers (2051, 2052) of the input/output subsystem (2050) receive at least two identical input signals transmitted from the MCU subsystem (2020) or the network subsystem (2030). And they can generate a converted signal using the same communication method for all of the at least two identical input signals. Or they can generate a converted signal using a heterogeneous communication method for at least one of the at least two identical input signals. Here, the input signal is a signal transmitted from the node (2070). And it may include actuator command data or a calculation result value for driving an actuator. And the communication method may include SPI, UART, I2C, and CAN protocols. For example, the first and second communication controllers (2051, 2052) may include one of a pair of SPI communication controllers, a pair of UART communication controllers, a pair of I2C communication controllers, and a pair of CAN controllers. On the other hand, the first and second communication controllers (2051, 2052) may be composed of a combination of at least two of an SPI communication controller, a UART communication controller, an I2C communication controller, and a CAN controller. For example, the first and second communication controllers (2051, 2052) may be composed of a combination such as an SPI communication controller and a UART communication controller, or an SPI communication controller and an I2C communication controller, or a UART communication controller and an I2C communication controller, or an SPI communication controller and a CAN communication controller.

The network subsystem (2030) identifies the command data and the calculation result value for driving for the actuator (2080) directly connected to the vehicle control apparatus (20) from the data transmitted from the node (2070). And it can transmit the command data and the calculation result value for driving for the actuator (2080) to the first and second communication controllers (2051, 2052) through each of a pair of interfaces placed between the NoC bus system (2040) and the input/output subsystem (2050). The first and second communication controllers (2051, 2052) can convert the received command data and the calculation result value for driving for the actuator (2080) into their respectively pre-designated communication methods and transmit them to the driving control unit (2060).

The driving control unit (2060) may include first and second driving signal generators (2061, 2062) and an output unit (2063). And each of the first and second driving signal generators (2061, 2062) can respectively generate an actuator driving signal using the command data or the calculation result value for driving for the actuator (2080) transmitted from the first communication controller (2051) or the second communication controller (2052). Here, the form of the actuator driving signal (2090) can be a PWM signal.

The output unit (2063) selects one of the respective actuator driving signals generated by the first and second driving signal generators (2061, 2062) using a logic selection circuit. And it can transmit it to the actuator (2080).

The output unit (2063) within the driving control unit (2060) monitors a first diagnostic signal (DS1) transmitted from the first communication controller (2051), a second diagnostic signal (DS2) transmitted from the second communication controller (2052), a third diagnostic signal (DS3) transmitted from the first driving signal generator (2061), and a fourth diagnostic signal (DS4) transmitted from the second driving signal generator (2062). And if all of the first to fourth diagnostic signals (DS1 to DS4) are normal, the output unit (2063) preferentially bases its operation on the data transmitted from the first communication controller (2051). Through this, it can select a driving signal generated by the first driving signal generator (2061) or the second driving signal generator (2062) and transmit it to the actuator (2080). If an error is detected in one of the first to fourth diagnostic signals (DS1 to DS4), the signal output from the faulty device is discarded. And it can select a driving signal generated based on the signal output from the normal device and transmit it to the actuator (2080). Through this, the functional safety for the actuator control of the vehicle control apparatus (20) can be improved by providing redundancy within the vehicle control apparatus (20) for the path where the driving signal generated based on the actuator (2080) command data or the calculation result value for driving received from the node (2070) is transmitted to the actuator (2070). Here, the first and second diagnostic signals (DS1, DS2) may include a loopback signal for the first and second communication controllers (2051, 2052).

Also, if an error occurs in the computing unit of the first and second driving signal generators (2061, 2062) within the driving control unit (2060), the network subsystem (2030) fetches the command data or the calculation result value for driving from a packet passing through the NoC bus system (2040) after the error. And it transmits it to the MCU subsystem (2020). And the MCU subsystem (2020) can transmit the fetched calculation result value for driving or the calculation result value for driving calculated from the fetched command data to the driving signal generators (2061, 2062) via the input/output subsystem (2050).

In the present disclosure, the path from the network subsystem (2030) to the driving signal generator (2060) of FIG. 22 is defined as part of a tunneling path.

FIG. 23 is a block diagram of an input/output subsystem (21) composed of a plurality of General Purpose Serial Bus (GPSB) controllers according to an embodiment of the present disclosure.

The input/output subsystem (21) shown in FIG. 23 may include at least two GPSB controllers (2140_1 to 2140_3) and a GPIO multiplexer (2160).

The at least two GPSB controllers (2140_1 to 2140_3) of the input/output subsystem (21) are connected to the NoC bus system (2120) by an AXI-AHB interconnect (2130_1) and an AHB-APB interconnect (2130_2). And they receive command data (e.g., target operation, target state of a target device, etc.) or a calculation result value for driving (e.g., control parameter values for timers and controllers, prescale value, counter value, compare value, etc.). Also, they can convert it into a pre-designated communication method and transmit it to the driving control unit (2060) of FIG. 22 through the GPIO multiplexer (2160).

Each of the plurality of GPSB controllers (2140_1 to 2140_3) may include a DMA controller (2141), a buffer (2143), a controller register (2142), an I/O interface (2144), and a loopback diagnostic device (2145). Each of the plurality of GPSB controllers (2140_1 to 2140_3) uses a configuration value for a specific item of the controller register (2142) transmitted from the MCU subsystem (2020) of FIG. 22. Through this, by changing the configuration and operation of the DMA controller (2141), buffer (2143), and I/O interface (2144), it can operate as one of an SPI (Serial Peripheral Interface), UART, or I2C communication controller. Here, the specific items may include mode setting (SPI, UART, I2C, CAN mode) and clock setting (e.g., frequency setting, polarity setting, bit width setting, etc.).

Each of the plurality of GPSB controllers (2140_1 to 2140_3) can operate as a master and a slave on its own. Through this, it can transmit an internal signal to the outside or receive an external signal to the inside. And it may further include a loopback diagnostic device (2145). Therefore, by receiving the output signal in the master state as an input signal in the slave state and comparing the two signals, it diagnoses an error in the internal communication path or the communication path between external devices. And it can output the result as diagnostic signals (DS1, DS2).

The registers of each of the plurality of GPSB controllers (2140_1 to 2140_3) are set to generate the same output signal for the same input signal. And the loopback diagnostic device (2145) of each of the plurality of GPSB controllers (2140_1 to 2140_3) can independently diagnose an error in its own internal circuit and an error in the communication path between external devices and output diagnostic signals (DIS1, DIS2).

FIG. 24 is a block diagram of an input/output subsystem (22) according to another embodiment of the present disclosure.

The input/output subsystem (22) shown in FIG. 24 may include an SPI communication controller (2240), an I2C communication controller (2250), and a GPIO multiplexer (2280). The NoC bus system (2220) and the SPI communication controller (2240) and I2C communication controller (2250) can be connected through an AXI-AHB interconnect (2230_1) and an AHB-APB interconnect (2230_2).

The SPI communication controller (2240) may largely include a master (2260) and a master virtual slave (2270). And the master (2260) may include a configuration control unit (2261) that determines interrupts and transmission frequency, a command control unit (2262) that converts serial data to parallel data, and a noise filter unit (2263) that removes signal noise. The master virtual slave (2270) stores the output signal transmitted from the master (2260), and then diagnoses a signal error using the stored signal and a loopback circuit. And it can generate a first diagnostic signal (DS1).

The I2C communication controller (2250) may include a separate internal loopback circuit. And it can diagnose a signal error using the internal loopback circuit and separately generate a second diagnostic signal (DS2). The control parameters of each component of the SPI communication controller (2240) and the I2C communication controller (2250) are respectively set to include the same information for the same input signal. That is, if the SPI signal output from the SPI communication controller (2240) for a signal received from the NoC bus system (2220) and the I2C signal output from the I2C communication controller (2250) for the same received signal from the NoC bus system (2220) are demodulated, the same command data or the same calculation result value for driving is generated.

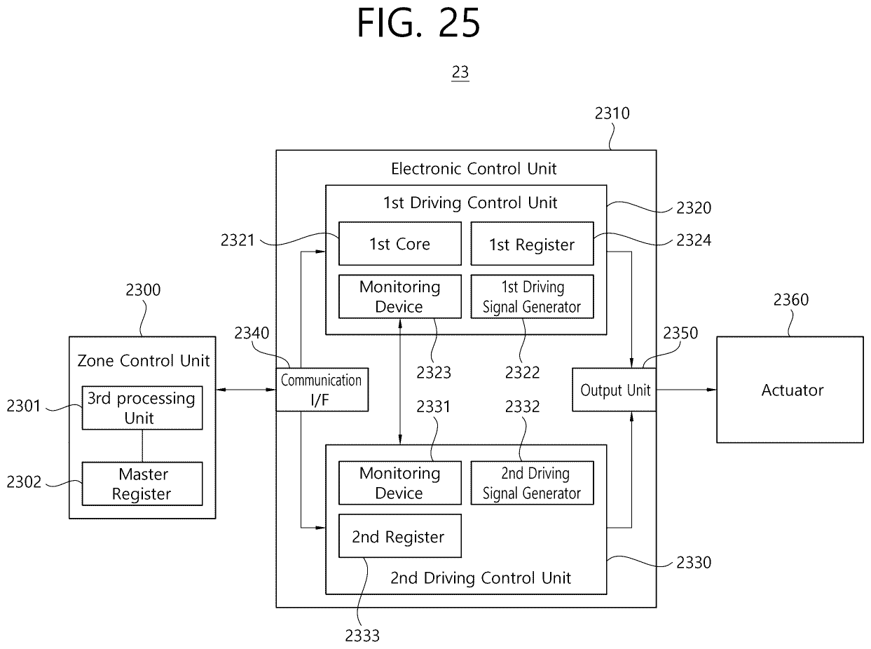

FIGS. 25 and 26 are block diagrams of vehicle control systems (23, 24) including ECUs (2310, 2440, 2450) with improved functional safety for actuator control according to another embodiment of the present disclosure.

As shown in FIGS. 25 and 26, the vehicle control systems (23, 24) may include zone control units (2300, 2400) and ECUs (2310, 2440, 2450). And they can control a plurality of actuators (2360, 2460, 2470, 2480). However, the connection structure and number of zone control units and ECUs are not limited to this and can be modified and expanded.

The zone control units (2300, 2400) shown in FIGS. 25 and 26 are located in a specific zone within the vehicle. And the ECUs (2310, 2440) can communicate directly with the zone control units (2300, 2400). Also, they can directly control the actuators (2360, 2460, 2470).

Each of at least one pair of driving control units (2442 and 2443, 2452 and 2453) within the ECUs (2440, 2450) can be input with data having different information generated from the same command signal. And they can perform different processing on the input data with different information and generate the same output signal. Here, the different information may include command data generated from the same command signal for the same target actuator and a calculation result value for driving calculated from the command data. And the same output signal can be a driving signal in the same pulse form. That is, the command data generated for a command signal to lower the driver's side window is transmitted to the first driving control unit (2320). And the calculation result value for driving calculated for the command signal to lower the driver's side window is transmitted to the second driving control unit (2330). The first driving control unit (2320) performs a calculation on the received command data, calculates a calculation result value for driving, and stores it in the first register (2324). And the first driving signal generator (2322) performs processing to generate a driving signal using the first register value and a first clock (not shown). And the second driving control unit (2330) stores the received calculation result value for driving in the second register (2333). And the second driving signal generator (2332) performs processing to generate a driving signal using the second register value and a second clock (not shown). However, the driving signal output from the first driving control unit (2320) and the second driving control unit (2330) is the same.

The ECUs (2310, 2440, 2450) shown in FIGS. 25 and 26 may include a communication interface (2340, 2441, 2451) composed of at least one of CAN, LIN, and Ethernet controllers. And they may include an output unit (2350, 2444, 2454) that outputs a driving signal that directly controls the actuators (2360, 2460, 2470).

The first driving control unit (2320) shown in FIG. 25 has a first core (2321), whereas the second driving control unit (2330) may not include a core. The first core (2321) within the first driving control unit (2320) performs a calculation on the first command data generated from the first command signal transmitted from the zone control unit (2300), calculates a first calculation result value for driving, and writes it to the first register (2324). And the first driving signal generator (2322) can generate a driving signal according to the first register value and a first clock (not shown) and transmit it to the actuator (2360) through the output unit (2350). On the other hand, the second driving control unit (2330) writes the first calculation result value for driving (a value that the first core (2321) should calculate at the time of an error, which is a value calculated by the third computing unit (2301) using the value stored in the master register (2302) of the zone control unit (2300) at the time of the error) and the second calculation result value for driving (a value calculated by the third computing unit (2301) after the error) transmitted from the zone control unit (2300) to the second register (2333). And the second driving signal generator (2332) can generate a driving signal according to the second register value and a second clock (not shown). Here, the second driving signal generator (2332) has a state machine, registers, and buffers, and can generate an actuator driving signal according to the register value and clock signal without a command from the first core (2321).

The first and second driving control units (2320, 2331) may each have a monitoring device (2331, 2323) that monitors each other's operation. During normal operation, the first driving control unit (2320) processes the data transmitted from the zone control unit (2300). And if an error occurs in the first core (2321), the monitoring device (2331) of the second driving control unit (2330) can transmit error information to the zone control unit (2300) through the communication interface (2340). Here, the error information may include the ID of the core where the error occurred and the time of the error.

The zone control unit (2300) may include a third computing unit (2301). And the third computing unit (2301) can calculate a calculation result value for driving an actuator by performing a calculation using the data stored in the master register (2302) within the zone control unit (2400) based on the error information transmitted by the first driving control unit (2320) and transmit it to the ECU (2310). The communication interface (2340) within the ECU (2310) transmits the received data to the second driving control unit (2330). And the second driving control unit (2330) can generate an actuator driving signal using the received data and transmit it to the actuator (2360). Thereafter, if the monitoring device (2331) of the second driving control unit (2330) detects that the first core (2321) of the first driving control unit (2320) is operating normally, the second driving control unit (2330) transmits a normal operation signal of the first core (2321) to the zone control unit (2300). And the zone control unit (2300) can transmit subsequently received data to the ECU (2310). Here, the data can be command data or a calculation result value for driving.

As shown in FIG. 26, the zone control unit (2400) may include its own driving control unit (2403) that can directly control the third actuator (2480).

The driving control unit (2403) may have the same structure as the ECU (2310) shown in FIG. 25. That is, the driving control unit (2403) within the zone control unit (2400) may include the first and second driving control units (2320, 2331) within the ECU (2310) of FIG. 25. That is, if an error occurs in the first driving control unit (2405) of the driving control unit (2403) within the zone control unit (2400), the second driving control unit (2406) receives data transmitted from the master register (2404) where the third computing unit (2401) calculates and stores data through the second communication interface (2402) and the first communication interface (2414). And it can generate a driving signal for the third actuator (2408). In this way, the communication interface (2340), output unit (2350), first driving control unit (2320), and second driving control unit (2330) of the first ECU (2310) of FIG. 25 are modularized. Through this, they can be used equally in the driving control unit (2403) of the zone control unit (2400) of FIG. 26, which simplifies the design and shortens the development period.

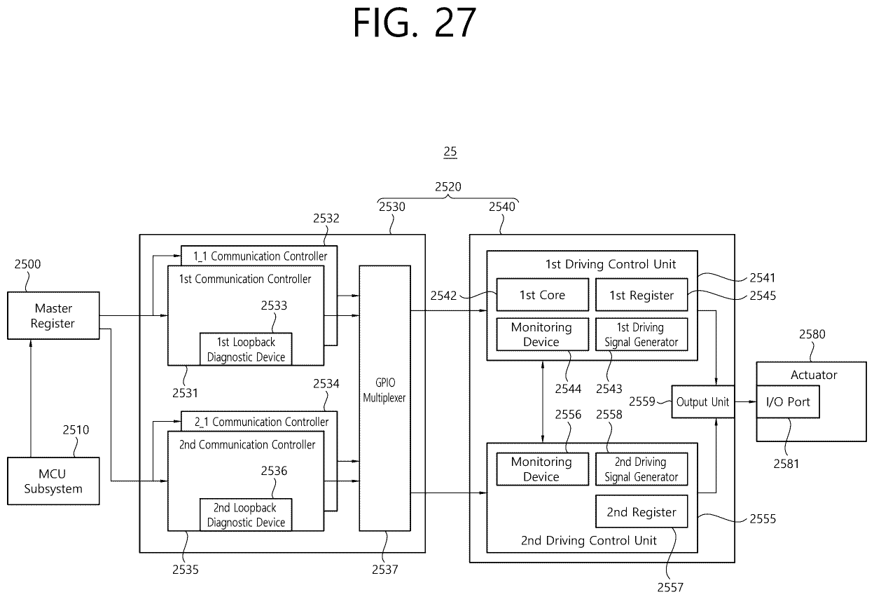

FIG. 27 is a block diagram of a vehicle control apparatus (25) that directly controls an in-vehicle actuator according to another embodiment of the present disclosure.

As shown in FIG. 27, the vehicle control apparatus (25) according to another embodiment of the present disclosure may include a master register (2500), an MCU subsystem (2510), and a driving signal processing unit (2520). And the driving signal processing unit (2520) may include an input/output subsystem (2530) and a driving control unit (2540).

The input/output subsystem (2530) may include first communication controllers (2531, 2532) and second communication controllers (2534, 2535). And the first communication controllers (2531, 2532) and the second communication controllers (2534, 2535) can receive command data or a calculation result value for driving from the master register (2500). Basically, the first communication controllers (2531, 2532) receive command data. And the second communication controllers (2534, 2535) can receive a calculation result value for driving.

Each of the first communication controllers (2531, 2532) and the second communication controllers (2534, 2535) of the input/output subsystem (2530) can be composed of at least two serial communication controllers and operated with redundancy. And each of the redundant communication controllers can output a signal of the same or a different communication method for one input signal. That is, the redundant communication controllers can output the same data in one or a combination of at least two of SPI, UART, and I2C.

The driving control unit (2540) may include first and second driving control units (2541, 2555). And the first driving control unit (2541) and the second driving control unit (2555) can receive command data or a calculation result value for driving from the input/output subsystem (2530). Basically, the first driving control unit (2541) is connected to the first communication controllers (2531, 2532). And the second driving control unit (2555) is connected to the second communication controllers (2534, 2535). And the signals generated by the first and second driving control units (2541, 2555) can be transmitted to the actuator (2580) through the output unit (2559). Here, the first core (2542) can be configured in dual-core lock-step. Therefore, basically, the command data mirrored from the master register (2500) can be converted into a serial communication protocol by the first communication controller (2531) and transmitted to the first driving control unit (2541).

The first core (2542) of the first driving control unit (2541) of the driving control unit (2540) interprets and calculates the command data according to a control model or a control algorithm and generates a calculation result value for driving. And it stores it in the first register (2545). Also, the first driving signal generator (2543) can generate a driving signal using the first register value. On the other hand, the second register (2557) of the second driving control unit (2555) stores the calculation result value for driving mirrored from the master register (2500). And the second driving signal generator (2558) can generate a driving signal using the second register value. That is, the second driving control unit (2555) can generate a driving signal with a different processing from the first driving control unit (2541). If an error occurs in the first driving control unit (2541), the second driving control unit (2555) transmits the error of the first driving control unit (2541) to the master register (2500) and the MCU subsystem (2510). And the master register (2500) can transmit the data at the time of the error to the input/output subsystem (2530). Also, the MCU subsystem (2510) acquires the command data after the error of the first driving control unit (2541) and generates a calculation result value for driving with the same control model or control algorithm as the first driving control unit (2541). And it transmits it to the master register (2500). And the master register (2500) can transmit the updated data to the input/output subsystem (2530).

The input/output subsystem (2530) may include a GPIO multiplexer (2537). And the GPIO multiplexer (2537) can select and transmit the data transmitted from the first and second communication controllers (2531, 2532, 2534, 2535) to the first driving control unit (2541) or the second driving control unit (2555) according to an external control signal.

Basically, the command data transmitted from the master register (2500) can be transmitted to the first driving control unit (2541) by the GPIO multiplexer (2537) via the first communication controller (2531) of the input/output subsystem (2530). If an error occurs in the first communication controller (2531), the first_1 communication controller (2532) receives the command data transmitted from the master register (2500) by an upper-level selection signal. And it can be transmitted to the first driving control unit (2541) by the GPIO multiplexer (2537). If an error occurs in both the first and first_1 communication controllers (2531, 2532), the second or second_1 communication controller (2534, 2535) receives the data transmitted from the master register (2500) by an upper-level selection signal. And it can be transmitted to the first driving control unit (2541) by the GPIO multiplexer (2537). If an error occurs in the first driving control unit (2541), the master register (2500) can transmit the calculation result value for driving calculated and transmitted by the MCU subsystem (2510) to the second driving control unit (2555) through one of the first or second communication controllers (2531, 2532, 2534, 2535) and the GPIO multiplexer (2537).

Meanwhile, each of the controllers within the first and second communication controllers (2531, 2532, 2534, 2535) has a loopback diagnostic device (2533, 2536). And the loopback diagnostic signal can be used as a signal for output selection in the output unit (2559) of the driving control unit (2540).

The output unit (2559) may include a logic circuit. And it can determine a final signal based on the operating status of the first driving control unit and the second driving control unit (2541, 2555) and the loopback diagnostic signal of each of the first and second communication controllers (2531, 2532, 2534, 2535) and transmit it to the actuator (2580).

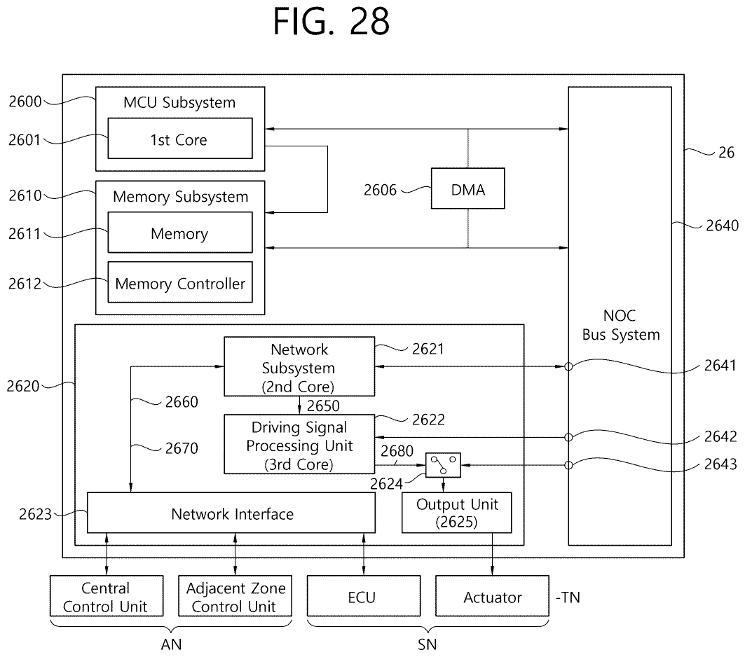

FIG. 28 is an internal block diagram of a zone control unit (26) used in an in-vehicle zone architecture network according to another embodiment of the present disclosure.

As shown in FIG. 28, the zone control unit (26) may include an MCU subsystem (2600), a memory subsystem (2610), a network device (2620), and a NoC bus system (2630).

The zone control unit (26) is connected to a target node (TN). And the target node (TN) can be classified into an adjacent node (AN) and a self-node (SN). The adjacent node (AN) may include a central control unit and an adjacent zone control unit. And the self-node (SN) may include an ECU and an actuator directly connected to the corresponding zone control unit.

The NoC bus system (2640) is connected to the MCU subsystem (2600), the memory subsystem (2610), and the network device (2620) and can control the data flow between these systems and apparatuses.

The first core (2601) of the MCU subsystem (2600) is composed of a high-performance microprocessor capable of complex calculations and data processing. And it can handle programs that require a high amount of computation, Ethernet communication, and large amounts of data. The first core (2601) of the MCU subsystem (2600) prepares a program that can temporarily perform the role of the first core (2542) of the driving control unit (2540) of FIG. 27. And if an error of the first core (2542) of the driving control unit (2540) is detected, it can perform the same function as the first core (2542) until the first core (2542) of the driving control unit (2540) recovers from the error.

The memory subsystem (2610) uses a first memory (2611) that the first core (2601) of the MCU subsystem (2600) uses for code execution, data loading, and storage. And it uses a separate memory (not shown) for code execution, data loading, and storage of the second core (not shown) of the network subsystem (2621) and the third core (not shown) of the driving signal processing unit (2622).

The network subsystem (2621) receives a first signal (in a protocol format such as Ethernet, CAN, LIN) input through the network interface (2623), processes it, and converts it into a second signal (in a protocol format such as Ethernet, CAN, LIN) and can transmit it through the network interface (2623). Specifically, the network subsystem (2621) performs the role of an Ethernet switch and router. And it can perform the role of routing CAN and LIN data. It can also perform the role of converting received data into heterogeneous data and transmitting it to the destination. For example, the network subsystem (2621) can convert a received Ethernet signal into heterogeneous data such as CAN, LIN and transmit it to the destination. In particular, if the received data needs to be consumed by the zone control unit itself, the network subsystem (2621) can simultaneously transmit the received data to the driving signal processing unit (2622), memory (2611), and MCU subsystem (2600). Here, the data may include command data and a calculation result value for driving. If an error occurs in the third core of the driving signal processing unit (2622), the driving signal processing unit (2622) transmits it to the MCU subsystem (2600) through the second interface (2642). And the first core (2601) of the MCU subsystem (2600) can retrieve the command data or the calculation result value for driving written in the memory (2611) through the DMA controller (2606) and calculate a calculation result value for driving or a driving signal. The calculation result value for driving can be transmitted to the driving signal processing unit (2622) through the second interface (2642). And the driving signal can be transmitted to the output unit (2625) using the third interface (2643) and the driving signal switch (2624).

The network subsystem (2621) can transmit command data transmitted from a central control unit, an adjacent zone control unit, or an ECU to the memory subsystem (2610) and the MCU subsystem (2600) through a first interface (2641) connected to the NoC bus system (2640). The driving signal processing unit (2622) can receive a calculation result value for driving transmitted from the MCU subsystem (2600) or the memory subsystem (2610) through a second interface (2642) connected to the NoC bus system (2630). Here, the first and second interfaces are electrically and physically separated from each other, so a single point of failure does not occur.

The network subsystem (2621) processes a first signal (2660) received from an adjacent node (AN) to generate a second signal (2670) or a third signal (2650). And the driving signal processing unit (2622) can receive the third signal (2650) and generate an actuator driving signal (2680). The third signal (2650) can be specific data (e.g., command data or a calculation result value for driving) extracted through separate parsing from the first signal (2660) if the target node (TN) of the received first signal (2660) is a self-node (SN) and an actuator. Or it can be a signal converted from the specific data into SPI, UART, and I2C communication. On the other hand, the second signal (2670) is a signal in which specific data of the first signal (2660) is encapsulated with one of Ethernet, CAN, or LIN protocols if the target node (TN) of the received first signal is an adjacent node (AN) or a self-node (SN) and an ECU.

The network subsystem (2621) and the driving signal processing unit (2622) are physically isolated and can be configured to be electrically independent.

The network subsystem (2621) can perform protocol conversion between Ethernet, CAN, and LIN, and data parsing. Also, the network subsystem (2621) may further include processing from Ethernet, CAN, LIN to SPI/UART/I2C serial communication.

The first core (2601) of the MCU subsystem (2600) receives the command data transmitted from the network subsystem (2621) and performs a calculation. And it calculates a calculation result value for driving and can store the calculation result value for driving at a specific address of a specific memory of the memory subsystem (2610). Here, the first core (2601) and the third core within the driving signal processing unit (2622) can generate the same calculation result value for driving for the same command data.

The network subsystem (2621) processes the first signal (2660) using information included in it (e.g., protocol type, source address, destination address, in-vehicle device ID, etc.) to generate a second signal (2670). And the second signal (2670) can be transmitted to the network interface (2623). Also, the network subsystem (2621) can perform security processing such as L2 switching, timestamping, MACsec, and IPsec on the second signal.

The third core (not shown) of the driving signal processing unit (2622) calculates the third signal (2650) transmitted from the network subsystem (2621) to generate a calculation result value for driving an actuator. And using this, it can generate an actuator driving signal (2680) and transmit it to the output unit (2625).

The network interface (2623) may include a communication interface (e.g., Ethernet PHY, CAN, LIN controller). And the output unit (2625) may include a plurality of GPIOs. The network interface (2623) can communicate with a central control unit, an adjacent zone control unit, and an ECU. And the plurality of GPIOs can be connected to actuators.

Ethernet-based communication is used between the zone control unit and the central control unit and adjacent zone control units. And the zone control unit and the ECU can be connected by one of Ethernet, CAN, and LIN communication. The zone control unit and the actuator are connected by hardwire and can transmit an actuator driving signal such as a PWM signal.

The input signal received by the network device (2620) has data encapsulated in the form of a packet or frame. And the data includes at least some of command data, a calculation result value for driving, an event generation device ID, an in-vehicle device ID targeted by the event generation device ID, a network device ID connected to the event generation device, a network device protocol type, an actuator ID connected to the in-vehicle device, a communication protocol of the driving signal processing unit, and control parameters that determine the form of the driving signal. Here, event generation may include the generation of a device control signal by a user and the generation of a device control signal by a sensor (see FIGS. 41a and 41b).

The destination node or zone control unit to which the network subsystem (2621) routes the input signal is automatically identified based on the event generation device ID included in the input signal. And the destination node can be one of a plurality of communication ports of the network interface (2623) or an input terminal (not shown) of the driving signal processing unit (2622) (see FIGS. 41a and 41b).

The network subsystem (2621) receives a first signal through the network interface (2623). And it can analyze the first signal and transmit it to one of the destination nodes connected to the device to which the first signal is directed.

The network device (2620) may include a parsing unit (not shown) that derives command data and a calculation result value for driving from an input signal.

In the network device (2620), the derived command data can be transmitted to the MCU subsystem (2600) through the first interface (2641). And the derived calculation result value for driving can be transmitted to the MCU subsystem (2600) or the memory subsystem (2610).

The memory subsystem (2610) can transmit the stored calculation result value for driving to the driving signal processing unit (2622) through the second interface (2642) or the third interface (2643) of the NoC bus system (2640).

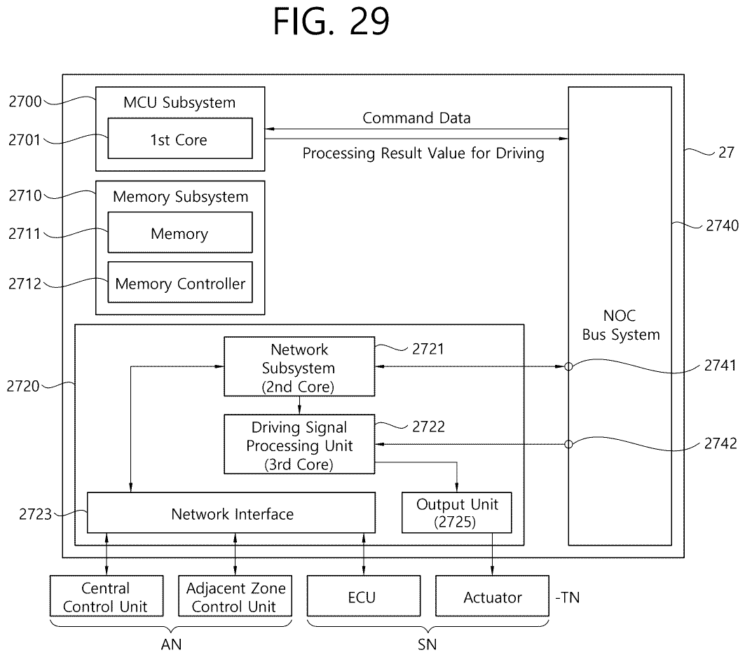

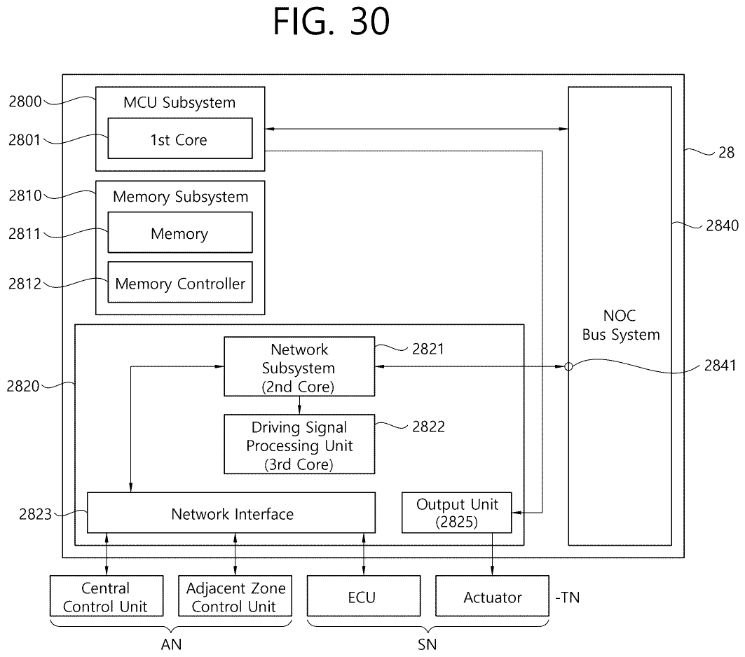

FIGS. 29 and 30 are internal block diagrams of zone control units (27, 28) used in an in-vehicle zone architecture network, as modified embodiments of FIG. 28.

As shown in FIG. 29, the MCU subsystem (2700) receives the actuator command data transmitted by the network subsystem (2721) through the first interface (2741) and the NoC bus system (2740). And it can directly transmit the calculation result value for driving an actuator calculated by the first core (2701) to the driving signal processing unit (2722) through the NoC bus system (2730) and the second interface (2742).

The MCU subsystem (2800) shown in FIG. 30 receives the actuator command data or the calculation result value for driving transmitted by the network subsystem (2821) through the first interface (2841) and the NoC bus system (2840). And it generates an actuator driving signal and can directly transmit the generated actuator driving signal to the output unit (2825).

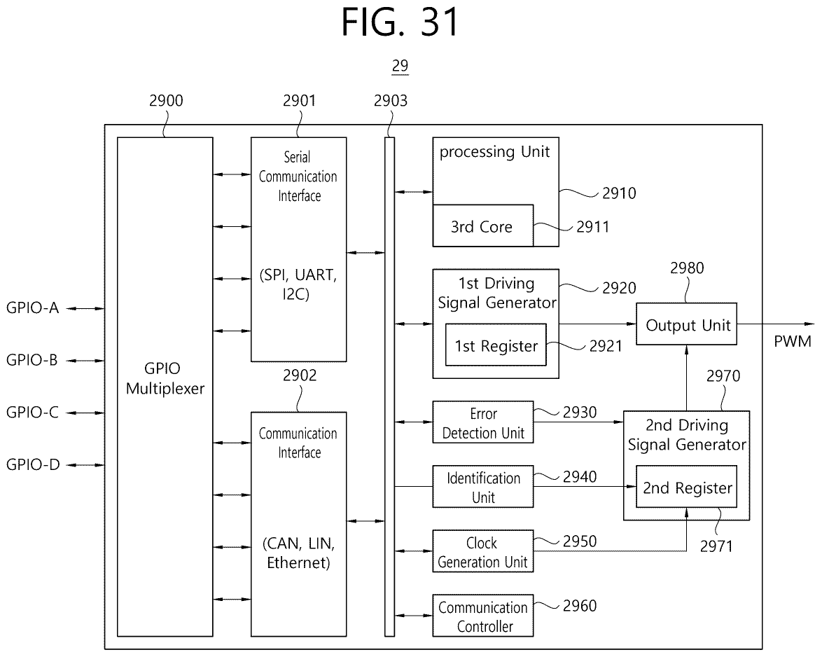

FIG. 31 is an internal block diagram of a driving control unit (29) according to an embodiment of the present disclosure.

The driving control unit (29) shown in FIG. 31 may include a GPIO multiplexer (2900), an output unit (2901), a communication interface (2902), a bus interconnect (2903), a computing unit (2910), a first driving signal generator (2920), an error detection unit (2930), an identification unit (2940), a clock generation unit (2950), a communication controller (2960), a second driving signal generator (2970), and an output unit (2980).

The GPIO multiplexer (2900) can determine the path between GPIO-A to GPIO-D and the output unit (2901) and the communication interface (2902). Here, the output unit (2901) may include SPI, UART, and I2C communication interfaces. And the communication interface (2902) may include CAN, LIN, and Ethernet interfaces.

In the third core (2911) of the driving control unit (29), for the command data received through the output unit (2901), the calculated calculation result value for driving is stored in the first register (2921) of the first driving signal generator (2920). And the first driving signal generator (2920) can generate a driving signal (e.g., a PWM signal) using the calculation value for driving stored in the first register (2921).

If an error occurs in the third core (2911) of the driving control unit (29), the MCU subsystem (see FIG. 28 to FIG. 30) of the zone control unit fetches the command data received at the time of the error and after the error. And it calculates a calculation result value for driving, and the calculated calculation result value for driving is written to the second register (2971) within the second driving signal generator (2970) of the driving control unit (29). And the second driving signal generator (2970) can generate a driving signal using the calculation result value for driving written in the second register (2971). The output unit (2980) can output the outputs of the first driving signal generator (2920) and the second driving signal generator (2970) with AND logic.

The communication controller (2960) includes CAN, LIN, and Ethernet communication controllers and can communicate with external devices through the communication interface (2902).

The computing unit (2910) interprets the command data (including the target device and the target operation, target state of the target device) received through the output unit (2901). And it determines the identification of the target device and the output target for the actuator that drives the target device. It also calculates control parameter values such as prescale value, counter value, compare value, etc., necessary for generating a driving signal that satisfies the output target and can transmit them to the first driving signal generator (2920). The first driving signal generator (2920) can control the amplitude, frequency, and duty cycle of the driving signal using the received control parameter values. Here, the prescale value is the clock division ratio (e.g., 1, 8, 64, 256, 1024, etc.). And the compare value is the value that the timer (not shown) compares (e.g., 8-bit or 16-bit). Also, the duty cycle is the duration of the High state of the PWM signal. The control parameter values are stored in the first register (2921) of the first driving signal generator (2920). And the first driving signal generator (2920) can generate an actuator driving signal using the parameter values stored in the first register (2921) and transmit it to the output unit (2980).

The second driving signal generator (2970) has its own control circuit (state machine, register, buffer). Therefore, it can read and output bits according to its own clock signal without a command from the computing unit (2910). The operation method of the second driving signal generator (2970) can be hardware-based. And it can generate a driving signal according to the set register value and clock signal. That is, the second driving signal generator (2970) can sequentially read data based on hardware or software and determine the output signal. Therefore, the computing unit (2910) does not need to intervene after the initial setting. The clock of the second driving signal generator (2970) can be received from the clock generation unit (2950) from the beginning of system operation.

The output unit (2980) is composed of an AND logic gate. Therefore, it can output the outputs of the first and second driving signal generators (2920, 2970) through a logic like AND.

The process of generating and outputting a driving signal by the second driving signal generator (2970) when an error occurs in the third core (2911) of the computing unit (2910) is as follows.
1) At the beginning of system operation, ‘0’ is stored in the second register (2971) of the second driving signal generator (2970).
2) If an error occurs in the third core (2911) of the computing unit (2910), the error is detected by the error detection unit (2930) of the driving signal control unit (29).
3) The error detection unit (2930) transmits error information (e.g., target actuator ID, error occurrence time, etc.) to the computing unit (2601, 2701, 2801 of FIG. 28 to FIG. 30) of the zone control unit through the output unit (2901).
4) The computing unit of the zone control unit receives the command data at the time of the error and after the error, calculates a calculation result value for driving, and transmits it to the driving control unit (29).
5) The identification unit (2940) identifies the calculation result value for driving for the second driving signal generator (2970) from the signal transmitted from the computing unit of the zone control unit and writes the value to the second register (2971).
6) The state machine and shift register within the second driving signal generator (2970) sequentially read and shift the bits stored in the second register (2971) according to the clock signal received from the clock generation unit (2950).
7) An output buffer (not shown) within the first and second driving signal generators (2920, 2970) determines the output as ‘High’if the read bit value is ‘1’ and ‘Low’ if the bit value is ‘0’.

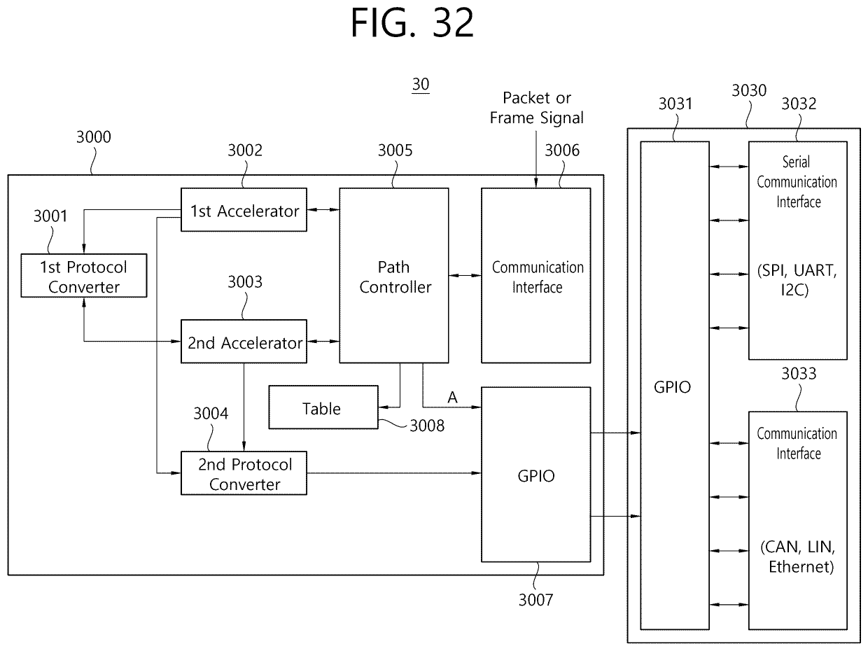

FIG. 32 is an internal block diagram of a network device (30) within a zone control unit including a path controller (3005) according to another embodiment of the present disclosure.

The network device (30) shown in FIG. 32 may include a network subsystem (3000) and a driving control unit (3030).

At least one of a central control unit, a zone control unit, and an ECU is connected to the communication interface (3006) (e.g., CAN, LIN, and Ethernet communication interfaces) of the network subsystem (3000). And it can receive a packet or frame signal including command data or a calculation result value for driving. The network subsystem (3000) can transmit a signal to the driving control unit (3030) through GPIOs (3007, 3031).

The path controller (3005) may be placed between the first and second accelerators (3002, 3003) and the communication interface (3006). The path controller (3005) can transmit an incoming packet or frame to the first accelerator (3002), the second accelerator (3003), or the driving control unit (3030) based on a pre-stored table (3008) where the node information transmitting the command data-the target device information-the node information including the target device are matched. For example, if the node transmitting the command data is a central control unit or a zone control unit, the target device is the driver's side window, and the node including the actuator that drives the target device is a central control unit or a zone control unit or an Ethernet ECU, the path controller (3005) transmits the received packet or frame to the second accelerator (3003). If the node transmitting the command data is a central control unit or a zone control unit, the target device is the driver's side window, and the node including the actuator that drives the target device is a CAN/LIN ECU, the path controller (3005) transmits the received packet or frame to the first accelerator (3002). And if the node transmitting the command data is a central control unit, a zone control unit, or an ECU, the target device is the driver's side window, and the node including the actuator that drives the target device is an actuator connected to it, the path controller (3005) can directly transmit the received packet or frame to the driving signal processing unit (3030) through the A line. Also, the path controller (3005) can dynamically determine a transmission path for an incoming packet or frame according to a TSN scheduler and a zone reference table.

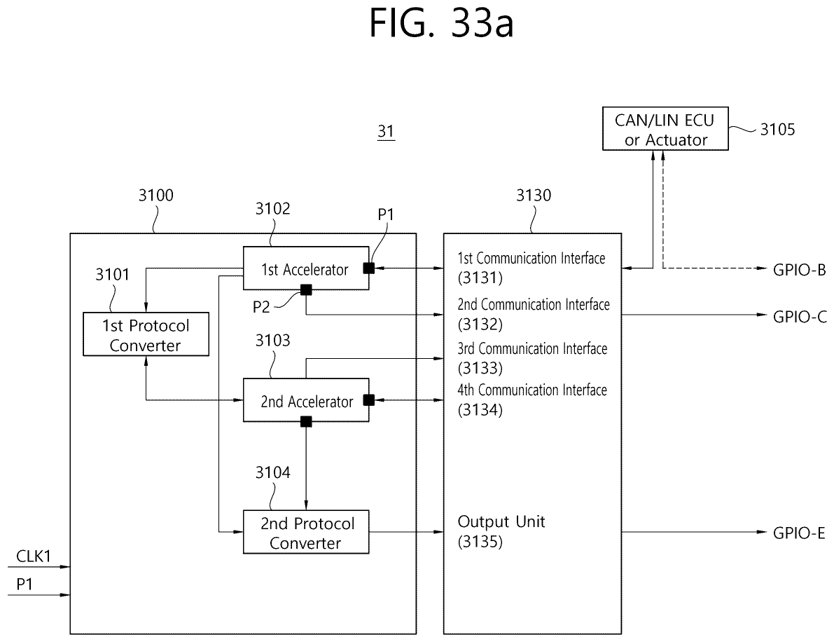

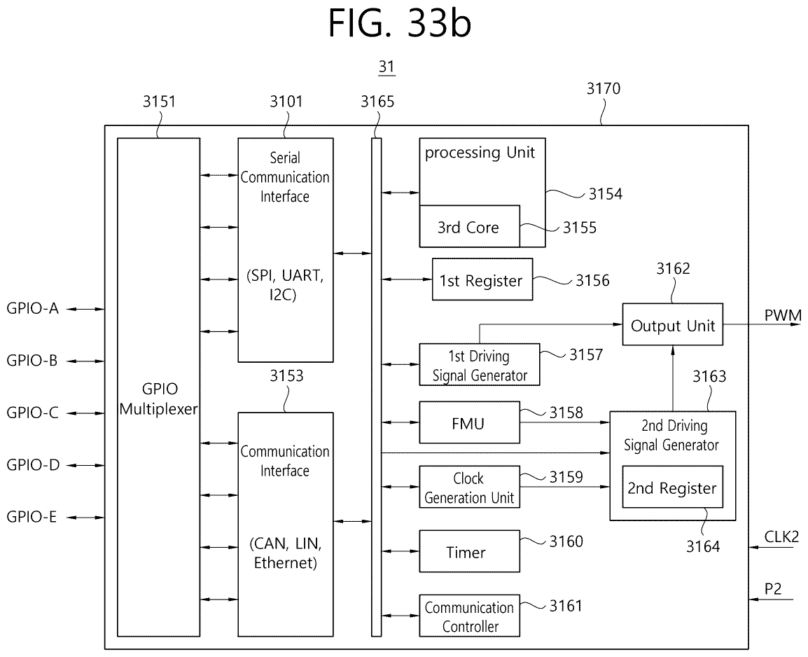

FIGS. 33a and 33b are internal block diagrams of a network device (31) within a zone control unit according to another embodiment of the present disclosure.

The interface (3130) of the network device (31) shown in FIGS. 33a and 33b may include a plurality of communication interfaces (3131 to 3134) and an output unit (3135). And it can receive a packet or frame from at least one of a central control unit, a zone control unit, and an ECU.

The first port (P1) of the first accelerator (3102) of the network subsystem (3100) is connected to the first communication interface (3131), and the first communication interface (3131) can be connected to a specific CAN/LIN ECU (3105). The second port (P2) of the first accelerator (3102) is connected to the second communication interface (3132), and the second communication interface (3132) is connected to GPIO-C of the driving control unit (3170). And the signal transmitted from the second port (P2) of the first accelerator (3102) can be received by the communication controller (3161) through the communication interface (3153) of the driving control unit (3170). Here, the signal transmitted from the second port (P2) of the first accelerator (3102) may be a copy of the signal transmitted from the first port (P1) of the first accelerator (3102).

The communication controller (3161) of the driving control unit (3170) receives the signal transmitted from the second port (P2) of the first accelerator (3102) of the network subsystem (3100). And it can retransmit it to the specific CAN/LIN ECU (3105) through GPIO-B of the driving control unit (3170). That is, the network device (31) can provide a redundant communication path for the specific CAN/LIN ECU (3105). If an error occurs in the line between the first port (P1) of the first accelerator (3102) of the network subsystem (3100) and the specific CAN/LIN ECU (3105), the communication controller (3161) of the driving control unit (3170) transmits the copy signal received through GPIO-C to the specific CAN/LIN ECU (3105) through GPIO-B. Through this, the control of the specific CAN/LIN ECU (3105) can be continued.

Also, the network subsystem (3100) includes a parsing unit (not shown) and a communication controller (not shown) within the second protocol converter (3104). And the parsing unit extracts specific data from the input signal received by the network system (3100). Also, the communication controller transmits the specific data to the output unit (3135) with a serial communication protocol. And the output unit (3135) is connected to GPIO-E of the driving control unit (3170). The first register (3156) within the driving control unit (3170) can store the specific data input through GPIO-E.

If an error occurs on the path between the first communication interface (3131) and the actuator (3105), the driving control unit (3170) can transmit the specific data stored in the first register (3156) to the actuator (3105) through GPIO-B. Here, the specific data may include command data or a calculation result value for driving.

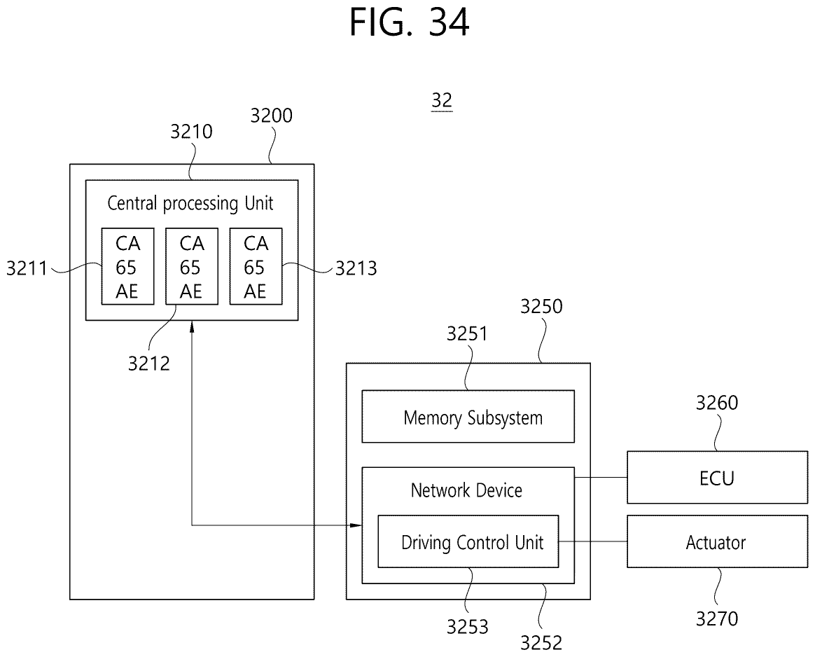

FIG. 34 is a schematic diagram of a centralized vehicle control system (32) in which the in-vehicle computing unit is integrated into the central control unit according to another embodiment of the present disclosure.

Three high-performance processors (3211 to 3213) in a hypervisor-less structure can be placed in the central control unit (3200) shown in FIG. 34. Each of the three high-performance processors (3211 to 3213) can execute an independent software instance or container to support function reallocation and load balancing in a Software-Defined Vehicle (SDV). Each of the three high-performance processors (3211 to 3213) can be responsible for controlling the chassis, powertrain, and body domains. And they can be physically isolated structures. The zone control unit (3250) does not include a computing unit that can interpret command data and calculate a calculation result value for driving. And it may have a driving control unit (3253) that generates a driving signal based on a register.

FIG. 35 is an internal configuration diagram of a driving control unit (33) of a zone control unit according to another embodiment of the present disclosure.

Referring to FIGS. 34 and 35, the central control unit (3200) transmits an Ethernet packet including command data and a calculation result value for driving in specific fields to the zone control unit (3250). And the network device (3252) within the zone control unit (3250) derives the calculation result value for driving from the received Ethernet packet. Also, the driving control unit (3253) can generate a driving signal using the derived calculation result value for driving. That is, the driving control unit (3253 of FIGS. 34, 33 of FIG. 35) can control the first driving signal generator (3320) by writing the received calculation result value for driving to the first register (3321) of the first driving signal generator (3320) of FIG. 35.

If the calculation result value for driving included in the Ethernet packet transmitted from the central control unit (3200) of FIG. 34 is different from the calculation result value for driving required by the command data, the hidden computing unit (3310) of the driving control unit (3253 of FIGS. 34, 33 of FIG. 35) of the network device (3252) extracts the command data included in the Ethernet packet transmitted from the central control unit (3200). And it can calculate a calculation result value for driving and write it to the first register (3321) or the second register (3371). Through this, the zone control unit (3250) can continuously control the actuator even if a temporary error occurs in the central computing unit (3210).

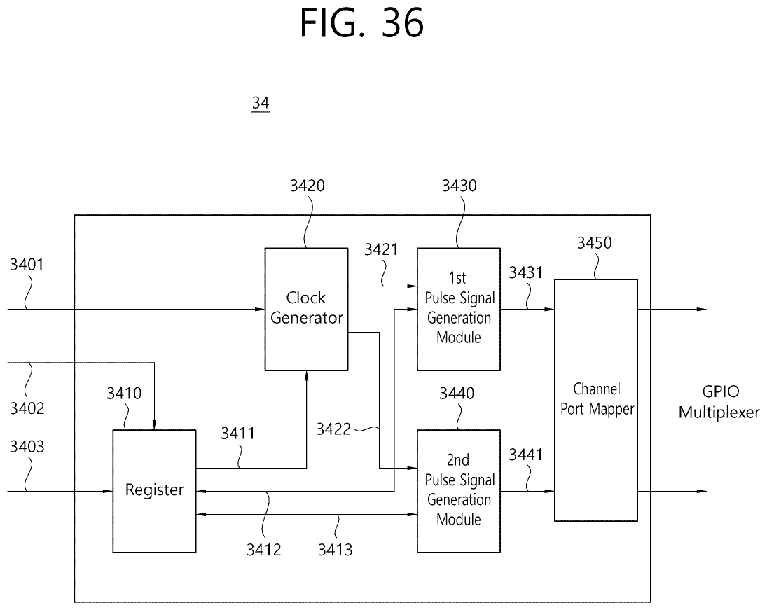

FIG. 36 is an internal block diagram of a driving signal generator (34) according to a comparative embodiment of the present disclosure.

The driving signal generator (34) shown in FIG. 36 may include a register (3410), a clock generator (3420), first and second pulse signal generation modules (3430, 3440), and a channel-port mapper (3450).

The clock generator (3420) generates a first clock (3421) and a second clock (3422) using an upper-level system clock signal (3401) and a clock division value (3411) provided by the register (3410). And it can transmit them to the first pulse signal generation module (3430) and the second pulse signal generation module (3440), respectively.

The first pulse signal generation module (3430) can transmit a first driving signal (3431) to the channel-port mapper (3450) using the first clock (3421) supplied from the clock generator (3420) and a first setting value (3412) provided by the register (3410).

The second pulse signal generation module (3440) can transmit a second driving signal (3441) to the channel-port mapper (3450) using the second clock (3422) supplied from the clock generator (3420) and a second setting value (3413) provided by the register (3410).

The register (3410) receives and stores register values (3403) for each pulse signal generation module from an upper-level system. And it can transmit the stored register values to the first and second pulse signal generation modules (3430, 3440) as a first setting value (3412) and a second setting value (3413), respectively.

The register value (3403) transmitted from the upper-level system includes a clock division value and a setting value (configuration value). And the clock division value (3411) is transmitted to the clock generator (3420). The clock generator (3420) can divide the upper-level system clock signal (3401) by one of ½, ¼, or ⅛ with the clock division value (3411). The first setting value (3412) and the second setting value (3413) are for specifying the phase mode, register mode, and pattern mode of the first and second pulse signal generation modules (3430, 3440). This can specify the cycle length, the signal width setting within the cycle, the number of bits setting within the cycle, and a specific output pattern. The lower-level system clock signal (3402) is independent of the upper-level system clock signal (3401). And the register value of the register (3410) can be transmitted to the first and second pulse signal generation modules (3430, 3440) by the clock signal.

The driving signal generator (34) of FIG. 36 has a disadvantage in that the actuator control stops even if an error occurs in one of the upper-level system clock signal (3401) or the lower-level system clock signal (3402). Also, it may not provide a means for register mirroring for the central control unit or the zone control unit to directly control the first and second pulse signal generation modules (3430, 3440).

FIG. 37 is an internal block diagram of a driving signal generator (35) according to an embodiment of the present disclosure.

The driving signal generator (35) shown in FIG. 37 may include a clock interface (3500), a register interface (3510), a register (3520), a clock generator (3530), pulse signal generation modules (3540, 3550), and a channel port mapper (3560).

The clock interface (3500) can select one of a first system clock (3501) or a second system clock (3502) (3505) and transmit it to the clock generator (3530) and the register (3520). The first system clock (3501) and the second system clock (3502) may have different frequencies, phases, and amplitudes. But preferably, they may include different frequencies. Here, the first system clock (3501) and the second system clock (3502) can be derived from CLK 1 to CLK 4 of FIG. 13. The clocks derived from each of CLK 1 to CLK 4 do not affect each other and can be generated independently. The clock interface (3500) can select at least one of CLK 1 to CLK 4 of FIG. 13 based on the normal operation status of CLK 1 to CLK 4 of FIG. 13 and transmit it to the clock generator (3530).

The clock generator (3530) uses the system clock signal (3505) selected and transmitted from the clock interface (3500) and the clock division values provided by the register (3520). Through this, it can generate at least one clock and transmit it to both or only one of the first and second pulse signal generation modules (3540, 3550). Here, among the clock division values, a first clock division value is for the first pulse signal generation module (3540). And a second clock division value can be for the second pulse signal generation module (3550).

The register interface (3510) can receive register values (3503) transmitted from the master register (901) of FIG. 11, the CPU subsystem (1100) or MCU subsystem (1120) of FIG. 13, or the master register (1715) of FIG. 19. The register values (3503) may include clock division values transmitted to the clock generator (3530) and configuration values for the first pulse signal generation module (3540) and the second pulse signal generation module (3550). Here, the configuration values for the first pulse signal generation module (3540) and the second pulse signal generation module (3550) may include a calculation result value for driving an actuator. And they can specify the phase mode, register mode, and pattern mode of each of the first and second pulse signal generation modules (3540, 3550), specifying the cycle length, the signal width setting within the cycle, the number of bits setting within the cycle, and a specific output pattern. Here, the configuration values for the first pulse signal generation module (3540) and the second pulse signal generation module (3550) are received at the register interface (3510) through the plurality of communication controllers (21 or 22) of FIG. 23 and FIG. 24.

The first pulse signal generation module (3540) uses at least one of the clock signal transmitted from the clock generator (3530) through line 3531 and the configuration values transmitted from the register (3520) through at least one of lines 3522 and 3523. Through this, it can generate a first driving signal and transmit it to the channel-port mapper (3560) through line 3541. Here, the first driving signal is an actuator driving signal corresponding to the command data.

The second pulse signal generation module (3550) uses at least one of the clock signal transmitted from the clock generator (3530) through line 3532 and the configuration values transmitted from the register (3520) through at least one of lines 3522 and 3523. Through this, it can generate a first driving signal and transmit it to the channel-port mapper (3560) through line 3551. Here, the driving signal generator may include at least two pulse signal generation modules.

The clock interface (3500) can select one of the first system clock (3501) and the second system clock (3502) according to their normal status. And the register (3520) can transmit a clock division value corresponding to the type of signal of the system clock selected by the clock interface (3500) to the clock generator (3530) through at least one of lines 3521 and 3525.

During normal operation, the clock interface (3500) transmits the first system clock (3501) to the clock generator (3530). And the clock generator (3530) can generate a first clock signal using the first system clock (3501) and a first clock division value transmitted from the register (3520) and transmit it to the first pulse signal generation module (3540). The first pulse signal generation module (3540) generates a first driving signal (3541) using the first clock signal and a first configuration value transmitted from the register (3520). And it can transmit it to the actuator through the channel port mapper (3560).

If an error of the first system clock (3501) is detected, the clock interface (3500) can select the second system clock (3502) and transmit it to the clock generator (3530). The register (3520) can transmit a second clock division value to the clock generator (3530). The register (3520) can transmit a first configuration value to the first pulse signal generation module (3540). The clock generator (3530) can generate a first clock signal using the second system clock (3502) and the second clock division value (3521) and transmit it to the first pulse signal generation module (3540). The first pulse signal generation module (3540) generates a first driving signal using the first clock signal and the first configuration value. And it can transmit it to the actuator through the channel port mapper (3560).

If an error occurs in the signal or line transmitted from the clock generator (3530) to the first pulse signal generation module (3540), the second pulse signal generation module (3550) is activated. And the second pulse signal generation module (3550) can generate a first driving signal using the first clock signal transmitted from the clock generator (3530) and the first configuration value transmitted from the register (3520). Here, the first and second pulse signal generation modules (3540, 3550) are identical in operating frequency, circuit configuration, and clock generation method. If the first and second pulse signal generation modules (3540, 3550) are not identical in operating frequency, circuit configuration, and clock generation method, the register (3520) transmits a second configuration value to the second pulse signal generation module (3550). And the second pulse signal generation module (3550) can generate a first driving signal using the first clock signal and the second configuration value.

If an error occurs in the signal or line transmitted from the clock generator (3530) to the first pulse signal generation module (3540), and an error also occurs in the first system clock (3501), the clock generator (3530) can receive a second clock division value from the register (3520) and generate a first clock signal. And the second pulse signal generation module (3550) can generate a first driving signal using the first clock signal and a second configuration value.

Meanwhile, the register (3520) separately includes a safety control value. And if the actuator exceeds the state required by the command data (e.g., sudden acceleration, rapid window closing, sharp turn, etc.), the register (3520) receives an error signal (AF) from a device (not shown) that monitors the actuator status. And the register (3520) transmits a safety control value to the first and second pulse signal generation modules (3540, 3550) through line 3524. And the first and second pulse signal generation modules (3540, 3550) process the safety control value with the highest priority to stop the actuator or maintain it in a safe state.

Also, in the case of an emergency control signal, the upper-level system transmits a direct control signal (DCS) to the register interface (3510). And the register interface (3510) can directly transmit the register value (3503) received after receiving the direct control signal (DCS) to the first or second signal generation module (3540, 3550) through line 3511. Here, the upper-level system may include the CPU subsystem (1000, 2010), MCU subsystem (1020, 1820, 1920, 2020, 2600, 2700, 2800), and central computing unit (3210) of FIG. 13, FIG. 14, FIG. 15, FIG. 20, FIG. 21, FIG. 28, FIG. 29, FIG. 30, and FIG. 34. Here, the register value (3503) may include a calculation result value for driving an actuator. Here, the direct control signal (DCS) can be a selection signal transmitted from the central control unit or a zone control unit to directly control the first and second pulse signal generation modules (3540, 3550).

Meanwhile, the second pulse signal generation module (3550) operates complementarily with the first pulse signal generation module (3540) and can be used for precise actuator control. That is, the second pulse signal generation module (3550) can transmit an auxiliary driving signal to the first pulse signal generation module (3540).

That is, both the first pulse signal generation module (3540) and the second pulse signal generation module (3550) are activated. And the clock generator (3530) receives a third clock division value through line 3525 and generates a second clock signal. And it can transmit it to the second pulse signal generation module (3550) through line 3532. The first pulse signal generation module (3540) generates a main driving signal. And the second pulse signal generation module (3550) receives a separate configuration value (3523) from the register (3520) and generates an auxiliary driving signal. And the actuator can be precisely controlled by the combination of the main driving signal and the auxiliary driving signal. Here, the auxiliary driving signal can be a pre-set calculation result value for driving an actuator corresponding to the configuration value stored for each address of the register (3520). Alternatively, it can be a calculation result value for driving an actuator transmitted by another control device other than the device currently transmitting the actuator driving command signal. That is, if the driver transmits a brake pedal signal and at the same time an additional brake signal transmitted from the ADAS system occurs, the second pulse signal generation module (3550) can generate a driving signal corresponding to the additional brake signal and transmit it to the actuator.

Here, the configuration value and the calculation result value for driving an actuator can be parameters that set the period, signal, width, pattern, etc. of the actuator driving signal generated by the first and second pulse signal generation modules (3540, 3550).

When a write signal (WS) is received from the upper-level system, the register interface (3510) can write the input register value (3503) to a specific address of the register (3520).

The driving signal generator (35) can avoid stopping due to a clock signal failure by using at least one of the first system clock (3501) and the second system clock (3502) signals.

In the present invention, the path between the register interface (3510) and the register (3520) of FIG. 37 can be defined as part of a tunneling path.

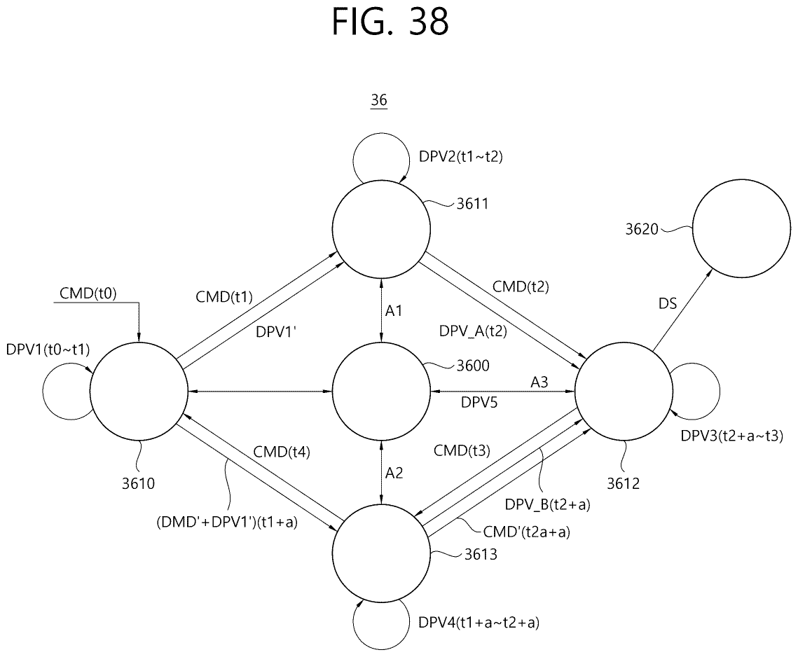

FIG. 38 is a diagram showing a signal flow in a zone control system (36) having data security and a backup path according to another embodiment of the present disclosure.

The zone control system (36) shown in FIG. 38 may include first to fourth zone control units (3610, 3611, 3612, and 3613). The configuration of FIG. 38 is one embodiment, and variations in the number of zone control units and the network architecture are possible.

FIG. 38 shows the signal content in each component and transmission path of the zone control system (36) when actuator command data (CMD(t0)) is received by the first zone control unit (3610), and the actuator (3620) that drives the target device to which the actuator command data (CMD(t0)) is directed is in the third zone control unit (3612). Here, the actuator command data (CMD(t0)) may be input to any one of the first to fourth zone control units (3610 to 3613).

At time T0, actuator command data (CMD) is input to the first zone control unit (3610).

Between times T0 and T1, the first zone control unit (3610) calculates a first calculation result value for driving (DPV1) for the actuator command data (CMD) by its own computing unit.

At time T1, the first zone control unit (3610) transmits the original of the actuator command data (CMD) and the original of the first calculation result value for driving (DPV1) to the second zone control unit (3611). And after a certain time (t1+a), it transmits a copy of the actuator command data (CMD′) and a copy of the first calculation result value for driving (DPV1′) to the fourth zone control unit (3613).

Between times T1 and T2, the second zone control unit (3611) uses the original of the actuator command data (CMD) transmitted from the first zone control unit (3610). Through this, it generates a second calculation result value for driving (DPV2) by its own computing unit. And it selects one of the first calculation result value for driving (DPV1) or the second calculation result value for driving (DPV2) (DPV_A) through a predetermined rule (e.g., 2-out-of-3 or 3-out-of-5 voting logic, etc.) for the generated second calculation result value for driving (DPV2) and the original of the first calculation result value for driving (DPV1) transmitted from the first zone control unit (3610). And if they are not identical, it prepares to transmit both the first calculation result value for driving (DPV1) and the second calculation result value for driving (DPV2). Here, if the first calculation result value for driving (DPV1) and the second calculation result value for driving (DPV2) are not identical, it can transmit a first alarm signal (A1) to the central control unit (3600). The central control unit (3600) can receive and store at least one of CMD(t0) and DPV1(t0~t1) or perform computation processing. And when it receives the first alarm signal (A1), it prepares to transmit at least one of CMD(t0) and its own computation processing result value to the third zone control unit (3612).

Between times T1+a and T2+a, the fourth zone control unit (3613) uses the copy of the actuator command data (CMD′) transmitted from the first zone control unit (3610). Through this, it generates a fourth calculation result value for driving (DPV4) by its own computing unit. And it selects one of the copy of the first calculation result value for driving (DPV1′) or the fourth calculation result value for driving (DPV4) through a predetermined rule for the generated fourth calculation result value for driving (DPV4) and the copy of the first calculation result value for driving (DPV1′) transmitted from the first zone control unit (3610). And if they are not identical, it prepares to transmit both the copy of the first calculation result value for driving (DPV1′) and the fourth calculation result value for driving (DPV4). Here, if both the copy of the first calculation result value for driving (DPV1′) and the fourth calculation result value for driving (DPV4) are not identical, it can transmit a second alarm signal (A2) to the central control unit (3600). When the central control unit (3600) receives the second alarm signal (A2), it prepares to transmit at least one of CMD(t0) and its own computation processing result to the third zone control unit (3612).

At time T2, the second zone control unit (3611) transmits the original of the actuator command data (CMD) and DPV_A to the third zone control unit (3612).

At time T2+a, the fourth zone control unit (3613) transmits the copy of the actuator command data (CMD′) and the selected calculation result value for driving (DPV_B) from DPV1′ and DPV4 to the third zone control unit (3612).

Between times T2+a and T3, the third zone control unit (3612) selects one of the original and copy of the actuator command data (CMD, CMD′) according to a predetermined rule (802.1CB standard specification). And it calculates a third calculation result value for driving (DPV3) using the selected signal.

At time T3, the third zone control unit (3612) compares the DPV_A, DPV_B, and DPV3 values. And if two or more of the three are identical, it selects one of the two identical ones, or if three or more of five are identical, it makes a final selection (DPV_F) of one of the three identical ones. Also, it generates a driving signal (DS) using the finally selected calculation result value (DPV_F) and transmits it to the target actuator (3620). If, among the received signals, more than a predetermined number (e.g., 2 out of 3 or 3 out of 5) are different, the third zone control unit (3612) can transmit a third alarm signal (A3) to the central control unit (3600).

When the central control unit (3600) receives the third alarm signal (A3), it can transmit CMD and its own calculation result value (DPV5) to the third zone control unit (3612). Also, if all of the signals within DPV_A, the signals within DPV_B, and the DPV3 signal are different, the third zone control unit (3612) transmits a separate alarm signal to the central control unit (3600). And the central control unit (3600) transmits DPV5 to the third zone control unit (3612). And the third zone control unit (3612) can generate a driving signal (DS) using DPV5. Alternatively, the third zone control unit (3612) can control the target actuator (3620) with a predetermined safety level value.

In the in-vehicle zone control system (36) shown in FIG. 38, each zone control unit performs its own computation on the same command data. And it transmits the computation value to the next zone control unit. And the next zone control unit, after comparing and verifying the accumulated computation values, selects only reliable values and transmits them to the next zone control unit. Through this, it can finally generate a driving signal using an error-free calculation result value for driving and transmit it to the target actuator.

Through this, the zone control system (36) of the present invention can accurately transmit a calculation result value for driving that accurately corresponds to the initial command data to the actuator that drives the target device, even if data manipulation by external intrusion or an error in a computing unit within a unit occurs. Also, if the calculation result value for driving is uncertain or not resolved, the zone control system (36) can control the target actuator at a preset safety level.

Meanwhile, the central control unit (3600) of the zone control system (36) of FIG. 38 uses the alarm signals and their respective self-computation values (first computation value, second computation value, fourth computation value) transmitted by the first, second, and fourth zone control units (3610, 3611, 3613). Through this, it can provide a means to check for errors in the computing unit or on the path within each zone control system (36) by applying a predetermined rule.

For example, if the central control unit (3600) receives an alarm signal from the second zone control unit (3611) and does not receive an alarm signal from the fourth zone control unit (3613), the central control unit (3600) can recognize that an error has occurred in the computing unit of the second zone control unit (3611) or on the path between the first zone control unit (3610) and the second zone control unit (3611) and perform post-processing. And if alarm signals are received from both the second zone control unit (3611) and the fourth zone control unit (3613), the central control unit (3600) can identify that there is an error in the computing unit within the first zone control unit (3610) if the self-computation values transmitted by the second zone control unit (3611) and the fourth zone control unit (3613) are identical after comparison.

As another example, if the self-computation values transmitted from the first, second, and fourth zone control units (3610, 3611, 3613) are all identical, and the self-computation value (DPV3) of the third zone control unit (3612) is different from the self-computation values (DPV1, DPV2, DPV4) transmitted from the first, second, and fourth zone control units (3610, 3611, 3613), the central control unit (3600) can select one of DPV1, DPV2, and DPV4 and write it to a register within the driving control unit of the third zone control unit (3612). Alternatively, the second zone control unit (3611) can write its self-computation result value (DPV2) to the register within the driving control unit of the third zone control unit (3612).

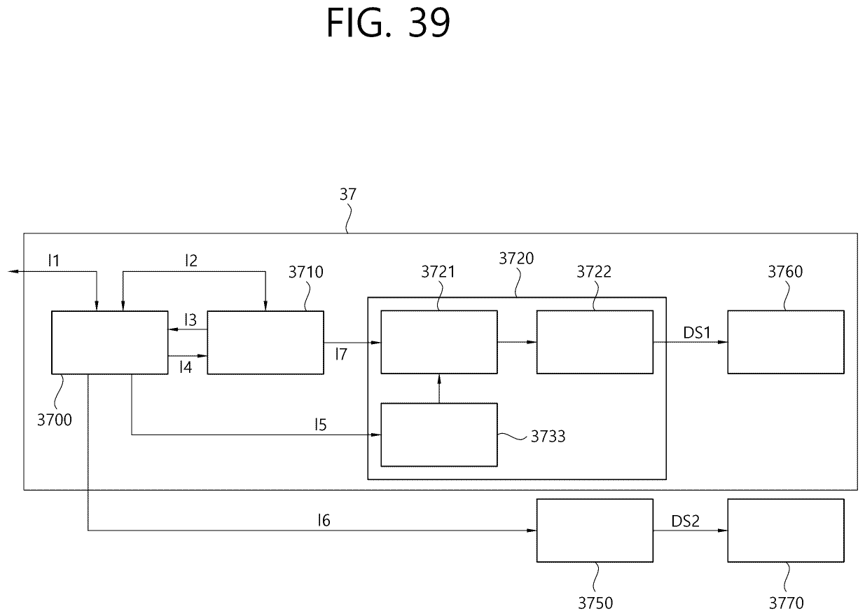

FIG. 39 is a block diagram of a zone control unit (37) constituting the zone control system (36) of FIG. 38 according to another embodiment of the present disclosure.

The zone control unit (37) shown in FIG. 39 is an internal block diagram of the third zone control unit (3612) shown in FIG. 38. However, the internal block diagram of FIG. 39 can be commonly applied to the first to fourth zone control units (3610, 3611, 3612, 3613).

The zone control unit (37) may include a network subsystem (3700), a computing unit (3710), and a driving control unit (3720).

The network subsystem (3700) within the zone control unit (37) can transmit a signal including at least one of command data (CMD), a calculation result value for driving calculated by its own computing unit (DPV_E), calculation result values for driving transmitted from adjacent zone control units (DPV_J), and an alarm signal (A) (an alarm signal transmitted from the computing unit (3710) within the zone control unit (37)) to the computing unit (3710) within the zone control unit (37), adjacent zone control units, the central control unit, and an ECU (3750) outside the zone control unit (37) through a plurality of signal lines l1.

The network subsystem (3700) can generate a copy of the original command data or calculation result value for driving and transmit the original and the copy to an adjacent zone control device at regular time intervals.

Specifically, the computing unit (3710) within the zone control unit (37) calculates its own computation value (DPV_E) using the command data (CMD) received from the network subsystem (3700) through signal line l4. And it can transmit the calculated DPV_E to the network subsystem (3700) through signal line l2.

Also, the network subsystem (3700) within the zone control unit (37) selects one of the original and copy of the command data received at regular time intervals according to the 802.1CB standard. And the computing unit (3710) verifies the integrity of the data by applying a predetermined first rule (e.g., bit comparison in a specific cycle section, etc.) to the selected command data. And if an abnormality occurs, it can transmit an alarm signal indicating an error on the network path to the outside through the network subsystem (3700).

Also, the computing unit (3710) within the zone control unit (37) applies a second rule (e.g., 2-out-of-3 or 3-out-of-5 decision logic) to at least one calculation result value for driving (DPV_J) transmitted from an adjacent zone control unit and its own calculated calculation result values for driving (DPV_E). Through this, it determines a final computation value (DPV_F) and can transmit it to the network subsystem (3700) through signal line l3.

The network subsystem (3700) can transmit the final computation value (DPV_F) to the driving control unit (3720) through signal line l5. Here, if a difference of more than a predetermined number occurs when comparing its own computation value (DPV_E) with the computation values (DPV_J) transmitted by other zone control units, the computing unit (3710) generates an alarm signal (A) indicating the occurrence of an error in the computing unit (3710) within the vehicle control system. And it transmits it to the network subsystem (3700) through signal line l3. And the network subsystem (3700) can transmit the alarm signal (A) to the central control unit or an adjacent zone control unit through a plurality of signal lines l1. Here, signal lines l2, l3, and l4 can be configured as a single signal line.

Also, if the actuator to which the command data input to the network subsystem (3700) is directed is the actuator (3760) connected to it, the computing unit (3710) can directly transmit the command data or the computation value to the driving control unit (3720) through signal line l7.

The network subsystem (3700) transmits the received command data (CMD) to the ECU (3750) through signal line l6. And the ECU (3750) generates a driving signal (DS2) using the command data (CMD) and can transmit it to the second actuator (3770).

The driving control unit (3720) writes the final computation value (DPV_F) transmitted from the network subsystem (3700) through signal line l5 to a specific address of the register (3721) via the communication interface (3733). And the driving signal generation module (3722) can generate a driving signal (DS1) using the register value written at the specific address and transmit it to the first actuator (3760).

That is, the computing unit (3710) of FIG. 39 collects data transmitted from an adjacent zone control unit (e.g., sensor data, command data, calculation result value for driving, etc.). And it calculates its own computation value (DPV_E) using the collected data. Also, through comparison of its own calculated computation value (DPV_E) with the computation value (DPV_J) transmitted by the adjacent zone control unit, it filters out erroneous data, selects data with integrity, and transmits it to the network subsystem (3700). And if the driving control unit (3720) identifies that the final integrity data transmitted by the network subsystem (3700) is its own, it stores it in the register (3721). Also, the driving signal generation module (3722) can generate a driving signal using the data stored in the register (3721).

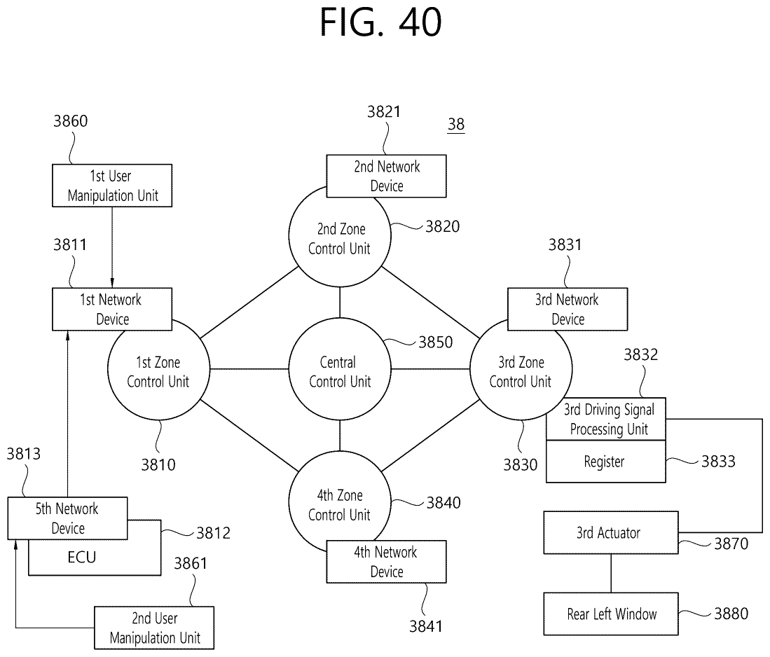

FIG. 40 is a configuration diagram of a vehicle control system (38) which is another embodiment of the present disclosure.

FIG. 40 is a diagram for explaining FIGS. 41a, 41b, 42 and 43. All the network devicees of the central control unit (3850), the first, second, and fourth zone control units (3810, 3820, 3840), and the ECU (3812) of FIG. 40 can be configured to be identical to the third network device (3831) having the third driving signal processing unit (3832) of the third zone control unit (3830).

The first user manipulation unit (3860) of FIG. 40 (event generation device ID: 0001) is connected to the first network device (3811) (network device ID: 0001) within the first zone control unit (3810). And the second user manipulation unit (3861) (event generation device ID: 0010) can be connected to the fifth network device (3813) (network device ID: 0101) within the ECU (3812). Here, the user manipulation units (3860, 3861) may include an in-vehicle switch, a cluster, and an in-vehicle sensor device.

The third zone control unit (3830) can be located in the third network device (3831) (network device ID: 0011) and the third driving signal processing unit (3832) (driving signal processing unit ID: 0011).

FIG. 40 shows a structure where the rear seat window (3880) (in-vehicle device ID: 0001) is connected to the third actuator (3870) (actuator ID: 0011). And the third actuator (3870) is connected to the third driving signal processing unit (3832). Also, the write address of the register (3833) of the third driving signal processing unit (3832) can be set to 0x000C.

The first user manipulation unit (3860) is, for example, one of the switches next to the driver's seat and is a switch that controls the rear left window (3880). And the second user manipulation unit (3861) is, for example, one of the in-vehicle manipulation units and can similarly control the rear left window (3880).

FIGS. 41a and 41b are diagrams showing a frame (3900) generated by a vehicle control system for directly controlling an actuator according to an embodiment of the present disclosure.

The explanation in FIGS. 41a and 41b is based on the configuration of the vehicle control system (38) of FIG. 40.

In the event of an emergency situation in the vehicle network (e.g., actuator control failure, etc.), the vehicle control system (38) of FIG. 40 needs a means to directly control the actuator to a safe value.

The frame (3900) of FIGS. 41a and 41b generated by the network devicees (3811, 3821, 3831, 3841, 3813) of FIG. 40 may include an event generation device ID (3901), an in-vehicle device ID (3902), a network device ID connected to the event generation device (3903), a communication protocol of the network device (3904), an actuator ID connected to the in-vehicle device (3905), a driving signal processing unit ID connected to the actuator (3906), a communication protocol of the driving signal processing unit (3907), and register information (3908).

The network device (3811, 3821, 3831, 3841, 3813 of FIG. 40) is based on the device that generates the event (e.g., a user manipulation unit that generates an operation signal for an in-vehicle device and a domain that generates a control signal related to steering, braking, and driving) and the node that first receives the event and transmits it as a packet. And it can automatically generate the frame (3900) of FIGS. 41a and 41b using a pre-written event reference table (3910), a network device reference table (3920), an in-vehicle device reference table (3930), an actuator reference table (3940), and a driving signal processing unit reference table (3950). The plurality of reference tables can be stored in the memory of each of the network devicees (3811, 3821, 3831, 3841, 3813 of FIG. 40). The plurality of reference tables may include a zone reference table that matches a physical Zone with a Zone Control Unit

The event reference table (3910) is composed of an event generation device ID—an in-vehicle device ID—a network device ID connected to the event generation device. Through this, it can provide the ID information of the final target device to which the device generating the event is directed and the network connected to the final target device. And the network device reference table (3920) is composed of a network device name—a network device ID—a communication protocol and can provide communication protocol type information for each network device. Also, the in-vehicle device reference table (3930) is composed of an in-vehicle device ID—an actuator ID connected to the in-vehicle device and can provide the ID information of the actuator connected to each in-vehicle device. And the actuator reference table (3940) is composed of an actuator ID—a driving signal processing unit ID connected to the actuator and can provide the driving signal processing unit ID information for each actuator. Also, the driving signal processing unit reference table (3950) is composed of a driving signal processing unit name—an ID—a communication protocol—a write address—a clock division value—the number of signals per cycle, etc. Through this, it can provide information on the communication protocol, write address, and control parameters of the driving signal (calculation result value for driving) for each driving signal processing unit.

In this way, the network device (3811, 3821, 3831, 3841, 3813 of FIG. 40) can automatically generate the frame based on its own information and the identification information of the user manipulation unit or domain.

The clock division value (3951) and the number of signals per cycle (3952) within the driving signal processing unit reference table (3950) are actuator driving calculation result values calculated by a computing unit (not shown) within the zone control units (3810, 3820, 3840). And they can be written to a specific address of the register (3833) of the driving signal processing unit (3832) of FIG. 39. Also, the register information (3908) may further include command data derived from the event generation device ID (3901) and a write address.

In this way, if the ID of the user manipulation unit (3860, 3861) where the event signal is generated and the network device that initially receives the event signal are identified, the frame (3900) of FIGS. 41a and 41b or payload is automatically generated in at least one of the zone control units (3810, 3820, 3830, 3840) of FIG. 40. And the automatically generated frame (3900) or payload is broadcast to all of the zone control units (3810, 3820, 3830, 3840) of FIG. 40. Also, the network device of all of the zone control units (3810, 3820, 3830, 3840) can decapsulate the automatically generated frame (3900) and transmit it to its own driving signal processing unit (3832) or to an adjacent network device.

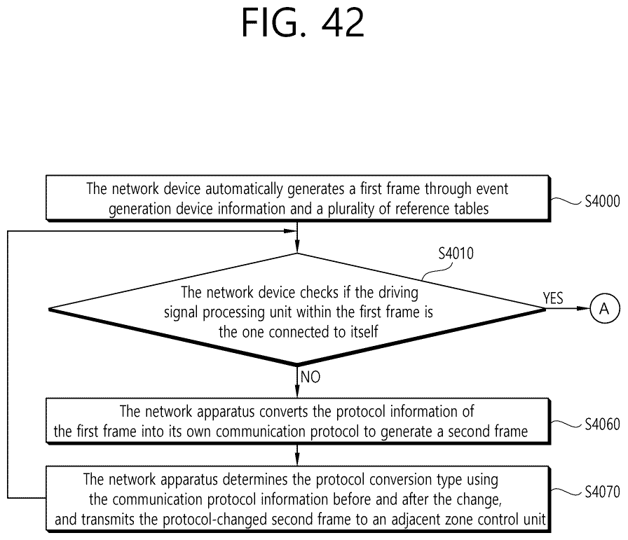

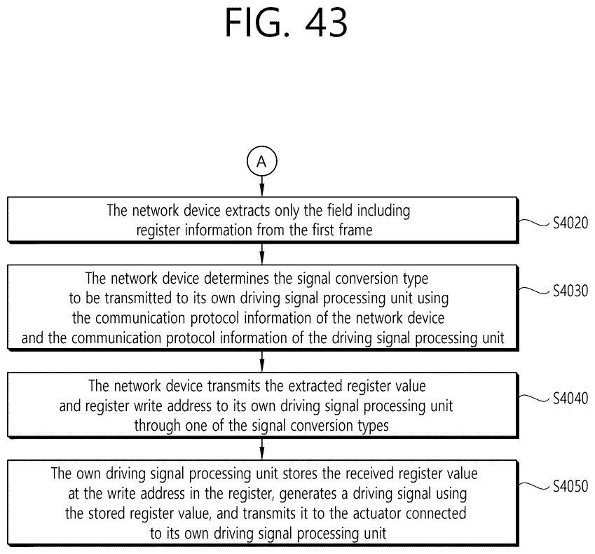

FIGS. 42 and 43 is flowcharts of a vehicle control system controlling an actuator using the frame (3900) according to an embodiment of the present disclosure.

The flowcharts of FIGS. 42 and 43 is based on the configuration of the vehicle control system (38) and frame (3900) shown in FIGS. 40, 41a, and 41b.

First, the network device that initially receives an event automatically generates a first frame (3900) through the device information (identification ID) that generated the event and a plurality of reference tables (3910, 3920, 3930, 3940, 3950) (step S4000). Here, the event includes a user manipulation signal or a control signal generated in a steering, brake, or driving system. And the generated first frame (3900) may include command data showing the content of the event and a calculation result value for driving calculated on its own using the command data.

Thereafter, the network device extracts the driving signal processing unit ID in the fifth field of the first frame (3900) and checks whether the derived driving signal processing unit is a driving signal processing unit connected to it (step S4010).

If it is a driving signal processing unit connected to it, the network device extracts only the register information (3908) from the first frame (3900) (step S4020). Here, the network device can verify the integrity of the register information (3908) by comparing the extracted register information (3908) with a plurality of reference table information stored on its own. If a problem occurs with the integrity of the register information (3908), it transmits an alarm to the central control unit. And the central control unit can determine the signal transmission path to the final target actuator and the register information to be transmitted based on the alarm signal, register information, and its own computation value transmitted from the in-vehicle zone control unit. Meanwhile, the plurality of reference tables may be downloaded and updated from a central control unit or via an OTA method.

Next, the network device determines the signal conversion form to be transmitted from the network device to its own driving signal processing unit using the communication protocol information (3904) of the network device in the third field and the communication protocol information (3907) of the driving signal processing unit in the sixth field of the first frame (3900) (step S4030). Through this, signal conversion in the network device can be performed quickly. The signal conversion forms may include conversion from Ethernet to serial communication, CAN to serial communication, and LIN to serial communication.

Then, the network device transmits the extracted register value (3908) and register write address information to its own driving signal processing unit through one of the signal conversion forms (step S4040).

Its own driving signal processing unit stores the received register value (3908) at the write address in the register and generates a driving signal using the stored register value (3908). And it transmits it to the actuator connected to its own driving signal processing unit (step S4050).

If the driving signal processing unit (3906) in the fifth field of the first frame (3900) is not a driving signal processing unit connected to it, the network device (3811) generates a second frame in which the third field (3904) of the first frame (3900) is converted to its own communication protocol (step S4060).

The network device (3811) determines the protocol conversion form using the communication protocol information of the third field (3904) before the change and the communication protocol information after the change. And it transmits the protocol-changed second frame to an adjacent zone control unit (step S4070). Here, the protocol conversion may include one of Ethernet-to-Ethernet, Ethernet-to-CAN, Ethernet-to-LIN, CAN-to-LIN, CAN-to-CAN, and LIN-to-LIN conversion.

Next, the network device of the adjacent zone control unit that receives the second frame proceeds to step S4010.

Therefore, by using the frame (3900) generation of the present invention and the network device and driving signal processing unit that process data using the frame (3900), the end-to-end time delay can be reduced by performing rapid protocol conversion and extracting and using only the information necessary for driving the target actuator.

Features of the embodiments and aspects described above may be combined, unless their combination results in obvious technical conflicts.

What is claimed is:

1. A vehicle control apparatus for controlling in-vehicle actuators, the vehicle control apparatus comprising:
at least one pair of a first driving control unit and a second driving control unit configured to control a same actuator; and
a clock interface configured to:
receive a plurality of independent system clocks having mutually different frequencies, and
in an event of an error in a currently selected system clock, automatically switch to a next valid system clock to supply a clock to the first and second driving control units,
wherein the first driving control unit is configured to perform a first processing on a first input signal to generate a first actuator driving signal, and
wherein the second driving control unit is configured to perform a second processing, different from the first processing, on a second input signal, different from the first input signal, to generate a second actuator driving signal that is identical to the first actuator driving signal.

2. The vehicle control apparatus of claim 1, wherein the first input signal is command data indicating a target operation and a target state of the actuator, and the second input signal is a processing result value for driving, the processing result value for driving including a control parameter for a driving signal to achieve the target operation and the target state.

3. The vehicle control apparatus of claim 1, wherein the first processing comprises a process of calculating a processing result value for driving from command data, and the second processing comprises a process in which a driving signal generation module generates the driving signal by storing the processing result value for driving in a register and using the processing result value for driving stored in the register and a clock signal.

4. The vehicle control apparatus of claim 1, wherein the vehicle control apparatus is configured to receive a command signal through a plurality of control paths determined according to a location and a type of a control unit that initially receives a command signal for a target actuator, and to select a command signal that has a majority agreement by applying a 2-out-of-3 (2oo3) voting logic to a plurality of the received command signals.

5. The vehicle control apparatus of claim 1, wherein a first core of the first driving control unit and a second core of the second driving control unit are configured with mutually different performance levels.

6. The vehicle control apparatus of claim 1, further comprising a processing unit configured to select a final processing result value for driving by applying a predetermined voting logic to a plurality of processing result values for driving to determine a value with a majority agreement, wherein the plurality of processing result values for driving comprise:
a first processing result value for driving, the first processing result value for driving being received from an adjacent control unit; and
a second processing result value for driving, the second processing result value for driving being calculated by the processing unit itself for same command data as the first processing result value for driving.

7. The vehicle control apparatus of claim 6, wherein the processing unit is configured to, in a case where there is no value with a majority agreement when applying the voting logic, transmit an alarm signal to a central control unit, or determine the final processing result value for driving as a predetermined safety state.

8. The vehicle control apparatus of claim 1, wherein the first and second driving control units share an output unit, and the output unit includes a hardware comparator configured to compare whether the first and second actuator driving signals are identical.

9. The vehicle control apparatus of claim 1, wherein the vehicle control apparatus is configured to identify an error on a signal path by receiving an alarm signal transmitted from an adjacent control unit.

10. The vehicle control apparatus of claim 1, wherein, in an event of a clock switch in the clock interface, the vehicle control apparatus is configured to reset a clock generator by transmitting a new clock division value corresponding to a changed clock frequency to a register.

11. The vehicle control apparatus of claim 4, wherein the vehicle control apparatus is configured to monitor a reliability level of each of the control paths, and the reliability level is determined according to a signal delay time, signal congestion, and transmission bandwidth of a signal.

12. The vehicle control apparatus of claim 1, wherein, in a case where a state of the actuator deviates from a preset state range, the vehicle control apparatus is configured to control the actuator using a safety processing result value for driving, the safety processing result value for driving being stored in a safety register.

13. The vehicle control apparatus of claim 1, wherein the first driving control unit and the second driving control unit further include a monitoring device configured to monitor each other's operation.

14. The vehicle control apparatus of claim 1, wherein the vehicle control apparatus is installed in an Electronic Control Unit (ECU) or a zone control unit, and wherein the first and second driving control units are provided within the ECU or the zone control unit.

15. The vehicle control apparatus of claim 1, wherein the clock interface includes a monitor configured to detect a frequency variation or a signal stop of the system clock to determine an error of the system clock.

16. The vehicle control apparatus of claim 1, wherein the first driving control unit and the second driving control unit are located in different zones or in different Electronic Control Units (ECUs) of a vehicle and are configured to communicate with each other via a Time-Sensitive Networking (TSN)-based Ethernet backbone.
